(19) United States
(12) Patent Application Publication
(10) Pub. No.: US 2009/0037587 A1
(43) Pub. Date: Feb. 5, 2009

(54) COMMUNICATION SYSTEM, COMMUNICATION APPARATUS, COMMUNICATION METHOD, AND PROGRAM

(75) Inventors: Hideo Yoshimi, Tokyo (JP); Nobuyuki Enomoto, Tokyo (JP); Youichi Hidaka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/817,122

(22) PCT Filed: Feb. 27, 2006
(86) PCT No.: PCT/JP2006/303578

§ 371 Date: Aug. 24, 2007

(30) Foreign Application Priority Data
Feb. 28, 2005 (JP) 2005-054954

(51) Int. Cl. G06F 15/16; H04L 9/00

(52) U.S. Cl. 709/227; 713/150

(57) ABSTRACT

Out of data being transmitted from a client application A1 to a server application B1, data of which encryption has been determined to be necessary in a frame analyzing means within an intermediate driver A11 of s PC 1 is relayed by use of a total of two TCP sessions consisting of a TCP session 1 between a TCP A14 and a TCP A2, and a TCP session 2 between a TCP A17 and a TCP B3. Relaying the TCP sessions in such a manner makes it possible to achieve a coincidence of a TCP/IP protocol hierarchy between an SSL A16 within the intermediate driver A11 and an SSL B2 within a server 2, which enables certificate information, an encryption algorithm, etc. necessary for starting an SSL session to be automatically exchanged therebetween. As a result, secret data being sent out from the PC can be encrypted without changing the setting of the server or installing any software.

### APPLICABLE FIELD IN THE INDUSTRY

The present invention relates to a communication technology, and more particularly to an encrypted communication technology for encrypting and transmitting data that is sent out from an information processing terminal.

### BACKGROUND ART

Nowadays, the incident that secret information leaks out due to wiretapping, for example, the incident that data that is transmitted/received via networks such as Internet and LAN (Local Area Network) is interrupted unauthorizedly by a third party, frequently occurs, which has become an object of public concern.

As a technique that is effective in preventing such wiretapping of data, the technique of “encrypting” data that is sent out from a PC (Personal Computer) is listed. Encrypting data enables secrecy of data to be maintained.

Preserving secrecy of data necessitates encrypting all items of secret data that is sent out from the PC. However, conventionally, so as to encrypt data that is sent out from the PC, a user has to instruct encryption software to encrypt the transmission data.

For example, an electronic mail, which is generally encrypted by employing a protocol of SMTP over SSL, is transmitted, so the user has to explicitly instruct software to encrypt the electronic mail by using this protocol. Many kinds of software demand that its setting be changed manually, whereby a burden is imposed upon the user, and a risk that the not-encrypted electronic mail is sent out due to the erroneous setting is accompanied.

A suggestion of a solution for these problems is described in Patent document 1. The technique described in this Patent document 1 includes an encryption application, an encryption driver, and an encryption LSI for a purpose of preventing the not-encrypted packet from being sent out from the PC. In FIG. 47, its configuration is shown.

The encryption application, which is software, manages an encryption algorithm with a password.

The encryption driver is software incorporated into a data-link layer, being a lower layer of a TCP/IP protocol. The encryption driver receives a password from the encryption application, and upon making a reference to its password, gives an instruction for the encryption algorithm to the encryption LSI.

The encryption LSI, which is incorporated into a physical layer, being a lowest layer of the TCP/IP protocol, is hardware. The encryption LSI makes a reference to the encryption algorithm given as an instruction by the encryption driver, thereby to encrypt data responding to a necessity. This makes it possible to encrypt data being sent out from the PC, and to exclude a risk that not-encrypted data is sent out to the network.

The detailed content of this patent document 1 will be explained while making a reference to FIG. 52 by exemplifying the case that the encrypted data is exchanged between a PC 1 and a server 2.

At first, as an initial setting, the encryption driver is installed onto both of the PC 1 and the server 2, and a network interface card (NIC) including the encryption LSI is attached to both of the PC and the server. Further, the encryption algorithm and the password that are used for encryption are pre-set to the encryption drivers of the PC 1 and the server 2. After completing these initial settings, the encrypted data can be exchanged.

So as to specifically explain the encrypting process, the case that data is transmitted to the server 2 from the PC 1 will be explained.

In a case where the application such as mail and Web of the PC 1 side starts data communication, it firstly conveys a data communication start request indicating the effect that data transmission is started to the encryption application, and delivers plaintext data, which is to be transmitted, to the NIC through a TCP, an IP routing, an IP stack, and a driver. Upon receipt of the data communication start request from the application, the encryption application notifies a communication start to the encryption driver, and provides the password set by a user for the encryption driver. The encryption driver instructs the encryption LSI to encrypt the plaintext data by employing the algorithm that corresponds to the password received from the encryption application. The encryption LSI encrypts the plaintext data ready for transmission that exists in the NIC based upon the algorithm received from the encryption driver. The NIC sends out the data encrypted by the encryption LSI to the network. On the other hand, when the NIC of the server receives this encrypted data, it firstly notifies the incoming of data to the driver. Upon receipt of the incoming notification from the NIC, this time, the driver gives the incoming notification to the encryption driver and the encryption application. Upon receipt of the incoming notification from the driver, the encryption driver inquires of the encryption application a registered password for confirmation, and instructs the encryption LSI to decode the received data with a decoding algorithm that conforms to the registered password. The encryption LSI employs the decoding algorithm given as an instruction by the encryption driver to decode the encrypted data ready for reception that exists in the NIC. The NIC delivers the plaintext data decoded in the encryption LSI to the application through the driver, the IP stack, the IP routing, and the TCP. Performing a series of these processes enables secret information that is transmitted/received between the PC and the server to be encrypted, and to be surely prevented from leaking out to the third party.

[Patent document 1] JP-P1998-190704A

### DISCLOSURE OF THE INVENTION

### Problems to be Solved by the Invention

A first point at issue of the above-mentioned prior art is that employing the prior art to encrypt data that is transmitted/received between the PC 1 and the server 2 necessitates not only installing each of the encryption application, the encryption driver, and the encryption LSI onto both of the PC 1 and the server 2, but also pre-setting the encryption algorithm or the password key that is used for encryption to the encryption applications of the PC 1 and the server 2, whereby a burden for the installation and the setting is required.

A second point at issue of the above-mentioned prior art is that employing the prior art to encrypt data that is transmitted/received between the PC 1 and the server 2 necessitates incorporating an encryption function such as the encryption LSI into the NIC, whereby a load that is imposed upon a hardware developer and a software developer is enormous and a burden for the development is required.

A third point at issue of the above-mentioned prior art is that solving the above-mentioned first problem by the first invention of the present invention enables the encrypted communication to be made between the PC 1 and the server 2 without installing a special encryption apparatus onto the server; however, at this moment, the application of the server 2 side needs to correspond to the encryption, whereby there is a possibility that data cannot be encrypted, depending upon the application being used, and a burden for setting the encryption is required.

A fourth point at issue of the above-mentioned prior art is that so as to change the setting associated with the starting or the stopping of the encrypting function responding to a migration of the location of the PC, or the like, the user has to manually change the setting by use of a GUI (Graphical User Interface). For this, the point at issue is that a risk of information leakage due to the erroneous setting is accompanied, and a burden for the setting is required.

A fifth point at issue of the above-mentioned prior art is that, in a case where a plurality of the PCs each of which is inclined to trigger information leakage exist in the network, employing the prior art to encrypt data necessitates installing the encryption application, the encryption driver, and the encryption LSI onto all PCs, whereby a burden for the installation and the setting is required.

The present invention has been accomplished in consideration of the above-mentioned problems, and an object thereof is to provide an encryption system that enables all items of data being transmitted/received between the PC and the server to be surely encrypted without a burden.

In addition hereto, an object thereof lies in reducing a load that is imposed upon the hardware developer and the software developer.

### Means to Solve the Problem

The first invention for solving the above-mentioned problem, which is a communication system including a transmission node and a reception node, is characterized in including:

a first session establishing means for establishing a first session with the transmission node responding to a session establishment request from the transmission node;

a second session establishing means for establishing a second session with the reception node for transmitting/receiving encrypted transmission data; and

an encrypting means for exchanging information necessary for encryption through the second session, and encrypting the transmission data received through the first session based upon this information.

The second invention for solving the above-mentioned problem is characterized in that, in the above-mentioned first invention, one of the first session establishing means and the second session establishing means is a means for establishing a session with a transport layer.

The third invention for solving the above-mentioned problem is characterized in, in one of the above-mentioned first and second inventions, including a determining means for determining the transmission data, and as a result of the determination, sending the transmission data that has not been encrypted to the first session establishing means.

The fourth invention for solving the above-mentioned problem is characterized in that, in the above-mentioned third invention, the determining means is a means for making a reference to a header of the transmission data, thereby to determine whether or not the transmission data has been encrypted.

The fifth invention for solving the above-mentioned problem is characterized in that, in one of the above-mentioned first to fourth inventions, the first session establishing means is a means for establishing a first session with the transmission node responding to the session establishment request from the transport layer of the transmission node, and commanding the second session establishing means to establish a session with the transport layer of the reception node.

The sixth invention for solving the above-mentioned problem is characterized in that, in one of the above-mentioned first to fourth inventions, in a case where the transmission data is transmitted/received between the transmission node and the reception node through a relay apparatus, the first session establishing means is a means for establishing a first session with the transmission node responding to the session establishment request from the transport layer of the transmission node, and commanding the second session establishing means to establish a second session with the transport layer of the relay apparatus.

The seventh invention for solving the above-mentioned problem is characterized in that, in one of the above-mentioned first to sixth inventions, each of the first session establishing means, the second session establishing means, the encrypting means, and the determining means is configured between a network layer and a data-link layer.

The eighth invention for solving the above-mentioned problem is characterized in that, in one of the above-mentioned first to sixth inventions, Operating System (OS) includes the second session establishing means and the encrypting means.

The ninth invention for solving the above-mentioned problem is characterized in that, in the above-mentioned eighth invention, the Operating System (OS) further includes the first session establishing means.

The tenth invention for solving the above-mentioned problem is characterized in, in one of the above-mentioned first to ninth inventions, including a controlling means for conducting a communication test, and responding to a result of this test, deciding whether or not the transmission data is encrypted.

The eleventh invention for solving the above-mentioned problem is characterized in that, in the above-mentioned tenth invention, a timing at which the controlling means conducts a communication test is one of the time that the transmission node is started, the time of transmitting/receiving data, the time after a lapse of every constant time period, and the designated time, or a combination thereof.

The twelfth invention for solving the above-mentioned problem is characterized in that, in one of the above-mentioned tenth and eleventh inventions, the communication test is one of a test for checking whether a response of an ICMP echo request is returned, a test for checking whether a response of an echo request employing a special frame is returned, and a test for checking whether a value of an IP address allotted to the transmission node is a specified value, or a combination thereof.

The thirteenth invention for solving the above-mentioned problem is characterized in that, in one of the above-mentioned first to twelfth inventions, the encrypting means includes a decoding means for decoding the received data based upon the information.

The fourteenth invention for solving the above-mentioned problem is characterized in that, in the above-mentioned thirteenth invention, the decoding means is a means for decoding the received data that has been determined by the determining means to be data sent through the second session established by the second session establishing means.

The fifteenth invention for solving the above-mentioned problem is characterized in that, in the above-mentioned thirteenth invention, the determining means is a means for making a reference to a header of the received data, thereby to determine that the received data has been sent through the second session established by the second session establishing means.

The sixteenth invention for solving the above-mentioned problem, which is a communication system in which communication is made between a transmission node and a reception node through a relay apparatus, is characterized in including:

a communication establishing means for establishing a session for making communication between the transmission node and the reception node;

a session establishing means for establishing an encryption session for transmitting/receiving transmission data encrypted between the transmission node and the relay apparatus; and

an encrypting means for exchanging information necessary for encryption through the encryption session, and encrypting the transmission data based upon this information.

The seventeenth invention for solving the above-mentioned problem, which is a communication system including a transmission node and a reception node, is characterized in including:

a first session establishing means for establishing a first session with the transmission node responding to a session establishment request from the transmission node; and

a second session establishing means for establishing a second session for transmitting/receiving encrypted transmission data to/from the reception node.

The eighteenth invention for solving the above-mentioned problem, which is a communication apparatus, is characterized in including:

a first session establishing means for establishing a first session responding to a session establishment request;

a second session establishing means for establishing a second session for transmitting/receiving encrypted transmission data; and

an encrypting means for exchanging information necessary for encryption through the second session, and encrypting the transmission data received through the first session based upon this information.

The nineteenth invention for solving the above-mentioned problem is characterized in that, in the above-mentioned eighteenth invention, one of the first session establishing means and the second session establishing means is a means for establishing a session with a transport layer.

The twentieth invention for solving the above-mentioned problem is characterized in, in one of the above-mentioned eighteenth and tenth inventions, including a determining means for determining the transmission data, and as a result of the determination, sending the transmission data that has not been encrypted to the first session establishing means.

The twenty-first invention for solving the above-mentioned problem is characterized in that, in the above-mentioned twentieth invention, the determining means is a means for making a reference to a header of the transmission data, thereby to determine whether or not the transmission data has been encrypted.

The twenty-second invention for solving the above-mentioned problem is characterized in that, in one of the above-mentioned eighteenth to twenty-first inventions, the first session establishing means is a means for establishing a first session responding to the session establishment request from the transport layer of its own apparatus, and commanding the second session establishing means to establish a second session with the transport layer of a transmission destination.

The twenty-third invention for solving the above-mentioned problem is characterized in that, in the one of the above-mentioned eighteenth to twenty-first inventions, in a case where the transmission data is transmitted through a relay apparatus, the first session establishing means is a means for establishing a first session responding to the session establishment request from the transport layer of its own apparatus, and commanding the second session establishing means to establish a second session with the transport layer of the relay apparatus.

The twenty-fourth invention for solving the above-mentioned problem is characterized in that, in one of the above-mentioned eighteenth to twenty-third inventions, each of the first session establishing means, the second session establishing means, the encrypting means, and the determining means is configured between a network layer and a data-link layer.

The twenty-fifth invention for solving the above-mentioned problem is characterized in that, in one of the above-mentioned eighteenth to twenty-fourth inventions, Operating System (OS) includes the second session establishing means and the encrypting means.

The twenty-sixth invention for solving the above-mentioned problem is characterized in that, in the above-mentioned twenty-fifth invention, the Operating System (OS) further includes the first session establishing means.

The twenty-seventh invention for solving the above-mentioned problem is characterized in, in one of the above-mentioned eighteenth to twenty-sixth inventions, including a controlling means for conducting a communication test, and responding to a result of this test, deciding whether or not the transmission data is encrypted.

The twenty-eighth invention for solving the above-mentioned problem is characterized in that, in the above-mentioned twenty-seventh invention, a timing at which the controlling means conducts a communication test is one of the time that the its own apparatus is started, the time of transmitting/receiving data, the time after a lapse of every constant time period, and the designated time, or a combination thereof.

The twenty-ninth invention for solving the above-mentioned problem is characterized in that, in one of the above-mentioned twenty-seventh and twenty-eighth inventions, the communication test is one of a test for checking whether a response of an ICMP echo request is returned, a test for checking whether a response of an echo request employing a special frame is returned, and a test for checking whether a value of an IP address allotted to the transmission node is a specified value, or a combination thereof.

The thirtieth invention for solving the above-mentioned problem is characterized in that, in one of the above-mentioned eighteenth to twenty-ninth inventions, the encrypting means includes a decoding means for decoding the received data based upon the information.

The thirty-first for solving the problem is characterized in that, in the above-mentioned thirtieth invention, the decoding means is a means for decoding the received data that has been determined by the determining means to be data sent through the second session established by the second session establishing means.

The thirty-second invention for solving the above-mentioned problem is characterized in that, in the above-mentioned thirty-first invention, the determining means is a means for making a reference to a header of the received data, thereby to determine that the received data has been sent through the second session established by the second session establishing means.

The thirty-third invention for solving the above-mentioned problem, which is a communication apparatus for making communication through a relay apparatus, is characterized in including:

a communication establishing means for establishing a session for making communication with a transmission destination;

a session establishing means for establishing an encryption session for transmitting/receiving transmission data encrypted with the relay apparatus; and

an encrypting means for exchanging information necessary for encryption through the encryption session, and encrypting the transmission data based upon this information.

The thirty-fourth invention for solving the above-mentioned problem, which is a communication apparatus, is characterized in including:

a first session establishing means for establishing a first session responding to a session establishment request; and

a second session establishing means for establishing a second session with a transmission destination for transmitting/receiving encrypted transmission data.

The thirty-fifth invention for solving the above-mentioned problem, which is a communication method, is characterized in including:

a first session establishment step of establishing a first session responding to a session establishment request from a transmission source;

a second session establishment step of establishing a second session for transmitting encrypted transmission data; and

an encryption step of exchanging information necessary for encryption through the second session, and encrypting the transmission data received through the first session based upon this information.

The thirty-sixth invention for solving the above-mentioned problem is characterized in that, in the above-mentioned thirty-fifth invention, one of the first session establishment step and the second session establishment step is a step of establishing a session with a transport layer.

The thirty-seventh invention for solving the above-mentioned problem is characterized in, in one of the above-mentioned thirty-fifth and thirty-sixth inventions, the encryption step is a step of determining the transmission data, and as a result of the determination, encrypting the transmission data that has not been encrypted.

The thirty-eighth invention for solving the above-mentioned problem is characterized in that, in the above-mentioned thirty-seventh invention, the encryption step is a step of making a reference to a header of the transmission data, thereby to determine whether or not the transmission data has been encrypted.

The thirty-ninth invention for solving the above-mentioned problem is characterized in that, in one of the above-mentioned thirty-fifth to thirty-eighth inventions, the first session establishment step is a step of establishing a first session responding to the session establishment request from the transport layer of the transmission source, and giving a command for establishing a second session with the transport layer of a transmission destination in the second session establishment step.

The fortieth invention for solving the above-mentioned problem is characterized in that, in the one of the above-mentioned thirty-fifth to thirty-eighth inventions, in a case where the transmission data is transmitted through a relay apparatus, the first session establishment step is a step of establishing a first session responding to the session establishment request from the transport layer of the transmission source, and giving a command for establishing a second session with the transport layer of the relay apparatus in the second session establishment step.

The forty-first invention for solving the above-mentioned problem is characterized in, in one of the above-mentioned thirty-fifth to fortieth inventions, including a control step of conducting a communication test, and responding to a result of this test, deciding whether or not the transmission data is encrypted.

The forty-second invention for solving the above-mentioned problem is characterized in that, in the above-mentioned forty-first invention, a timing at which the communication test is conducted is one of the time that an apparatus of the transmission source is started, the time of transmitting/receiving data, the time after a lapse of every constant time period, and the designated time, or a combination thereof.

The forty-third invention for solving the above-mentioned problem is characterized in that, in one of the above-mentioned forty-first and forty-second inventions, the communication test is one of a test for checking whether a response of an ICMP echo request is returned, a test for checking whether a response of an echo request employing a special frame is returned, and a test for checking whether a value of an IP address allotted to the transmission source is a specified value, or a combination thereof.

The forty-fourth invention for solving the above-mentioned problem is characterized in, in one of the above-mentioned thirty-fifth to forty-third inventions, including a decoding step of decoding the received data based upon the information.

The forty-fifth invention for solving the above-mentioned problem is characterized in that, in the above-mentioned forty-fourth invention, the decoding step is a step of decoding the received data that has been determined to be data sent through the second session established in the second session establishment step.

The forty-sixth invention for solving the above-mentioned problem is characterized in that, in the above-mentioned forty-fifth invention, the decoding step is a step of making a reference to a header of the received data, thereby to making a determination.

The forty-seventh invention for solving the above-mentioned problem, which is a communication method for making communication through a relay apparatus, is characterized in including:

a communication establishment step of establishing a session through which communication is made between a transmission source and a transmission destination;

a session establishment step of establishing an encryption session for transmitting/receiving transmission data encrypted between the transmission source and the relay apparatus; and

an encryption step of exchanging information necessary for encryption through the encryption session, and encrypting the transmission data based upon this information.

The forty-eighth invention for solving the above-mentioned problem, which is a communication method, is characterized in including:

a first session establishment step of, responding to a session establishment request from a transmission source, establishing a first session with the transmission source; and

a second session establishment step of establishing a second session for transmitting/receiving encrypted transmission data.

The forty-ninth invention for solving the above-mentioned problem, which is a program of an information processing apparatus, is characterized in causing the information processing apparatus to function as:

a first session establishing means for, responding to a session establishment request from a transmission node, establishing a first session with the transmission node;

a second session establishing means for establishing a second session with the reception node for transmitting/receiving encrypted transmission data; and

an encrypting means for exchanging information necessary for encryption through the second session, and encrypting the transmission data received through the first session based upon this information.

The fiftieth invention for solving the above-mentioned problem is characterized in, in the above-mentioned forty-ninth invention, causing one of the first session establishing means and the second session establishing means to function as a means for establishing a session with a transport layer.

The fifty-first invention for solving the above-mentioned problem is characterized in, in one of the above-mentioned forty-ninth and fiftieth inventions, including a determining means for determining the transmission data, and as a result of the determination, sending the transmission data that has not been encrypted to the first session establishing means.

The fifty-second invention for solving the above-mentioned problem is characterized in, in the above-mentioned fifty-first invention, causing the determining means to function as a means for making a reference to a header of the transmission data, thereby to determine whether or not the transmission data has been encrypted.

The fifty-third invention for solving the above-mentioned problem is characterized in, in one of the above-mentioned forty-ninth to fifty-second inventions, causing the first session establishing means to function as a means for establishing a first session with the transmission node responding to the session establishment request from the transport layer of the transmission node, and commanding the second session establishing means to establish a session with the transport layer of the reception node.

The fifty-fourth invention for solving the above-mentioned problem is characterized in, in the one of the above-mentioned forty-ninth to fifty-second inventions, in a case where the transmission data is transmitted/received between the transmission node and the reception node through a relay apparatus, causing the first session establishing means to function as a means for establishing a first session with the transmission node responding to the session establishment request from the transport layer of the transmission node, and commanding the second session establishing means to establish a second session with the transport layer of the relay apparatus.

The fifty-fifth invention for solving the above-mentioned problem is characterized in, in one of the above-mentioned forty-ninth to fifty-fourth inventions, including a controlling means for conducting a communication test, and responding to a result of this test, deciding whether or not the transmission data is encrypted.

The fifty-sixth invention for solving the above-mentioned problem is characterized in that, in the above-mentioned fifty-fifth invention, a timing at which the controlling means conducts a communication test is one of the time that the transmission node is started, the time of transmitting/receiving data, the time after a lapse of every constant time period, and the designated time, or a combination thereof.

The fifty-seventh invention for solving the above-mentioned problem is characterized in that, in one of the above-mentioned fifty-fifth and fifty-sixth inventions, the communication test is one of a test for checking whether a response of an ICMP echo request is returned, a test for checking whether a response of an echo request employing a special frame is returned, and a test for checking whether a value of an IP address allotted to the transmission node is a specified value, or a combination thereof.

The fifty-eighth invention for solving the above-mentioned problem is characterized in that, in one of the above-mentioned forty-ninth to fifty-seventh inventions, the encrypting means includes a decoding means for decoding the received data based upon the information.

The fifty-ninth invention for solving the above-mentioned problem is characterized in that, in the above-mentioned fifty-eighth invention, the decoding means is a means for decoding the received data that has been determined by the determining means to be data sent through the session established by the second session establishing means.

The sixtieth invention for solving the above-mentioned problem is characterized in, in the above-mentioned fifty-ninth invention, causing the determining means to function as a means for making a reference to a header of the received data, thereby to determine that the received data has been sent through the second session established by the second session establishing means.

The sixty-first invention for solving the above-mentioned problem, which is a program of an information processing apparatus for making communication through a relay apparatus, is characterized in causing the information processing apparatus to function as:

a communication establishing means for establishing a session through which communication is made between a transmission source and a transmission destination;

a session establishing means for establishing an encryption session for transmitting/receiving transmission data encrypted between the transmission source and the relay apparatus; and

an encrypting means for exchanging information necessary for encryption through the encryption session, and encrypting the transmission data based upon this information.

The sixty-second invention for solving the above-mentioned problem, which is a program of an information processing apparatus, is characterized in causing the information processing apparatus to function as:

a first session establishing means for, responding to a session establishment request from a transmission node, establishing a first session with the transmission node; and

a second session establishing means for establishing a second session for transmitting/receiving encrypted transmission data to/from the reception node.

### EFFECTS OF THE INVENTION

The first effect of the foregoing present invention lies in a point that utilizing the TCP relaying means enables certificate information or an encryption key to be exchanged between the intermediate driver of the PC side and the SSL of the server side, whereby not only a burden of setting the encryption key to the intermediate driver of the PC side, but also a burden of installing the intermediate driver onto the server is eliminated. Further, a risk as well that data is wiretapped by the third party, and resultantly, secret information leaks out can be excluded.

The second effect lies in a point that utilizing a loopback connection enables the encrypting means incorporated inside the intermediate driver to be replaced with the existing module in the OS, whereby a burden that the software developer bears for developing the encrypting means and the decoding means is eliminated.

The third effect lies in a point that utilizing a TCP tunneling means enables the PC to encrypt data being sent out also in a case where the application of the server is not in a correspondence with the SSL, whereby a burden of installing the application in correspondence with SSL onto the server is eliminated.

The fourth effect lies in a point that utilizing an encryption setting means enables the encryption setting of the intermediate driver to be automatically switched over responding to a network environment, whereby a burden that a user bears for manually changing the encryption setting is eliminated. Further, a risk as well that the not-encrypted packet is sent out due to the erroneous setting by a user, and resultantly, secret information leaks out can be excluded.

The fifth effect lies in a point that incorporating each function of the intermediate driver into the gateway enables the encryption of the frames from all PCs to be collectively executed in the gateway also in a case where a plurality of the PCs each having a potential for causing secret information to leak out exist in the network, whereby a burden of installing the intermediate driver onto each PC is eliminated.

The first encryption system of the present invention includes the PC and the server. And, as shown in FIG. 42, this first encryption system is an encryption system that is characterized in that the PC, being a transmission apparatus side, has an intermediate driver mounted that includes a frame analyzing means for determining whether the frame received from the higher layer needs to be encrypted or decoded, a header converting means for inserting/extracting a header into/from the frame, a TCP relaying means for performing a TCP relaying process between the PC and the server, and an encrypting means for encrypting and decoding the frame. Herein, the so-called intermediate driver is a module that is inserted between a network layer and a data-link layer that are mentioned in the TCP/IP hierarchy model.

And, as shown in FIG. 43, upon receipt of the frame from the higher layer (step S431), the frame analyzing means determines whether or not its frame has been encrypted (step S432). The not-encrypted frame, into which a header is inserted in the header converting means (step S432), is encrypted (step S434). The encrypted frame is transmitted (step S435).

Employing such a configuration to perform a TCP relaying process in the intermediate driver of the PC makes it possible to match the TCP/IP hierarchy of the encrypting means of the intermediate driver of the PC side with that of the SSL of the server side. This enables communication by the SSL protocol to be made between the encrypting means of the intermediate driver of the PC side and the SSL of the server side, and the certificate information or the encryption key necessary for starting the encryption session to be exchanged. For this, the PC can download the certificate information or the encryption key from the server side, and simply can start the encrypted communication if the certificate or the encryption key are pre-set to the SSL module of the server side even though the certificate or the encryption key are not pre-set to the encrypting means of the intermediate driver of the PC side. From the foregoing, employing this configuration eliminates not only a burden of installing a special module onto the server side but also a burden of setting the encryption key or the certificate password to the PC, whereby a first object of the present invention can be accomplished.

Further, the second encryption system of the present invention, as shown in FIG. 44, is an encryption system that is characterized in that the PC includes a loopbacking means for making a relay connection between the intermediate driver and the OS (Operating System) via a virtual NIC, being software, and an encrypting means having the encrypting means of the first encryption system replaced with the existing module of the OS in addition to the configuration of the first encryption system.

Employing such a configuration to loopback the frame, of which the encryption has been determined to be necessary, from the intermediate driver into the OS in the intermediate driver of the PC by employing the loopbacking means makes it possible to encrypt the frame with the SSL module existing in the OS. Almost all, the SSL is standardizedly installed onto the OS (Operating System) of the computer that is currently available in the market, so the software developer does not have to develop the SSL newly. As a result, packaging the encrypting means into the intermediate driver is not necessitated, whereby a second object of the present invention can be accomplished.

Further, the third encryption system of the present invention includes a gateway in addition to the configuration of the first encryption system. This third encryption system is an encryption system that is characterized in that the PC and the gateway have a TCP tunneling means for establishing an encryption TCP tunnel mounted therebetween as shown in FIG. 45.

By employing such a configuration, encrypting the frame of which the encryption has been determined to be necessary in the intermediate driver of the PC, thereafter transferring it from the PC to the gateway by employing the TCP tunneling means, decoding this frame in the gateway, and then re-transferring it to the server, the PC can encrypt data being sent out even in a case where the application software of the server side is not in a correspondence with the SSL. For this, the encrypted communication can be made between the PC and the server without depending upon the application, whereby a third object of the present invention can be accomplished.

Further, the fourth encryption system of the present invention includes a management server in addition to the configuration of the first encryption system. And, this fourth encryption system is an encryption system that is characterized in that the PC includes an encryption setting means for automatically switching the setting of the encryption function of the intermediate driver over as shown in FIG. 46, responding to a result of the communication test with the manager server.

Employing such a configuration to automatically change the setting of the encryption function of the intermediate driver of the PC over enables a fourth object of the present invention to be accomplished.

Further, the fifth encryption system of the present invention is an encryption system that is characterized in including a gateway in addition to the configuration of the first encryption system and in incorporating the function of the intermediate driver incorporated into the PC in the first encryption system into the gateway.

Installation of the intermediate driver onto the PC is unnecessitated by employing such a configuration to encrypting the frame of which the encryption has been determined to be necessary in the intermediate driver of the gateway, and to then send it out, whereby a fifth object of the present invention can be accomplished.

### BRIEF DESCRIPTION OF THE DRAWINGS

FIG. 1 is a view illustrating a network configuration of a first embodiment of the present invention.

FIG. 2 is a view illustrating a hardware configuration of the PC of the first embodiment of the present invention.

FIG. 3 is a view illustrating software etc. that is mounted onto the first embodiment of the present invention, and a communication process over a protocol.

FIG. 4 is a view illustrating a format of data that is exchanged between each protocol of the first embodiment of the present invention and the other.

FIG. 5 is a view illustrating an operational flowchart of a frame analyzer of the first embodiment of the present invention.

FIG. 6 is a view illustrating an operational flowchart of the frame analyzer of the first embodiment of the present invention.

FIG. 7 is a view illustrating an operational flowchart of the frame analyzer of the first embodiment of the present invention.

FIG. 8 is a view illustrating an operational flowchart of the header converter of the first embodiment of the present invention.

FIG. 9 is a view illustrating an operational flowchart of the header converter of the first embodiment of the present invention.

FIG. 10 is a view illustrating a table that is preserved by the frame analyzer and the header converter of the first embodiment of the present invention.

FIG. 11 is a view illustrating a format of data in details that is exchanged between each protocol of the first embodiment of the present invention and the other.

FIG. 12 is a view illustrating software etc. that is mounted onto a second embodiment of the present invention, and a communication process over a protocol.

FIG. 13 is a view illustrating an operational flowchart of the frame analyzer of the second embodiment of the present invention.

FIG. 14 is a view illustrating an operational flowchart of the frame analyzer of the second embodiment of the present invention.

FIG. 15 is a view illustrating software etc. that is mounted onto a third embodiment of the present invention, and a communication process over a protocol.

FIG. 16 is a view illustrating software etc. that is mounted onto a fourth embodiment of the present invention, and a communication process over a protocol.

FIG. 17 is a view illustrating an operational flowchart of the header converter of the fourth embodiment of the present invention.

FIG. 18 is a view illustrating a format of data in details that is exchanged between each protocol of the fourth embodiment of the present invention and the other.

FIG. 19 is a view illustrating a network configuration of a fifth embodiment of the present invention.

FIG. 20 is a view illustrating software etc. that is mounted onto the fifth embodiment of the present invention, and a communication process over a protocol.

FIG. 21 is a view illustrating an operational flowchart of the frame analyzer of the fifth embodiment of the present invention.

FIG. 22 is a view illustrating an operational flowchart of the frame analyzer of the fifth embodiment of the present invention.

FIG. 23 is a view illustrating an operational flowchart of the frame analyzer of the fifth embodiment of the present invention.

FIG. 24 is a view illustrating an operational flowchart of the frame analyzer of the fifth embodiment of the present invention.

FIG. 25 is a view illustrating an operational flowchart of the header converter of the fifth embodiment of the present invention.

FIG. 26 is a view illustrating an operational flowchart of the header converter of the fifth embodiment of the present invention.

FIG. 27 is a view illustrating a format of data in details that is exchanged between each protocol of the fifth embodiment of the present invention and the other.

FIG. 28 is a view illustrating software etc. that is mounted onto a sixth embodiment of the present invention, and a communication process over a protocol.

FIG. 29 is a view illustrating an operational flowchart of the frame analyzer of the sixth embodiment of the present invention.

FIG. 30 is a view illustrating software etc. that is mounted onto a seventh embodiment of the present invention, and a communication process over a protocol.

FIG. 31 is a view illustrating a network configuration of an eighth embodiment of the present invention.

FIG. 32 is a view illustrating software etc. that is mounted onto the eighth embodiment of the present invention, and a communication process over a protocol.

FIG. 33 is a view illustrating an operational flowchart of the frame analyzer of the sixth embodiment of the present invention.

FIG. 34 is a view illustrating an operational flowchart of the frame analyzer of the sixth embodiment of the present invention.

FIG. 35 is a view illustrating a network configuration of a ninth embodiment of the present invention.

FIG. 36 is a view illustrating software etc. that is mounted onto the ninth embodiment of the present invention, and a communication process over a protocol.

FIG. 37 is a view illustrating an operational flowchart of the frame analyzer of the ninth embodiment of the present invention.

FIG. 38 is a view illustrating an operational flowchart of the frame analyzer of the ninth embodiment of the present invention.

FIG. 39 is a view illustrating an operational flowchart of the frame analyzer of the ninth embodiment of the present invention.

FIG. 40 is a view illustrating a network configuration in the case of expanding the ninth embodiment of the present invention and including a plurality of the PCs and the server.

FIG. 41 is a view illustrating software and a communication process over a protocol in the case of having expanded the ninth embodiment of the present invention to reduce the load for developing the intermediate driver.

FIG. 42 is a view illustrating characteristics of the first encryption system of the present invention.

FIG. 43 is a view illustrating an outline of an operation of the first encryption system of the present invention.

FIG. 44 is a view illustrating characteristics of the second encryption system of the present invention.

FIG. 45 is a view illustrating characteristics of the third encryption system of the present invention.

FIG. 46 is a view illustrating characteristics of the fourth encryption system of the present invention.

FIG. 47 is a view illustrating the prior art.

### BEST MODE FOR CARRYING OUT THE INVENTION

Next, so as to explain the aspect that enables the foregoing predominance point and characteristic of the present invention to be obtained, more specific description of the present invention briefed below will be made by making a reference to specific embodiments shown in the accompanied drawings. Upon understanding that these drawings illustrates only typified embodiments, and the invention is not intended to be limited to the embodiments described therein, the present invention will be described and explained more clearly and detailedly by employing the drawings attached hereinafter.

### First Embodiment

[Explanation of a Configuration]

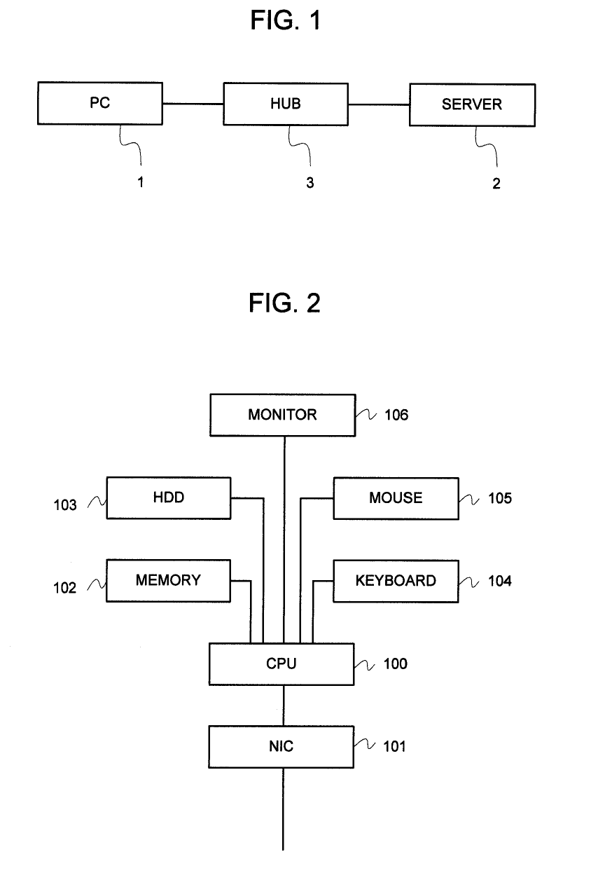

A first embodiment for carrying out the first invention of the present invention will be explained in details by making a reference to the accompanied drawings. FIG. 1 is a view illustrating a network configuration of the first embodiment, which includes a PC 1, a server 2, and a hub 3.

The PC 1, which is connected to the hub 3, receives the frame from the hub 3, and performs a desired process for the received frame. Further, the PC 1 transmits the frame generated in the internal process of the PC1 to the hub 3.

The server 2, which is connected to the hub 3, receives the frame from the hub 3, and performs a desired process for the received frame. Further, the server 2 transmits the frame generated in the internal process of the server 2 to the hub 3.

The hub 3 is connected to the PC 1 and the server 2. Upon receipt of the frame from the PC 1, the hub 3 analyzes the received frame, and transfers the frame to an appropriate port based upon its analysis result. Further, upon receipt of the frame from the server 2, the hub 3 analyzes the received frame, and transfers the frame to an appropriate port based upon its analysis result.

FIG. 2 is a block diagram having a hardware configuration of the PC 1 in the first embodiment shown in details. The PC 1 is configured of a CPU 100, an NIC 101, a memory 102, an HDD 103, and a keyboard 104, a mouse 105, and a monitor 106.

The CPU 100, which is referred to as a central processing unit, is hardware for loading software (program) recorded in the HDD 103, and executing the process described in a program by employing the memory 102. In performing this process, the CPU 100 receives a command by a user from the keyboard 104 and the mouse 105, and in addition hereto, also can output a result to the monitor 106. Further, in performing this process, it sometimes receives data from the NIC 101, or outputs data to the NIC 101.

The NIC 101, which is referred to as a network interface card, is hardware that is inserted into a computer for a purpose of connecting a cable for a network such as Ethernet. It converts data received from the cable into an appropriate electric signal to send it to the CPU 100, and contrarily, converts data received from the CPU 100 into an appropriate signal to send it to the cable.

The memory 102, which is a memory device that is used at the moment that the CPU 100 processes/executes the software, preserves data sent together with a write command from the CPU 100 in a designated address, and further, upon receipt of a read command transmitted from the CPU 100, reads out data from the designated address to forward it to the CPU.

The HDD 103, which is referred to as a hard disc drive, is a memory device for storing the software (program). It preserves data sent together with the write command from the CPU 100 in the designated address, and further, upon receipt of the read command transmitted from the CPU 100, reads out data from the designated address to forward it to the CPU.

The keyboard 104 is an input apparatus for converting a command input by pressing a key by a user into an electric signal, and conveying it to the CPU 100.

The mouse 105 is an input apparatus for converting a command input by moving the mouse by a user into an electric signal, and conveying it to the CPU 100.

The monitor 106 is an output apparatus for receiving a depiction command transmitted by the CPU 100, and displaying it on a Braun tube, a liquid crystal screen, etc.

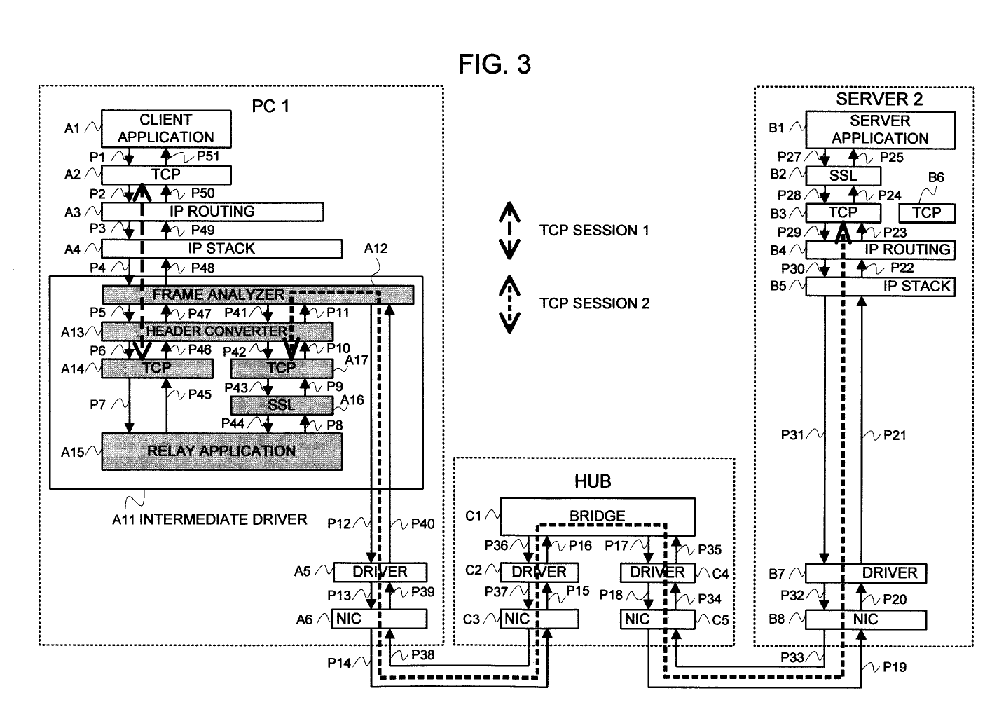

FIG. 3 is a view illustrating the communication process of the CPU and the NIC that are mounted onto each apparatus of the embodiment. Each of the CP 1, the server 2 and the hub 3 of this embodiment includes predetermined OS (Operating System) and software for realizing various kinds of the functions within each CPU, and includes the NIC, being hardware.

Many items of the software other than the software shown in FIG. 3 actually operate within the CPU; however the software having no relation to the present invention is omitted in FIG. 3.

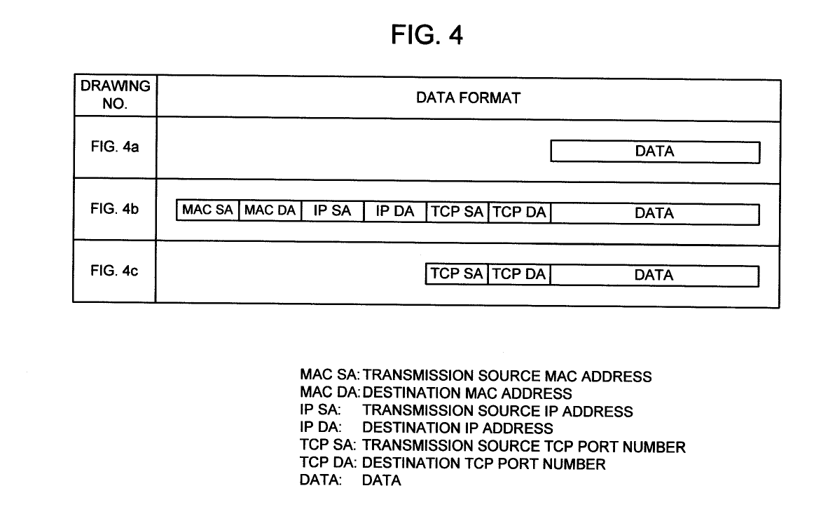

Next, a function of each component of the PC 1 will be explained in details. At first, out of the software operating within the CPU of the PC 1, the software that is positioned at the higher layer that is not included in the OS will be explained. The PC 1 includes a client application A1 as software that corresponds hereto. The client application A1 is an application for making communication with a server application B1 of the server 2. The client application A1 has a function of transferring data generated in a predetermined process to a TCP A2. Further, the client application A1 has function of, upon receipt of data from the TCP 2A, performing a predetermined process for the received data. FIG. 4a shows a format of data that the client application A1 exchanges with the TCP A2. Various applications, for example, WEB browser software, electronic mail client software, TELNET client software, FTP client software, accounting client software, file sharing client software, and database client software are applicable to the client application A1 as major software.

Next, a function of the software that is included in the OS of the PC 1 will be explained. The PC 1 includes a TCP A2, an IP routing A3, and an IP stack A4 as software that is included in the OS.

The TCP A2 has a function of arranging data into formatted data having a constant form and packetizing it in the processes of (1) to (4) described below, or recovering the data from the packet.

(1) The TCP A2 receives data from the client application A1, adds to the data a TCP header and a destination IP address for detecting a missing of the packet or a reversal of the sequence, and sends it to the IP routing A3. Herein, the data, of which size is large, is division-processed (also referred to as “is fragmented”).

(2) The TCP A2 receives the packet from the IP routing A3, and makes a reference to the TCP header, thereby to detect a missing of the packet or a reversal of the sequence, and in a case where not only a reversal of the sequence but also a missing has not occurred, removes the header from the packet, and sends the data to the client application A1. At this moment, it gives an ACK packet for notifying arrival of the packet as a reply to a transmission source of the packet.

(3) In the above-mentioned (2), in a case where a missing of the packet has occurred, the TCP A2 transmits a re-sending request packet to the transmission source. Further, in a case where a reversal of the sequence or a fragmentation has occurred, it waits for the packet that is to arrive later, and recovers the data.

(4) Upon receipt of the ACK packet, the TCP A2 regulates a transmission speed of the packet in (1).

The IP routing A3 has a function of receiving the packet from the TCP A2, and making a reference to the destination IP address to transfer the received packet to the IP stack A4. Further, the IP routing A3 has a function of receiving the packet from the IP stack A4, and making a reference to a destination port number to transfer the received packet to the TCP A2.

The IP stack A4 has a function of receiving the packet from the IP routing A3, adding the IP header and the MAC header to the received packet, thereby to generate a frame, and transferring this frame to an intermediate driver A11. FIG. 4b shows a format of data that the IP stack A4 delivers to the intermediate driver A11. Further, the IP stack A4 has a function of receiving the frame from the intermediate driver A11, deleting the MAC header from this received frame, and then transferring the frame to the IP routing A3. Further, the IP stack A4 has a function etc. as well of utilizing an address resolution protocol to investigate a destination MAC address of the packet.

Next, the software that is positioned in the lower layer that is not included in the OS of the PC 1 will be explained. The PC 1 includes the intermediate driver A11 and a driver A5 as software that corresponds hereto.

The intermediate driver A11 is a module that is inserted between a network layer and a data-link layer that are mentioned in a tabulation of a TCP/IP hierarchy model. And, the intermediate driver A11, which is connected to the IP stack A4 and the driver A5, has functions listed below.

The intermediate driver A11 makes a reference to a header of the frame that arrives from the IP stack A4, thereby to determine whether the frame needs to be encrypted. If, as a result of the determination, the received frame needs to be encrypted, the intermediate driver A11 terminates a TCP session with the TCP A2 for the time being, and thereafter, encrypts the data. Herein, the encryption key exchanged with the SSL B2 is employed for an encryption key that is used for encryption. And, the intermediate driver A11 has a function of, after adding to the encrypted data the header that corresponds to the TCP session with the TCP B3, transferring it to the driver A5. On the other hand, the intermediate driver A11 has a function of, if the received frame does not need to be encrypted, transferring the received frame to the driver A5. Herein, as a frame that does not need to be encrypted, the frame already encrypted in the higher TCP/IP hierarchy, a DHCP packet, an ARP packet, etc. are listed.

Further, the intermediate driver A11 makes a reference to a header of the frame that arrives from the driver A5, thereby to determine whether the frame needs to be decoded. If, as a result of the determination, the received frame needs to be decoded, the intermediate driver A11 terminates a TCP session with the TCP B3 for the time being, and thereafter, decodes the data. Herein, the decoding key exchanged with the SSL B2 is employed for a decoding key that is used for decoding. And, the intermediate driver A11 has a function of, after adding to the decoded data the header that corresponds to the TCP session with the TCP A2, transferring it to the IP stack A4. On the other hand, the intermediate driver A11 has a function of, if the received frame does not need to be decoded, transferring it to the IP stack A4. As a frame that does not needs to be decoded, the frame that should be decoded in the TCP/IP hierarchy higher than the intermediate driver A11, the DHCP packet, the ARP packet, etc. are listed.

The intermediate driver A11, as shown in FIG. 3, is configured of a plurality of functional blocks in order to execute the above-mentioned functions. As a component of the intermediate driver A11, a frame analyzer A12 for determining whether the received frame needs to be encrypted and decoded, a header converter A13 for inserting/extracting the header into/from the frame, a TCP A14 and a TCP A17 for terminating the TCP session with a TCP A22 or a TCP B3, an SSL A16 for encrypting and decoding the received data, and an application A15 for performing a relaying process of the TCP are listed. A function of each component will be explained in details as follows.

However, each of a function and a configuration of each component described below is only an example. In particular, it will be appreciated by those skilled in the relevant field that, with the frame analyzer A12 and the header converter A13, its function and configuration can be realized with multifarious methods.

Further, the frame analyzer A12 to be described below will be explained by employing a configuration having a function of determining whether the received frame needs to be encrypted and decoded; however it is not limited hereto. For example, the frame analyzer A12 may assume a configuration having a function of determining whether to cancel the frame in addition this function. This cancellation function makes it possible to prevent CPU resources of the PC 1 from being wasted due to the unnecessary process of the packet, and to prevent the PC 1 from being attacked unauthorizedly from the external network.

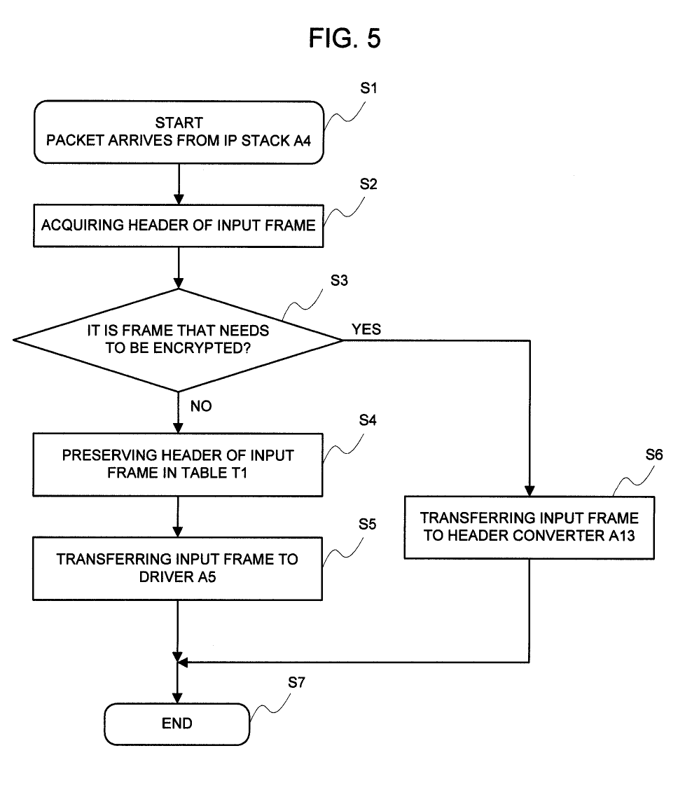

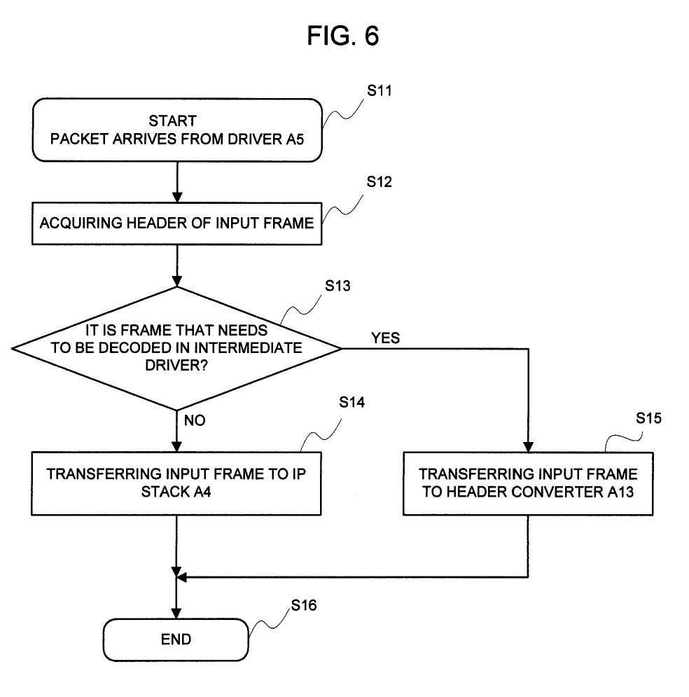

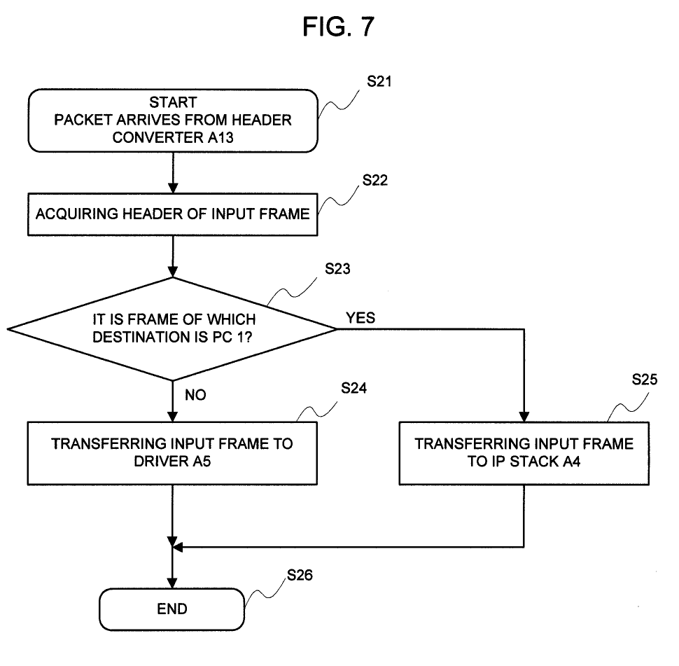

At first, a function of the frame analyzer A12 will be explained. The frame analyzer A12 is connected to the IP stack A4, the header converter A13, and the driver A5. Each of FIG. 5, FIG. 6, and FIG. 7 is a flowchart for explaining the function of the frame analyzer A12 in details.

FIG. 5 shows the process of the frame analyzer A12 in the case that the frame has arrived from the IP stack A4. After firstly acquiring a header of the frame that has arrived (Step S2), the frame analyzer A12 makes a reference to its header, thereby to determine whether the frame needs to be encrypted (step S3). As a header to be referenced herein, the MAC header, the IP header, the TCP header, etc. are listed. The frame of which the encryption is determined to be necessary in this step S3 is a frame that has not been encrypted yet at the time of arriving. Contrarily, the frame of which the encryption is determined to be unnecessary in this step S3 is a frame that has not been encrypted yet at the time of arriving. However, it is to be determined in this step S3 that the frame such as the DHCP frame and the DNS frame, which is never encrypted originally, does not need to be encrypted even though it has not been encrypted.

As mentioned above, it can be determined whether the received frame has been encrypted in the higher TCP/IP hierarchy, and whether the received frame is one of the DHCP frame and the DNS frame, for example, by making a reference to the TCP header of its frame. Specifically, it follows that numbers, for example, no. 443, no. 465, and no. 995 are employed for the destination port number of the encrypted frame with WWW (World Wide Web) access, mail transmission, and mail reception, respectively. On the other hand, numbers, for example, no. 80, no. 25, and no. 110 are employed for the destination port number of the not-encrypted frame with WWW (World Wide Web) access, mail transmission, and mail reception, respectively. Further, no. 68 is employed for the destination port number of the DHCP frame, and no. 53 for the destination port number of the DNS frame

In such a manner, it is determinable from the header of the frame whether its frame needs to be encrypted. So as to cause the frame analyzer A12 to execute such a process, it is enough that the frame analyzer A12 is allowed to have a list having port number information described of the encrypted frame and the not-encrypted frame.

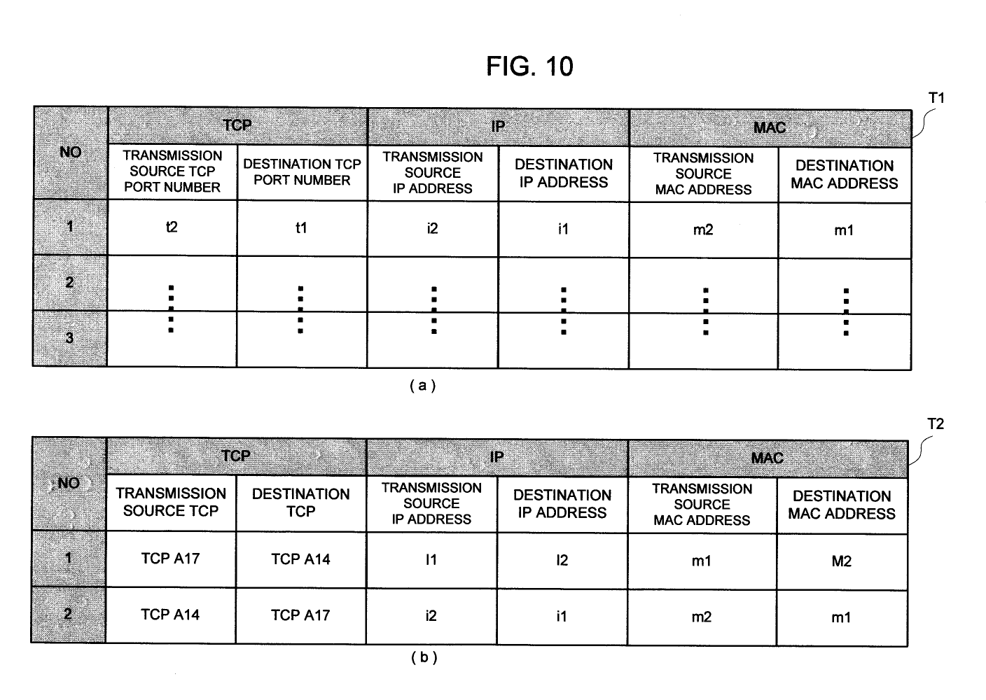

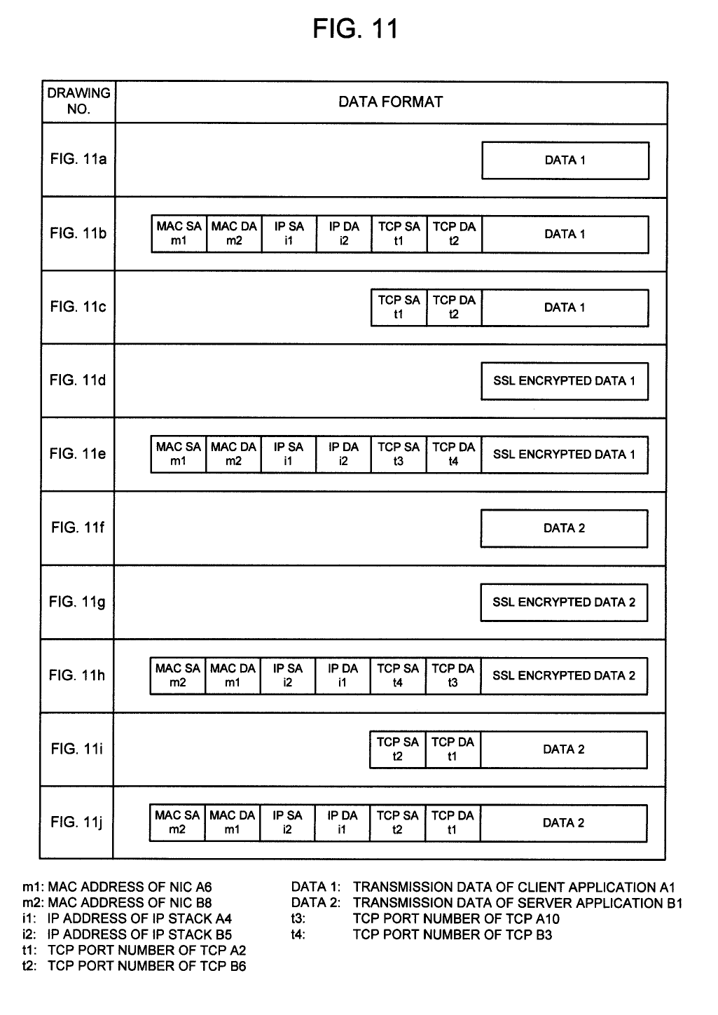

The frame analyzer A12 employs the above-mentioned method, thereby to determine in the step S3 of FIG. 5 whether the frame needs to be encrypted, preserves the header of the frame in a table T1 (step S4) if it is determined that the frame does not need to be encrypted, and thereafter, transfers the frame to the driver A5 (step S5). Further, if the frame needs to be encrypted, it transfers the frame to header converter A13 (step S6). FIG. 10(a) shows filed information of the table T1. The TCP port number, the IP address and the MAC address are registered into the table T1 as shown in FIG. 10(a).

On the other hand, FIG. 6 shows the process of the frame analyzer A12 in the case that the frame has arrived from the driver A5. After firstly acquiring a header of the frame that has arrived (Step S12), the frame analyzer A12 makes a reference to its header, thereby to determine whether the frame needs to be decoded (step S13). As a header to be referenced herein, the MAC header, the IP header, the TCP header, etc. are listed.

The frame of which the decoding is determined to be necessary in this step S13 is a frame that has been encrypted. Contrarily, the frame of which the decoding is determined to be unnecessary in this step S13 is a frame that has not been encrypted.

As mentioned above, whether the received frame has been encrypted is determinable, for example, by making a reference to the TCP header of its frame.

Specifically, it follows that the numbers, for example, no. 443, no. 465, and no. 995 are employed for the transmission source port number of the encrypted frame with WWW (World Wide Web) access, mail transmission, and mail reception, respectively. On the other hand, no. 80, no. 25, and no. 110 are employed for the transmission source port number of the not-encrypted frame with WWW (World Wide Web) access, mail transmission, and mail reception, respectively.

In such a manner, it is determinable from the header of the frame whether its frame needs to be decoded. So as to cause the frame analyzer A12 to execute such a process, it is enough that the frame analyzer A12 is allowed to have a list having port number information described of the encrypted frame and the not-encrypted frame.

Further, the frame analyzer A12 also makes a reference to the table T1 to check whether the acquired frame header has been registered into the table T1 in addition to the above-mentioned process. Herein, in checking whether the frame header has been registered into the table T1, attention should be paid to the fact that, with both of the frame header and the table T1, a relation of the transmission source address and the destination address has been reversed.

As a result of determination, if the frame does not need to be decoded, or the acquired header has been registered into the table T1, the frame analyzer A12 transfers the frame to the IP stack A4 (step S14). Further, if the frame needs to be decoded, and yet the acquired header has been not been registered into the table T1, the frame analyzer A12 transfers the frame to the header converter A13 (step S15).

Herein, the reason why registered information of the table T1 is checked will be explained. The reason is that it is determined whether the received frame is decoded in the intermediate driver A11, or in the TCP/IP hierarchy higher than the intermediate driver A11. So as to explain a necessity of making a reference to this table T1 in details, envisage the case that the PC 1 includes a plurality of the SSL modules. For example, in a case where the PC 1 includes not only an SSL A16 that exists in the intermediate driver A11, but also another SSL module in the TCP/IP hierarchy higher than the intermediate driver A11, the packet of some TCP session is encrypted and decoded in the SSL A16 of the intermediate driver A11, and further, the packet of another TCP session is encrypted and decoded in the SSL module of the TCP/IP hierarchy higher than the intermediate driver A11. In such a case, it is the table T1 that is used for determining which SSL module is employed for decoding the received packet. The table T1 has the header of the packet encrypted in the TCP/IP hierarchy higher than the intermediate driver A11 registered in the step S4 of FIG. 5, whereby making a reference to the header registered into the table T1 makes it possible to determine whether the packet that has arrived should be decoded in the SSL A16 of the intermediate deriver.

On the other hand, FIG. 7 shows an operational flowchart of the frame analyzer A12 in the case that the frame has arrived from the header converter A13. After firstly acquiring a header of the frame that has arrived (Step S22), the frame analyzer A12 makes a reference to its header, thereby to determine a destination terminal of the frame (step S23). As a header to be referenced herein, the MAC header, the IP header, etc. are listed. For example, making a reference to the destination address of the MAC header or the IP header enables the destination terminal to be identified.

If, as a result of the investigation, the destination of the frame is the PC 1, the frame analyzer A12 transfers the frame to the IP stack A4 (step S24). Further, if the destination of the frame is a destination other than the PC 1, it transfers the frame to the driver A5 (step S25).

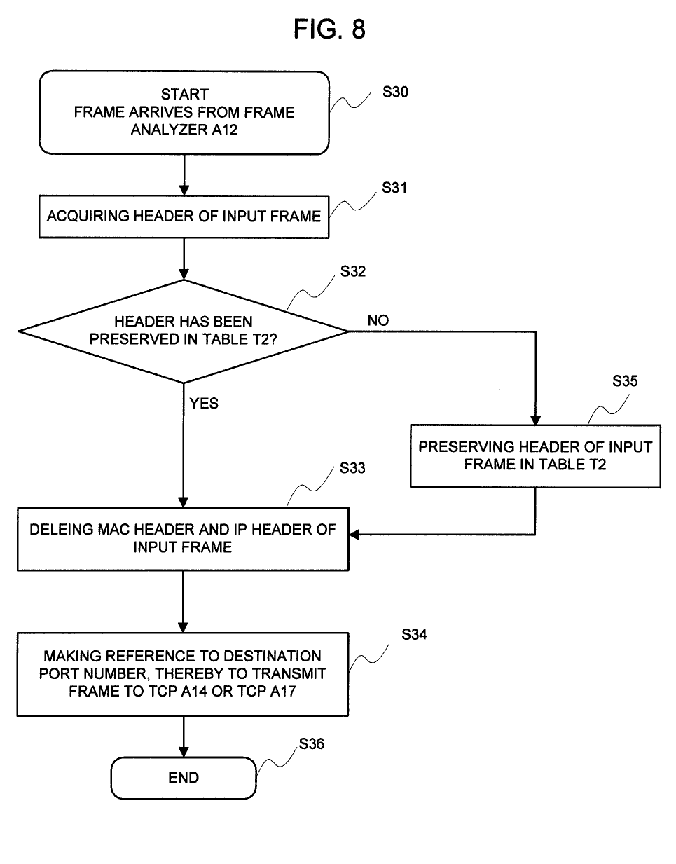

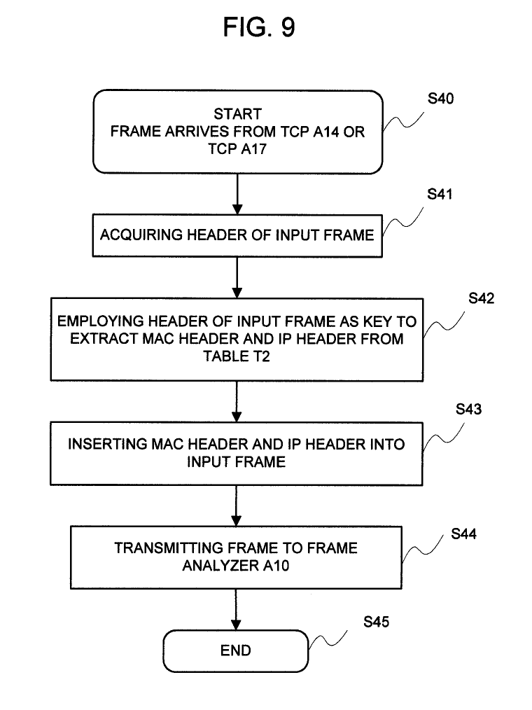

Next, a function of the header converter A13 will be explained. The header converter A13 is connected to the frame analyzer A12, the TCP A14, and the TCP A17. Each of FIG. 8 and FIG. 9 is a flowchart for explaining the process of the header converter A12 in details.

FIG. 8 shows the process of the header converter A13 in the case that the frame has arrived from the frame analyzer A12. After firstly acquiring a header of the frame that has arrived (Step S31), the header converter A13 checks whether the acquired header has been registered into a table T2 (step S32). If the acquired header has not been preserved in the table T2, it registers the header into the table T2 (step S35). Further, if the acquired header has been preserved in the table T2, the header converter A13 deletes the IP header and the MAC header from the frame (step S33), and thereafter, makes a reference to the destination port number of the frame, thereby to transfer the frame to the TCP A14 or the TCP A17. FIG. 10(b) shows filed information of the table T2. The table T2 has the headers such as the IP address and the MAC address registered TCP by TCP as shown in FIG. 10(b). An example is explained of the process in registering the header into the table T2 in the foregoing step S35. For example, in a case where the destination TCP of the received packet is the TCP A14, in a FIG. 10(b), the header converter A13 registers the IP address and the MAC address of its packet into a section in which the destination TCP is the TCP A14.

On the other hand, FIG. 9 shows the process of the header converter A13 in the case that the frame has arrived from the TCP A14 or the TCP A17. At first, the header converter A13 acquires a header of the frame that has arrived (Step S41). As a header to be acquired herein, the destination IP address, the TCP header, etc. are listed. It employs this header as a key to acquire the MAC header and the IP header, which correspond to the frame that has arrived, from the table T2 (step S42). After inserting the MAC header and the IP header acquired in such a manner into the input frame (step S43), it transmits the frame to the frame analyzer A12 (step S44). An example is explained of the process in acquiring the header from the table T2 in the foregoing step S42. For example, in a case where the transmission source TCP of the received packet is the TCP A14, in the table T2 of FIG. 10(b), the header converter A13 reads out the IP address and the MAC address in the section in which the transmission source TCP is the TCP A14, and inserts them into the received packet.

Next, functions of the TCP A14 and the TCP A17 will be explained. Each of the TCP A14 and the TCP A17 has a function of arranging data into formatted data having a constant form and packetizing it in the processes of (1) to (4) described below, or recovering the data from the packet.

(1) Each of the TCP A14 and the TCP A17 receives data from the SSL A16 or the relay application A15, adds to the data the TCP header and the destination IP address for detecting a missing of the packet and a reversal of the sequence, and sends it to the header converter A13. Herein, the data, of which size is large, is division-processed (also referred to as “is fragmented”).

(2) Each of the TCP A14 and the TCP A17 receives the packet from the header converter A13, and makes a reference to the TCP header, thereby to detect a reversal of the sequence and a missing of the packet, and in a case where not only a reversal of the sequence but also a missing has not occurred, removes the header from the packet to send the data to the relay application A15. At this moment, it gives an ACK packet for notifying arrival of the packet as a reply to a transmission source of the packet.

(3) In the above-mentioned (2), in a case where a missing of the packet has occurred, TCP A14 and the TCP A17 transmit a re-sending request packet to the transmission source of the packet. Further, in a case where a reversal of the sequence or a fragmentation has occurred, they wait for the packet that is to arrive later, and recover the data.

(4) Upon receipt of the ACK packet, each of the TCP A14 and the TCP A17 regulates a transmission speed of the packet in (1).

Next, a function of the SSL A16 will be explained. The SSL A16 has a function of, after encrypting the data received from the relay application A15, transferring it to the TCP A17. Further, the SSL A16 has a function of, after decoding the data received from the TCP A17, transferring it to the relay application A15. In addition hereto, the SSL A16 has a function of exchanging information of the certificate or the secret key/the public key that are employed for encryption with the SSL B2 according to an SSL protocol. It is decided according to the setting from the relay application A15 whether to use the SSL, and in a case where the SSL is not used, the data received from the relay application A15, which is not encrypted, is transferred to the TCP A17, and further the data received from the TCP A17, which is not decoded, is transferred to the relay application A15.

Next, a function of the relay application A15 will be explained. The relay application A15 has a function of transferring the data arriving from the TCP A14 to the SSL A16 for a purpose of allowing it to get into communication by the TCP session between the TCP A16 and a TCP B3. FIG. 4a shows a format of data that the relay application A15 exchanges with the SSL A16. Further, the relay application A15 has a function of transferring the data arriving from the SSL A16 to the TCP A14 for a purpose of allowing it to get into communication by the TCP session between the TCP A2 and the TCP A14.

Above, the explanation of each functional block that is included in the intermediate driver A11 is finished.

Continuously, a function of the driver A5 will be explained. The driver A5, which is software for mediating between an NIC A6 and the OS, has a function of receiving the frame from the NIC A6 and sending it to the OS, and further has a function of receiving the frame from the OS and sending it to the NIC A6

Next, a function of hardware of the PC 1 will be explained. The PC 1 includes the NIC A6 as hardware. The NIC A6, which is referred to as a network interface card, is hardware that is inserted into a computer for a purpose of connecting a cable for a network such as Ethernet. It has a function of converting data received from the cable into an appropriate electric signal to send it to the driver, and further converting data received from the driver into an appropriate electric signal to transmit it to the cable.

Next, a function of each component of the server 2 will be explained. At first, out of software that operates within the CPU of the server 2, software that is positioned in the higher layer that is not included in the OS will be stated. The server 2 includes the server application B1 as software that corresponds hereto. The server application B1 is an application for making communication with the client application A1. The server application B1 has a function of transferring data generated in a predetermined process to the TCP B2. Further, the server application B1 has function of, upon receipt of data from the TCP B2, performing a predetermined process for the received data. FIG. 4a shows a format of data that the server application B1 exchanges with the TCP B2. Various applications, for example, WEB server software, electronic mail server software, TELNET server software, FTP server software, accounting server software, file-sharing server software, and database server software are applicable to the server application B1 that corresponds to the client application A1.

Next, a function of the software that is included in the OS of the server 2 will be explained. The server 2 includes the SSL B2, the TCP B3, a TCP B6, an IP routing B4, and an IP stack B5 as software that is included in the OS. The function of the software other than the IP stack B5 out of theses modules is entirely identical to that of the software of the PC 1, so its explanation is omitted.

The IP stack B5 has a function of receiving the packet from the IP routing B4, adding the IP header and the MAC header to the packet, and then transferring the packet to a driver B7. FIG. 4b shows a format of data that the IP stack B5 exchanges with the driver B7. Further, the IP stack B5 has a function of receiving the packet from the driver B7, deleting the MAC header from the packet, and then transferring the packet to the IP routing B4. Further, it also has a function etc. of utilizing the address solution protocol to investigate the destination MAC address of the packet.

Next, a function of the software that is positioned in the lower layer that is not included in the OS of the server 2 will be explained. The server 2 includes the driver B7 as software that corresponds hereto; however a function of the driver B7 is entirely identical to that of the driver A5 of the PC 1, so its explanation is omitted.

Next, a function of the hardware of the server 2 will be explained. The server 2 includes an NIC B8 as hardware; however a function of the NIC B8 is entirely identical to that of the NIC A6 of the PC 1, so its explanation is omitted.

Next, a function of each component of the hub 3 will be explained. At first, a function of the software that is included in the OS of the hub 3 will be explained. The hub 3 includes a bridge C1 as software that is included in the OS. The bridge C1 has a function of receiving the frame from a diver C2 or a driver C4, making a reference to the destination MAC address, and transferring the frame to the driver C2 or the driver C4. Further, it has function of, at the time of receiving the frame, making a reference to the transmission source MAC address, learning the MAC address, and recording which MAC address the terminal has, and which NIC the above terminal has been connected to.

Next, a function of the software of the lower layer that is not included in the OS of the hub 3 will be explained. The hub 3 includes the driver C2 and the driver C4 as software that corresponds hereto; however a function of the driver C2 and the driver C4 is entirely identical to that of the driver A5 of the PC 1, so its explanation is omitted.

Next, a function of the hardware of the hub 3 will be explained. The hub 3 includes an NIC C3 and an NIC C5 as hardware; however a function of the NIC C3 and the NIC C5 is entirely identical to that of the NIC A6 of the PC 1, so its explanation is omitted.

[Explanation of an Operation]

FIG. 11 shows a format of the frame that is exchanged between each of the items of the software of FIG. 3 and the other. An operation of this embodiment will be explained below by making a reference to FIG. 3 and FIG. 11.

At first, an operation in the case that data is transmitted from the client application A1 of the PC 1 to the server application B1 of the server 2 will be explained.

In a case where the client application A1 of the PC 1 transmits data to the server application B1 of the server 2, it firstly delivers data to the TCP A2 through a connection P1. FIG. 11a shows a format of data that is delivered to the TCP A2. Herein, it is assumed that the client application A1 is an application that does not employ the SSL, and its data has not been encrypted.

Upon receipt of the data from the client application A1 through the connection P1, the TCP A2 adds the TCP header and the destination IP address to the data, thereby to packetize it. A port number t2 of the TCP B6 of the server 2 is employed for the destination TCP port number of the TCP header, and a port number t1 of the TCP A2 for the transmission source TCP port number. Further, an IP address i2 of the server 2 is set to the destination IP address. After adding the TCP header and the destination IP address, the TCP A2 delivers the packet to the IP routing A3 through a connection P2.

Upon receipt of the packet from the TCP A2 through the connection P2, the IP routing A3 makes a reference to the destination IP address, and transmits the packet to the IP stack A4 through a connection P3.

Upon receipt of the packet from the IP routing A3 through the connection P3, the IP stack A4 adds the IP header and the MAC header to the packet. An IP address i2 of the server 2 is employed for the destination IP address of the IP header, and an IP address i1 of the PC 1 for the transmission source IP address. Further, an MAC address m2 of the server 2 is employed for the destination MAC address of the MAC header, and an MAC address m1 of the PC 1 for the transmission source MAC address. After inserting such an IP header and MAC header into the packet, thereby to generate a frame, the IP stack A4 delivers the frame to the frame analyzer A12 through a connection P4. FIG. 11b shows a format of data that is delivered to the frame analyzer A12.

Upon receipt of the frame from the IP stack A4 through the connection P4 as shown in FIG. 5, the frame analyzer A12 makes a reference to its header. The frame analyzer A12 determines whether the received data has been encrypted from this header.

For example, it can be checked whether the frame has been encrypted from the destination TCP port number t2 of the frame. The frame analyzer A12 makes a reference to a list having port number information of the encrypted frame and the not-encrypted frame described, thereby to grasp that the port number t2 is a destination TCP port number of the non-encrypted frame.

After performing such a process, the frame analyzer A12 determines that the frame delivered in the connection P4 has not been encrypted, and delivers this frame to the header converter A13 through a connection P5 according to FIG. 5.

Upon receipt of the frame from the frame analyzer A12 through the connection P5 as shown in FIG. 8, the header converter A13 registers the MAC header and the IP header of the received frame into the table T2 responding to the destination TCP. An example of the table T2 is shown in FIG. 10b. The destination TCP of the packet received in the connection P5 is determined to be the TCP A14 because the port number of the TCP A14 has been caused to coincide with the port number t2 of the TCP B6, and its MAC address and IP address is registered into the top stage of the table T2 of FIG. 10b. After registering the header of the received frame into the table T2, the header converter A13 removes the MAC header and the IP header from the frame, thereby to convert it into a packet, and thereafter, makes a reference to the destination port number to deliver the packet to the TCP A14. FIG. 11c shows a format of data that is delivered to the TCP A14.

Upon receipt of the packet from the header converter A14 through a connection P6, the TCP A14 makes a reference to the TCP header, thereby to detect a reversal of the sequence and a missing of the packet, and in a case where not only a reversal of the sequence but also a missing has not occurred, removes the header from the packet to deliver the packet to the relay application A15 through a connection P7. At this moment, it gives an ACK packet for notifying arrival of the packet as a reply to the TCP A2, thereby to terminate the TCP session from the TCP A2. Upon viewing from the TCP A2, the TCP session looks as if it were established between the TCP A2 and the TCB B6 because the port number of the TCP A14 has been caused to coincide to the port number t2 of the TCP B6; however the actual TCP session is established between the TCP A2 and the TCP A14. In FIG. 3, this TCP session is shown with a broken line (TCP session 1).

The above-mentioned explanation of the operation of the TCP A14 was made on the assumption that the TCP session 1 was already established between the TCP A2 and the TCP A14. Herein, upon making a digression a little, an operation until the TCP session 1 is established between the TCP A2 and the TCP A14 will be briefed.

Upon receipt of the data from the client application A1 through the connection P1, the TCP A2 transmits a TCP session establishment request frame for a purpose of establishing the TCP session with the TCP B6 of the server 2 prior to transmitting its data; however, the TCP A14 waits for this TCP session establishment request frame in all port numbers so that it can be usurped, for example, so that all frames are engulfed into the TCP A14. However, the port number that the TCP module other than the intermediate driver A11 occupies is not allowed to be included in the wait-state port number so as to prevent a competing problem of the port number from occurring.

Performing such a process enables the TCP A14 to receive the TCP session establishment request frame via the header converter A13. Upon receipt of this TCP session establishment request frame, the TCP A14 occupies the destination port number t2 described in its frame header as a wait-state port number of the TCP A14, and releases other port numbers. Thereafter, the TCP A14 performs a 3-way handshake process necessary for establishing the TCP session with the TCP A2, and establishes a TCP session 1. It became apparent that performing the process as mentioned above enabled the TCP session 1 to be established between the TCP A2 and the TCP A14.

Above, a digression was made a little, and now returning to the subject matter, the explanation of the operation of each module is continued.

Upon receipt of the packet from the TCP A14 through the connection P7, the relay application A7 delivers it to the SSL A16 as it stands through a connection P8 for a purpose of encrypting the packet to realize prevention of the wiretapping.

Upon receipt of the packet from the relay application A15 through the connection P8, the SSL A16 uses an encryption technique pre-settled with the SSL B2 of the server 2, thereby to encrypt the packet. After completing the encryption, the SSL A16 delivers the encrypted data to the TCP A17 through a connection P9. FIG. 11d shows a format of data that is delivered to the TCP A17.

Upon receipt of the encrypted data from the SSL A16 through the connection P9, the TCP A17 adds the TCP header and the destination IP address to this data, thereby to packetize it. A port number t4 of the TCP B3 of the server 2 is employed for the destination TCP port number of the TCP header, and a port number t3 of the TCP A17 for the transmission source TCP port number. Herein, the port number t4 of the TCP B3 is a port number that is explicitly used in transmitting the encrypted data. For example, in a case of transmitting the encrypted mail, the protocol of SMTP over SSL is used, and no. 465 is employed as its destination TCP port number. Further, an IP address i2 of the server 2 is set to the destination IP address. After adding the TCP header and the destination IP address, the TCP A17 delivers the packet to the header converter A13 through a connection P10. The TCP A17 establishes the TCP session with the TCP B3 by use of theses processes, and realizes the stabilized data transfer to/from the TCP B3. In FIG. 3, this TCP session is shown with a dotted line (TCP session 2).

The above-mentioned explanation of the operation of the TCP A17 was made on the assumption that the TCP session 2 was already established between the TCP A17 and the TCP B3. Herein, upon making a digression a little again, an operation until the TCP session 2 is established between the TCP A17 and the TCP B3 will be briefed.

Previously, the operation until the TCP A14 established the TCP session 1 with the TCP A2 was described, and after the TCP A14 establishes the TCP session 1 with the TCP A2, it sends the relay application A15 a command for establishing the encryption TCP session 2 with the server 2. At this moment, the TCP A14 delivers information as well of the IP address i2 of the server 2 and the port number t2 of the TCP B6 to the relay application A15.

Upon receipt of the command from the TCP A14, the relay application A15 derives a port number for encryption from the port number t2 for not-encryption that is delivered from the TCP A14. This process of deriving the port number for encryption is executable by making a reference to a list that, application by application, has its port number for encryption and port number for not-encryption described.

Specifically, the relay application A15 makes a reference to a list having the numbers described in such a manner that the encryption/not-encryption port number of WWW (World Wide Web) is no. 443/no. 80, the encryption/not-encryption port number of the mail transmission is no. 465/no. 25, and the encryption/not-encryption port number of the mail reception is no. 995/no. 110.

After the relay application A15 derives the encryption port number t4 that corresponds to the not-encryption port number t2 in the above-mentioned process, it delivers information of the IP address i2 of the server 2 and the encryption port number t4 to the TCP A17 via the SSL A16.

Upon receipt of the IP address i2 and the encryption port number t4 from the relay application A15 via the SSL A16, the TCP A17 transmits a TCP session establishment request frame for encryption to the TCP B3 of the server 2.

If the server application B1 that corresponds to the SSL has been installed onto the server 2, it follows that the TCP B3 has been mounted onto the server 2, whereby the 3-Way Handshake process can executed between the TCP B3 and the TCP A17, and the TCP session 2 can be established. After this TCP session 2 is established, the certificate information or the secret key necessary for starting the encryption session are exchanged between the SSL A16 and the SSL B2 by utilizing the TCP session 2. It became apparent that performing the process as mentioned above enabled the TCP session 1 to be established between the TCP A17 and the TCP B3. That is, it follows that the TCP A17 has established the session with a transport layer of the TCP B3.

On the other hand, unless the server application B1 that corresponds to the SSL has been installed onto the server 2, it follows that the TCP B3 has not been mounted onto the server 2, whereby the TCP A17 cannot execute the 3-Way Handshake process with the TCP B3, and resultantly, cannot establish the TCP session 2. As a countermeasure method in such a case, for example, the following two countermeasure methods are thinkable.

(1) Such application data is cancelled in the intermediate driver A11 because it is impossible to encrypt and transmit/receive it between the PC 1 and the server 2, and there is a risk of being wiretapped.

(2) The data, which is not encrypted, is daringly transmitted to the TCP B6 of the server 2 without using the encryption function of the SSL A16 in anticipation of a risk that the data is wiretapped. In this case, it is necessary not only to change the setting of the frame analyzer A12 but also to establish a TCP session 3 between the TCP A17 and the TCP B6 so that the frame transmitted from the TCP B6 is transferred to the TCP A17.

The operational policy of security governs which method out of the above-mentioned two methods is employed.

Above, the operation in the case that the server application B1 that corresponded to the SSL was not installed onto the server 2 was explained; however in the following explanation, without making mention of these operations particularly, it is assumed to the last that the server application B1 that corresponds to the SSL has been installed onto the server 2.

Above, a digression was made a little, and now upon returning to the subject matter, the explanation of the operation of each module is continued.

From the above explanation, it can be seen that the data transfer between the client application A1 and the server application B1 is relayed with a total of the two TCP sessions consisting of the TCP session 1 between the TCP A2 and the TCP A14, and the TCP session 2 between the TCP A17 and the TCP B3. Relaying the TCP session by use of the intermediate driver A11 in such a manner makes it possible to achieve a coincidence of the TCP/IP protocol hierarchy between the SSL A16 of the PC 1 side and the SSL B2 of the server 2 side. This enables communication by the SSL protocol to be made, and the certificate information, the encryption algorithm, etc. for necessary for starting the SSL session to be exchanged between the SSL A16 of the PC 1 side and the SSL B2 of the server side.

Upon receipt of the packet from the TCP A17 through the connection P10 as shown in FIG. 9, the header converter A13 makes a reference to the table T2 and adds the MAC header and the IP header that corresponds to the received packet. Specifically, it adds the MAC header and the IP header that corresponds to the received packet, responding to the transmission source TCP. For example, the transmission source TCP of the packet received in the connection P10 is the TCP A17, whereby its MAC address and IP address has been registered into the upper stage of the table T2 of FIG. 10b. After inserting the IP header and the MAC header into the packet to generate a frame, the header converter A13 delivers the frame to the frame analyzer A12 through a connection P11. FIG. 11e shows a format of data that is delivered to the frame analyzer A12.

Upon receipt of the frame from the header converter A13 through the connection P11 as shown in FIG. 7, the frame analyzer A12 makes a reference to its header. As a header that is referenced herein, the MAC header, the IP header, etc. are listed. The frame analyzer A12 identifies the terminal, being the destination of the frame, from this header. As an example of the identification method, the method is thinkable of identifying the destination from the destination IP address of the header. The frame analyzer A12 delivers the frame to the driver A5 through a connection P12 according to the step S24 of FIG. 7 because the destination IP of the frame delivered in the connection P11 is the IP address i2 of the server 2.

Upon receipt of the frame from the frame analyzer A12 through the connection P12, the drivers A5 delivers the packet to the NIC A6 through a connection P13.

Upon receipt of the frame from the driver A5 through the connection P13, the NIC A6 delivers the frame to the NIC C3 through a connection P14.

Upon receipt of the frame from the NIC A6 through the connection P14, the NIC C3 delivers the frame to the driver C2 through a connection P15.

Upon receipt of the frame from the NIC C3 through the connection P15, the driver delivers the frame to the bridge C1 through a connection P16.

Upon receipt of the frame from the driver C2 through the connection P16, the bridge C1 makes a reference to the destination MAC address of the received frame. When the bridge C1 recognizes that the terminal having the destination MAC address has been connected to the NIC C5, it delivers the frame to the driver C4 through a connection P17.

Upon receipt of the frame from the bridge C1 through the connection P17, the driver C4 delivers the frame to the NIC C5 through a connection P18.

Upon receipt of the frame from the driver C4 through the connection P18, the NIC C5 delivers the frame to the NIC B8 through a connection P19.

Upon receipt of the frame from the NIC C5 through the connection P19, the NIC B8 delivers the frame to the driver B7 through a connection P20.

Upon receipt of the frame from the NIC B8 through the connection P20, the driver B7 delivers the frame to the IP stack B5 through a connection P21.

Upon receipt of the frame from the driver B7 through the connection P21, the IP stack B5 removes the MAC header and the IP header from the frame, thereby to generate a packet, and thereafter, delivers the packet to the IP routing B4 through a connection P22.

Upon receipt of the packet from the IP stack B5 through the connection P22, the IP routing B4 makes a reference to the TCP header of the packet. When IP routing B4 recognizes that the destination of the packet is the TCP B3 from the destination TCP port number, it delivers the received packet to the TCP B3 through a connection P23.

The TCP B3 receives the packet from the IP routing B4 through the connection P23, and makes a reference to the TCP header, thereby to investigate a reversal of the sequence and a missing of the packet. In a case where not only a reversal of the sequence and also a missing have not occurred, it removes the TCP header from the packet, and delivers the data to the SSL B2 through a connection P24. At this moment, the TCP B3 gives the TCP A17 an ACK packet for notifying arrival of the packet as a reply.

Upon receipt of the data from the TCP B3 through the connection P24, the SSL B2 uses the decoding technique settled with the SSL A16 of the PC 1, thereby to decode the data. The SSL B2 delivers the decoded data to the server application B1 through a connection P25.

Above, it was confirmed that the data transmitted from the client application A1 was encrypted and surely arrived at the server application B1.

Next, after completing the above-mentioned process, this time, an operation will be explained of the case that the data is transmitted from the server application B1 to the client application A1.

In a case where the server application B1 of the server 2 transmits the data to the client application A1 of the PC 1, it firstly delivers the data to the SSL B2 through a connection P27. FIG. 11f shows a format of the data that is delivered to the SSL B2.

Upon receipt of the data from the server application B1 through the connection P27, the SSL B2 encrypts the data, and thereafter, delivers the data to the TCP B3 through a connection P28. FIG. 11g shows a format of the data that is delivered to the TCP B3.

Upon receipt of the data from the SSL B2 through the connection P28, the TCP B3 adds the TCP header and the destination IP address to the data, thereby to packetize it. A port number t3 of the TCP A17 of the PC 1 is employed for the destination TCP port number of the TCP header, and a port number t4 of the TCP B3 for the transmission source TCP port number. Further, an IP address i1 of the PC 1 is set to the destination IP address. After adding the TCP header, the TCP B3 delivers the packet to the IP routing B4 through a connection P29.

Upon receipt of the packet from the TCP B3 through the connection P29, the IP routing B4 makes a reference to the destination IP address, and transmits the packet to the IP stack B5 through a connection P30.

Upon receipt of the packet from the IP routing B4 through the connection P30, the IP stack B5 adds the IP header and the MAC header to the packet, thereby to generate a frame. An IP address i1 of the PC 1 is employed for the destination IP address of the IP header, and an IP address i2 of the server 2 for the transmission source IP address. Further, an MAC address m1 of the PC 1 is employed for the destination MAC address of the MAC header, and an MAC address m2 of the server 2 for the transmission source MAC address. After inserting such a IP header and MAC header into the packet, thereby to generate a frame, the IP stack B5 delivers the frame to the driver B7 through a connection P31. FIG. 11h shows a format of data that is delivered to the driver B7.

Upon receipt of the frame from the IP stack B5 through the connection P31, the driver B7 delivers the frame to the NIC B8 through a connection P32.

Upon receipt of the frame from the driver B7 through the connection P32, the NIC B8 delivers the frame to the NIC C5 through a connection P33.

Upon receipt of the frame from the NIC B8 through the connection P33, the NIC C5 delivers the frame to the driver C4 through a connection P34.

Upon receipt of the frame from the NIC C5 through the connection P34, the driver C4 delivers the frame to the bridge C1 through a connection P35.

Upon receipt of the frame from the driver C4 through the connection P35, the bridge C1 makes a reference to the destination MAC address of the received packet. When bridge C1 recognizes that the terminal having the destination MAC address has been connected to the NIC C3, it delivers the frame to the driver C2 through a connection P36.

Upon receipt of the frame from the bridge C2 through the connection P36, the driver C2 delivers the frame to the NIC C3 through a connection P37.

Upon receipt of the frame from the driver C2 through the connection P37, the NIC C3 delivers the frame to the NIC A6 through a connection P38.

Upon receipt of the packet from the NIC C3 through the connection P38, the NIC A6 delivers the packet to the driver A5 through a connection P39.

Upon receipt of the frame from the NIC A6 through the connection P39, the driver A5 delivers the frame to the frame analyzer A12 through a connection P40.

Upon receipt of the frame from the driver A5 through the connection P40 as shown in FIG. 6, the frame analyzer A12 makes a reference to its header. The frame analyzer A12 determines whether the received frame has been encrypted from this header. As an example of the determination method, for example, as described in the explanation of the configuration, the method is thinkable of determining whether the frame has been encrypted from the TCP port number of the header. For example, with the encrypted mail, the protocol of SMTP over SSL is used, and no. 465 is employed as its transmission source TCP port number. In such a manner, it is determinable whether the data has been encrypted from the transmission source TCP port number. Further, so as to determine whether to decode the frame in the intermediate driver or in the TCP/IP protocol hierarchy higher than the intermediate driver, the frame analyzer A12 simultaneously makes a reference to the table T1 as well. Through such a series of the processes, the frame analyzer A12 determines that the packet delivered in the connection P40 needs to be decoded in the intermediate driver, and delivers the frame to the header converter A13 through a connection P41.

Upon receipt of the frame from the frame analyzer A12 through the connection P41 as shown in FIG. 8, the header converter A13 registers the MAC header and the IP header of the received frame into the table T2, responding to the destination TCP. The destination TCP of the frame received in the connection P41 is the TCP A17, whereby its MAC address and IP address is registered in the bottom stage of the table T2 of FIG. 10b. After registering the MAC header and the IP header into the table T2, the header converter A13 removes them from the frame, thereby to packetize it, and thereafter, makes a reference to the destination port number to deliver the packet to the TCP A17.

The TCP A17 receives the packet from the header converter A13 through a connection P42, and makes a reference to the TCP header, thereby to investigate a reversal of the sequence and a missing of the packet. In a case where not only a reversal of the sequence but also a missing have not occurred, it removes the TCP header from the packet, and delivers the data to the SSL A16 through a connection P43. At this moment, it gives the TCP B3 an ACK packet for notifying arrival of the packet as a reply.

Upon receipt of the data from the TCP A17 through the connection P43, the SSL A16 uses the decoding technique settled with the SSL B2, thereby to decode the data. The SSL A16 delivers the decoded data to the relay application A15 through a connection P44.

Upon receipt of the data from the SSL A16 through the connection P44, the relay application A15 delivers the data to the TCP A14 through a connection A45 for a purpose of sending the data to the client application A1.

Upon receipt of the data from the relay application A15 through the connection P45, the TCP A14 adds the TCP header and the destination IP address to the data, thereby to packetize it. A port number t1 of the TCP A2 is employed for the destination TCP port number of the TCP header, and a port number t2 of the TCP B6 for the transmission source TCP port number. Further, an IP address i1 of the PC 1 is set to the destination IP address. After adding the TCP header, the TCP A14 delivers the packet to the header converter A13 through a connection P46.

Upon receipt of the packet from the TCP A14 through the connection P46 as shown in FIG. 9, the header converter A13 makes a reference to the table T2 and adds the MAC header and the IP header to the received packet, thereby to convert it into a frame. Specifically, it adds the MAC header and the IP header that corresponds to the received packet, responding to the transmission source TCP. For example, the transmission source TCP of the packet received in the connection P46 is the TCP A14, whereby its MAC address and IP address has been registered into the bottom stage of the table T2 of FIG. 10b. After inserting the IP header and the MAC header into the packet, thereby to generate a frame, the header converter A13 delivers the frame to the frame analyzer A12 through a connection P47. FIG. 11j shows a format of data that is delivered to the frame analyzer A12.

Upon receipt of the frame from the header converter A13 through the connection P47 as shown in FIG. 7, the frame analyzer A12 makes a reference to its header. As a header that is referenced herein, the MAC header, the IP header, etc. are listed. The frame analyzer A12 identifies the terminal, being the destination of the frame, from this header. As an example of the identification method, the method is thinkable of identifying the destination from the destination IP address of the header. The frame analyzer A12 delivers the frame to the IP stack A4 through a connection P48 according to the step S25 of FIG. 7 because the destination IP of the frame delivered in the connection P47 is the IP address i1 of the PC 1.

Upon receipt of the frame from the frame analyzer A12 through the connection P48, the IP stack A4 removes the MAC header and the IP header from the frame, thereby to packetize it, and thereafter, delivers the packet to the IP routing A3 through a connection P49.

Upon receipt of the packet from the IP stack A4 through the connection P49, the IP routing A3 makes a reference to the TCP header of the packet. When the IP routing A3 recognizes that the destination of the packet is the TCP A2 from the destination TCP port number, it delivers the received packet to the TCP A2 through a connection P50.

The TCP A2 receives the packet from the IP routing A3 through the connection P50, and makes a reference to the TCP header, thereby to investigate a reversal of the sequence and a missing of the packet. In a case where not only a reversal of the sequence but also a missing have not occurred, it removes the TCP header from the packet, and delivers the data to the client application A1 through a connection P51. At this moment, it gives the TCP A14 an ACK packet for notifying arrival of the packet as a reply. As mentioned above, it was confirmed that the data transmitted from the server application B1 was encrypted and surely arrived at the client application A1.

From the above explanation, it was confirmed that bi-directional communication between the client application A1 and the server application B1 was encrypted without fail.

Further, in the above explanation, the configuration in which encrypted data was exchanged between the PC 1 and the server 2 was explained, and in a case where the PC 1 exchanges encrypted data with a plurality of the servers in addition to the server 2, the intermediate driver A11 of the PC 1 assumes a configuration described below.

The intermediate driver A11, which includes the header converter A13, the TCP A14, the relay application A15, the SSL A16, the TCP A17, and the header converter A13 for each server that becomes a communication partner, establishes the different TCP session 2 for each server that becomes a communication partner. Data that is transmitted/received between the PC 1 and each server is encrypted, and exchanged through the TCP session 2. This enables the PC 1 to exchange the encrypted data with a plurality of the servers.

[Effects]

Next, effects of this embodiment will be explained.

In this embodiment, incorporating the TCP relay function into the intermediate driver A11 makes it possible to achieve a coincidence of the TCP/IP protocol hierarchy between the SSL A16 of the PC 1 side and the SSL B2 of the server 2 side, thereby enabling the communication by the SSL protocol between the SSL A16 of the PC 1 side and the SSL B2 of the server 2 side. With this, the certificate information or the encryption algorithm necessary for starting the SSL session is automatically exchanged between the server 2 and the PC 1, which can eliminate a burden of manually setting the encryption key to the intermediate driver of the PC 1 side.

Further, with the server 2, a configuration of its software does not need to be changed, differently from the conventional case, whereby a burden of installing the intermediate driver into the server 2 can be eliminated.

In addition hereto, the frame analyzer A12 is configured to determine whether or not the transmission data has been encrypted, and to encrypt it in a case where it has not been encrypted, whereby the transmission data can be transmitted in a state of having been encrypted surely.

### Second Embodiment

[Explanation of a Configuration]

Next, a second embodiment for carrying out the second invention of the present invention will be explained in details by making a reference to the accompanied drawings. A network configuration of the second embodiment is identical to that of the first embodiment of FIG. 1, so its explanation is omitted.

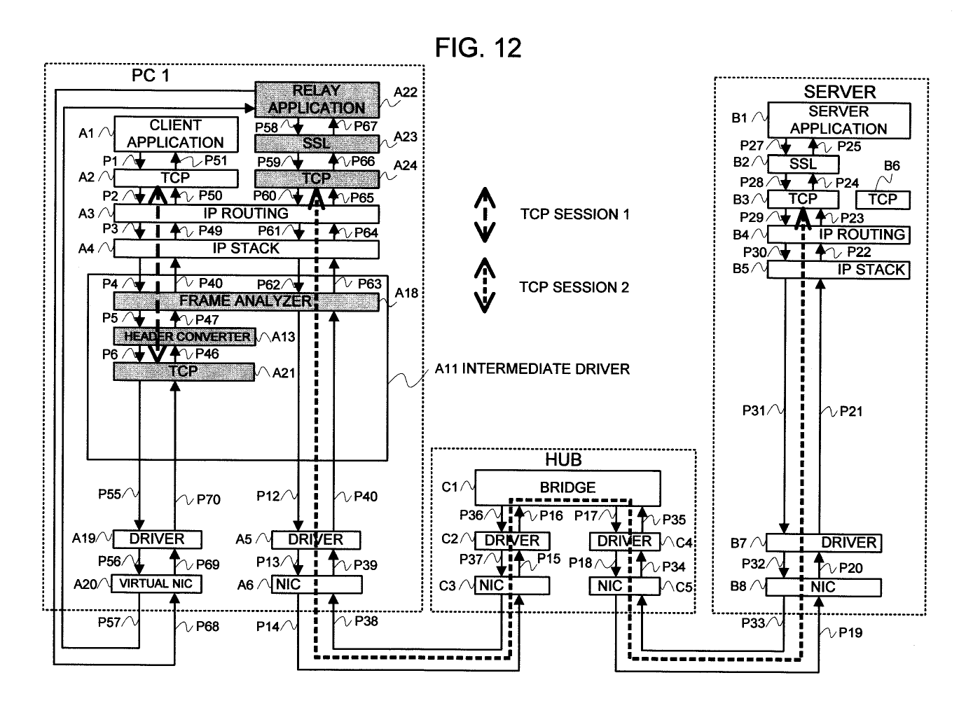

FIG. 12 is a view illustrating a communication process of the CPU and the NIC that are mounted onto each apparatus of this embodiment. Upon making a reference to FIG. 12, the second embodiment differs from the first embodiment in a point of including a driver A19, a virtual NIC A20 in addition to the configuration of the PC 1 in the first embodiment shown in FIG. 3.

A function of the driver A19 is identical to that of the driver A5 shown in FIG. 3, so its explanation is omitted.

The virtual NIC A20 is software for mediating between the driver A19 and a relay application A15. The virtual NIC A20 has a function of receiving the frame from the driver A19, and delivering it to the relay application A15. Further, it has a function of receiving the frame from the relay application A15, and sending it to the driver A19. Originally, the NIC is configured with hardware; however the virtual NIC is configured with software. The virtual NIC is recognized as if it were hardware from a view of the OS.

Further, upon making a reference to FIG. 12, the second embodiment differs from the first embodiment in a point that, out of the modules packaged inside the intermediate driver A11 in the first embodiment, the module replaceable with the function of the OS is separated from the intermediate driver A11. Specifically, in the second embodiment, the SSL A16 and the TCP A17 incorporated in the intermediate driver A11 of the first embodiment are separated from the intermediate driver A11, and these modules are replaced with the function incorporated into the normal terminal as the OS. Further, in the second embodiment, the relay application as well is separated from the intermediate driver, and the intermediate driver and the relay application are loopback-connected via the virtual NIC. Accompanied thereby, the function of each module of the intermediate driver A11 changes as described below.

An outline of a function of a TCP A21 is almost similar to that of the TCP A14 of the first embodiment shown in FIG. 3; however the TCP A21 differs from the TCP A17 of the first embodiment in a point that the module, being a deliveree of its data, is not the relay application A15 but the driver A19.

An outline of a function of the relay application A22 is almost similar to that of the relay application A15 of the first embodiment shown in FIG. 3; however the relay application A22 differs from the relay application A15 of the first embodiment in a point that the module, being a deliveree of its data, is not the TCP A14 but the virtual NIC A20.

An outline of a function of a TCP A24 is almost similar to that of the TCP A17 of the first embodiment shown in FIG. 3; however the TCP A24 differs from the TCP A17 of the first embodiment in a point that the module, being a deliveree of its data, is not the header converter A13 but the IP routing A3. Further, the TCP A24 differs from the TCP A17 of the first embodiment in a point of being incorporated into not the intermediate driver A11 but the OS.

An outline of a function of a SSL A23 is almost similar to that of the SSL A16 of the first embodiment shown in FIG. 3; however the SSL A23 differs from the SSL A16 of the first embodiment in a point of being incorporated into not the intermediate driver A11 but the OS.

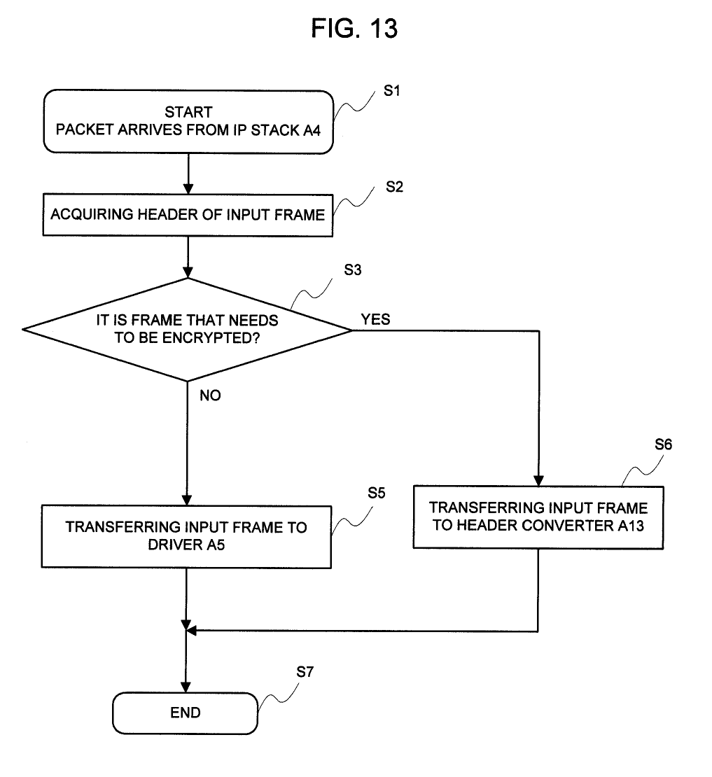

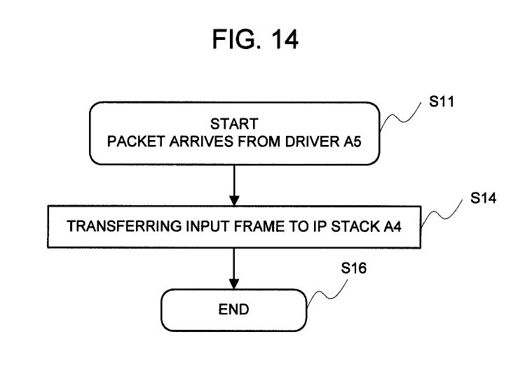

Next, a function of a frame analyzer A18 will be explained. Each of FIG. 13 and FIG. 14 is an operational flowchart for explaining the process of the frame analyzer A18 in details. FIG. 13 shows an operational flowchart of the frame analyzer A18 in the case that the frame has arrived from the IP stack A4. The frame analyzer A18 differs from the frame analyzer A12 of the first embodiment in a point that the process (step S4 of FIG. 5) of registering the header of the frame into the table T1 is omitted. The other process is identical to that of FIG. 5, so its explanation is omitted.

On the other hand, FIG. 14 shows an operational flowchart of the frame analyzer A18 in the case that the frame has arrived from the driver A5. The frame analyzer A18 differs from the frame analyzer A12 of the first embodiment in a point of transferring all frames that have arrived to the IP stack A4 (step S14).

Further, an operational flowchart of the frame analyzer A18 in the case that the frame has arrived from the header converter A13 is entirely identical to that of the frame analyzer A12 of the first embodiment, which was already explained by employing FIG. 7, so its explanation is omitted.

The function of the block other than the foregoing components, out of the components shown in FIG. 12, is entirely identical to that of the first embodiment shown in FIG. 3, so its explanation is omitted.

[Explanation of an Operation]

An operation of this embodiment will be explained below by making a reference to FIG. 12. A point in which this embodiment differs from the first embodiment shown in FIG. 3 lies only in an operation of the PC 1, so only the operation of the PC 1 will be explained.

At first, an operation in the case that data is transmitted from the client application A1 of the PC 1 to the server application B1 of the server 2 will be explained. However, the operation until a connection P3 is identical to that of the first embodiment, so the explanation of the operation is started at time point of a connection P4.

Upon receipt of the frame from the IP stack A4 through the connection P4 as shown in FIG. 13, the frame analyzer A18 makes a reference to its header. The frame analyzer A12 determines whether the received data has been encrypted from this header. The frame analyzer A18 determines that the data delivered in the connection P4 has not been encrypted, and delivers the frame to the header converter A13 through a connection P5.

Upon receipt of the frame from the frame analyzer A18 through the connection P5 as shown in FIG. 8, the header converter A13 registers the MAC header and the IP header of the received frame into the table T2 responding to the destination TCP. FIG. 10b shows an example of the table T2. It is determined that the destination TCP of the frame received in the connection P5 is the TCP A21 because the port number of the TCP A21 has been caused to coincide with the port number t2 of the TCP B6, and its MAC address and IP address are registered into the top stage of the table T2 of FIG. 10b. After registering the header of the received frame into the table T2, the header converter A13 removes the MAC header and the IP header from the frame, thereby to convert it into a packet, and thereafter, makes a reference to the destination port number to deliver the packet to the TCP A21. FIG. 11c shows a format of data that is delivered to the TCP A21.

Upon receipt of the packet from the header converter A13 through a connection P6, the TCP A21 makes a reference to the TCP header, thereby to investigate a reversal of the sequence and a missing of the packet, and in a case where not only a reversal of the sequence but also a missing have not occurred, removes the header from the packet, and delivers the data to the driver A19 through a connection P55. At this moment, it gives the TCP A2 an ACK packet for notifying arrival of the packet as a reply, thereby to terminate the TCP session from the TCP A2. Upon viewing from the TCP A2, the TCP session looks as if it had been established between the TCP A2 and the TCP B6 because the TCP port number of the TCP A21 has been caused to correspond to the TCP port number t2 of the TCP B6; however the actual TCP session is established between the TCP A2 and the TCP A21. In FIG. 12, this TCP session is shown with a broken line.

Upon receipt of the packet from the TCP A21 through the connection P55, the driver A19 delivers the packet to the virtual NIC A20 through a connection P56.

Upon receipt of the packet from the driver A19 through the connection P56, the virtual NIC A20 delivers the packet to the relay application A22 through a connection P57.

Upon receipt of the data from the virtual NIC A20 through the connection P57, the relay application A22 delivers the data to the SSL A23 through a connection P58 for a purpose of encrypting the data to realize prevention of the wiretapping.

Upon receipt of the data from the relay application A22 through the connection P58, the SSL A23 uses an encryption technique pre-settled with the SSL B2 of the server 2, thereby to encrypt the data. After completing the encryption, the SSL A23 delivers the encrypted data to the TCP A24 through a connection P59. FIG. 11d shows a format of data that is delivered to the TCP A24.

Upon receipt of the data from the SSL A23 through the connection P60, the TCP A24 adds the TCP header and the destination IP address to the data, thereby to packetize it. A port number t4 of the TCP B3 of the server 2 is employed for the destination TCP port number of the TCP header, and a port number t3 of the TCP A24 for the transmission source TCP port number. Herein, the port number t4 of the TCP B3 is a port number that is explicitly used in transmitting the encrypted data. For example, in a case of transmitting the encrypted mail, the protocol of SMTP over SSL is used, and no. 465 is employed as its destination TCP port number. Further, an IP address i2 of the server 2 is set to the destination IP address. After adding the TCP header and the destination IP address, the TCP A24 delivers the packet to the IP routing A3 through a connection P60. The TCP A24 establishes the TCP session with the TCP B3 by use of theses processes, and realizes the stabilized data transfer to/from the TCP B3. In FIG. 12, this TCP session is shown with a dotted line.

From the above explanation, it can be seen that the data transfer between the client application A1 and the server application B1 is relayed with a total of the two TCP sessions consisting of the TCP session 1 between the TCP A2 and the TCP A21, and the TCP session 2 between the TCP A24 and the TCP B3. Relaying the TCP session by use of the intermediate driver A11 in such a manner makes it possible to achieve a coincidence of the TCP/IP protocol hierarchy between the SSL A23 of the PC 1 side and the SSL B2 of the server 2 side. This enables communication by the SSL protocol to be made, and the certificate information, the encryption algorithm, etc. for necessary for starting the SSL session to be exchanged between the SSL A23 of the PC 1 side and the SSL B2 of the server side.

Upon receipt of the packet from the TCP A24 through the connection P60, the IP routing A3 makes a reference to the destination IP address to deliver the packet to the IP stack A4 through a connection P61.

Upon receipt of the packet from the IP routing A3 through the connection P61, the IP stack A4 adds the IP header and the MAC header to the packet, thereby to generate a frame. An IP address i2 of the server 2 is employed for the destination IP address of the IP header, and an IP address i1 of the PC 1 for the transmission source IP address. Further, an MAC address m2 of the server 2 is employed for the destination MAC address of the MAC header, and an MAC address m1 of the PC 1 for the transmission source MAC address. After inserting such an IP header and MAC header into the packet, thereby to generate a frame, the IP stack A4 delivers the frame to the frame analyzer A18 through a connection P62. FIG. 11e shows a format of data that is delivered to the frame analyzer A18.

Upon receipt of the frame from the IP stack A4 through the connection P62 as shown in FIG. 13, the frame analyzer A18 makes a reference to its header. The frame analyzer A18 determines whether the received data has been encrypted from this header. The frame analyzer A18 determines that the frame delivered in the connection P62 has been encrypted, and delivers the frame to the driver A5 through a connection P12.

The operation after it is entirely identical to that of the first embodiment of FIG. 3, so its explanation is omitted. As mentioned above, it was confirmed that the data transmitted from the client application A1 was encrypted, and surely arrived at the server application B1.

Next, after completing the above-mentioned process, this time, an operation will be explained of the case that the data is transmitted from the server application B1 to the client application A1. However, a point in which this embodiment differs from the first embodiment shown in FIG. 3 lies only in an operation of the PC 1, so only the operation of the PC 1 will be explained. Thus, the explanation of the operation is started at a time point of a connection P39 that the data transmitted from the server application B1 of the server 2 has arrived at the NIC A6 of the PC 1.

Upon receipt of the frame from the NIC A6 through the connection P39, the driver A5 delivers the frame to the frame analyzer A18 through a connection P40.

Upon receipt of the frame from the driver A5 through the connection P40, as shown in FIG. 14, the frame analyzer A18 delivers the received frame to the IP stack A4 as it stands through a connection P63.

Upon receipt of the frame from the frame analyzer A18 through the connection P63, the IP stack A4 removes the MAC header and the IP header from the frame, thereby to convert it into a packet, and thereafter, delivers the packet to the IP routing A3 through a connection P64.

Upon receipt of the packet from the IP stack A4 through the connection P64, the IP routing A3 makes a reference to the TCP header of the packet. When the IP routing A3 recognizes that the destination of the packet is the TCP A24 from the destination TCP port number, it delivers the received packet to the TCP A24 through a connection P65.

The TCP A24 receives the packet from the IP routing A3 through the connection P65, and makes a reference to the TCP header, thereby to investigate a reversal of the sequence and a missing of the packet. In a case where not only a reversal of the sequence but also a missing have not occurred, it removes the TCP header from the packet, and delivers the data to the SSL A23 through a connection P66. At this moment, it gives the TCP B3 an ACK packet for notifying arrival of the packet as a reply (TCP session 2).

Upon receipt of the data from the TCP A24 through the connection P66, the SSL A23 uses the decoding technique settled with the SSL B2 of the server 2, thereby to decode the data. The SSL A23 delivers the decoded data to the relay application A22 through a connection P67.

Upon receipt of the data from the SSL A23 through the connection P67, the relay application A22 delivers the data to the virtual NIC A20 through a connection A68 for a purpose of sending the data to the client application A1.

Upon receipt of the packet from the relay application A22 through the connection P68, the virtual NIC A20 delivers the packet to the driver A19 through a connection P69.

Upon receipt of the packet from the virtual NIC A20 through the connection P69, the driver A19 delivers the packet to the TCP A21 through a connection P70.

Upon receipt of the data from the driver A19 through the connection P70, the TCP A21 adds the TCP header and the destination IP address to the data, thereby to packetize it. A port number t1 of the TCP A2 is employed for the destination TCP port number of the TCP header, and a port number t2 of the TCP B6 for the transmission source TCP port number. Further, an IP address i1 of the PC 1 is set to the destination IP address. After adding the TCP header, the TCP A21 delivers the packet to the header converter A13 through a connection P46 (TCP session 1).

Upon receipt of the packet from the TCP A21 through the connection P46 as shown in FIG. 9, the header converter A13 makes a reference to the table T2, and adds the MAC header and the IP header that corresponds to the received packet, thereby to convert it into a frame. Specifically, it adds the MAC header and the IP header to the received packet, responding to the transmission source TCP. For example, the transmission source TCP of the packet received in the connection P46 is the TCP A21, whereby its MAC address and IP address has been registered in the bottom stage of the table T2 of FIG. 10b. After inserting the IP header and the MAC header into the packet, the header converter A13 delivers the frame to the frame analyzer A18 through a connection P47. FIG. 11j shows a format of data that is delivered to the frame analyzer A18.

The operation after it is entirely identical to that of the first embodiment of FIG. 3, so its explanation is omitted.

As mentioned above, it was confirmed that the data transmitted from the server application B1 was encrypted and surely arrived at the client application A1.

Next, effects of this embodiment will be explained.

This embodiment has the following effect in addition to the effects of the first embodiment.

In this embodiment, loopbacking the frame, which needs to be encrypted, from the intermediate driver A11 into the OS so that the function of the SSL A16 incorporated inside the intermediate driver A11 in the first embodiment can be replaced with the function of the SSL A23 already incorporated into the OS eliminates a burden that the software developer bears for packaging the SSL A16 into the intermediate driver. This makes it possible to reduce the load that is imposed upon the software developer, and to reduce a burden of the development.

### Third Embodiment

[Explanation of a Configuration]

Next, a third embodiment for carrying out the second invention of the present invention will be explained in details by making a reference to the accompanied drawings. A network configuration of the third embodiment is identical to that of the first embodiment of FIG. 1, so its explanation is omitted.

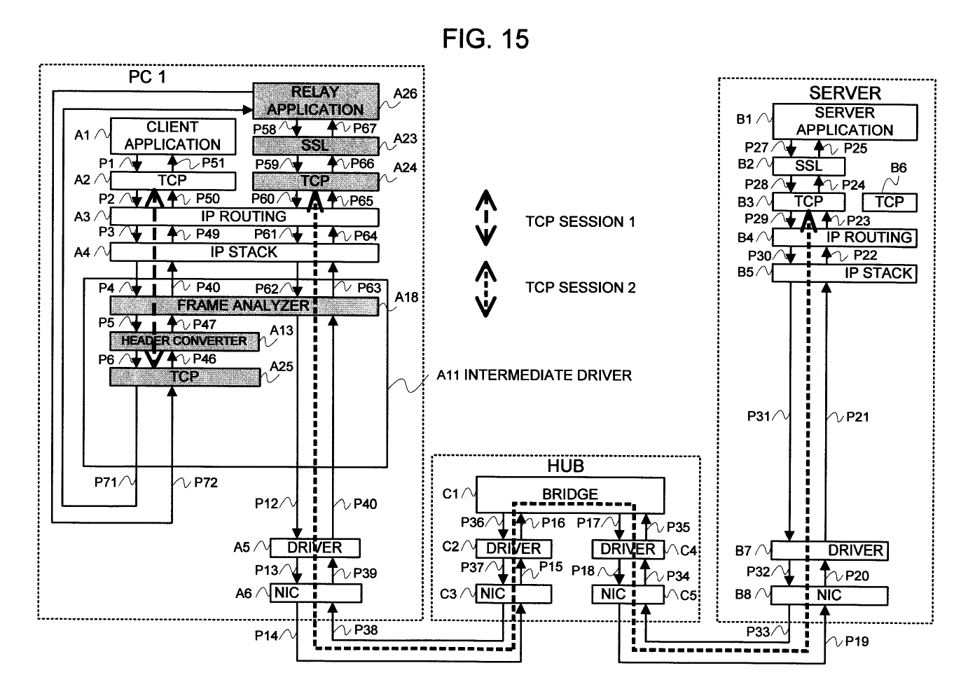

FIG. 15 is a view illustrating a communication process of the CPU and the NIC that are mounted onto each apparatus of this embodiment. Upon making a reference to FIG. 15, the third embodiment differs from the second embodiment in a point that, out of the components of the PC 1 in the second embodiment shown in FIG. 12, the driver A19 and the virtual NIC A20 are excluded, and that a TCP A25 and a relay application A26 are directly loopback-connected. Accompanied thereby, the function of each module changes as described below.

An outline of a function of the TCP A25 is almost similar to that of the TCP A21 of the second embodiment shown in FIG. 12; however the TCP A25 differs from the TCP A21 of the second embodiment in a point that the module, being a deliveree of its data, is not the driver A19 but the relay application A26.

An outline of a function of the relay application A26 is almost similar to that of the relay application A22 of the second embodiment shown in FIG. 12; however the relay application A26 differs from the relay application A22 of the second embodiment in a point that the module, being a deliveree of its data, is not the virtual NIC A20 but the TCP A25.

The function of the blocks other than the foregoing components out of the components shown in FIG. 15 is entirely identical that of the second embodiment shown in FIG. 12, so its explanation is omitted.

[Explanation of an Operation]

An operation of this embodiment will be explained below by making a reference to FIG. 15. A point in which this embodiment differs from the second embodiment shown in FIG. 12 lies only in an operation of the PC 1, so only the operation of the PC 1 will be explained.

At first, an operation in the case that data is transmitted from the client application A1 of the PC 1 to the server application B1 of the server 2 will be explained. However, the operation until a connection P5 is identical to that of the second embodiment, so the explanation of the operation is started at time point of a connection P6.

Upon receipt of the packet from the header converter A13 through the connection P6, the TCP A25 makes a reference to the TCP header, thereby to investigate a reversal of the sequence and a missing of the packet, and in a case where not only a reversal of the sequence but also a missing have not occurred, it removes the header from the packet, and delivers the data to the relay application A26 through a connection P71. At this moment, it gives the TCP A2 an ACK packet for notifying arrival of the packet as a reply, thereby to terminate the TCP session from the TCP A2. Upon viewing from the TCP A2, the TCP session looks as if it had been established between the TCP A2 and the TCP B6 because the TCP port number of the TCP A25 has been caused to correspond to the TCP port number t2 of the TCP B6; however the actual TCP session has been established between the TCP A2 and the TCP A25. In FIG. 15, this TCP session is shown with a broken line (TCP session 1).

Upon receipt of the data from the TCP A25 through the connection P71, the relay application A26 delivers the data to the SSL A23 through a connection P58 for a purpose of encrypting it to realize prevention of the wiretapping.

The operation after it is entirely identical to that of the second embodiment of FIG. 12, so its explanation is omitted.

As mentioned above, it was confirmed that the data transmitted from the client application A1 was encrypted and surely arrived at the server application B1.

Next, after completing the above-mentioned process, this time, an operation will be explained of the case that the data is transmitted from the server application B1 to the client application A1. However, a point in which this embodiment differs from the second embodiment shown in FIG. 12 lies only in an operation of the relay application A26 and the TCP A25 of the PC 1 side, so only its point will be explained. Thus, the explanation of the operation is started at a time point of a connection P67 that the data transmitted from the server application B1 of the server 2 has arrived at the relay application A26 of the PC 1.

Upon receipt of the data from the SSL A23 through the connection P67, the relay application A26 delivers the data to the TCP A25 through a connection P72 for a purpose of sending it to the client application A1.

Upon receipt of the data from the relay application A26 through the connection P72, the TCP A25 adds the TCP header and the destination IP address to the data, thereby to packetize it. A port number t1 of the TCP A2 is employed for the destination TCP port number of the TCP header, and a port number t2 of the TCP B6 for the transmission source TCP port number. Further, the IP address i1 of the PC 1 is set to the destination IP address. After adding the TCP header, the TCP A25 delivers the packet to the header converter A13 through a connection P46 (TCP session 1).

The operation after it is entirely identical to that of the second embodiment of FIG. 12, so its explanation is omitted.

As mentioned above, it was confirmed that the data transmitted from the server application B1 was encrypted and surely arrived at the client application A1.

[Effects]

Next, effects of this embodiment will be explained.

This embodiment has the following effect in addition to the effects of the second embodiment.

In this embodiment, performing the loopback process between the TCP A25 and the relay application A26 so that the driver A19 and the virtual NIC A20 incorporated into the PC 1 in the second embodiment can be excluded eliminates a burden that the software developer bears for developing these modules. This makes it possible to reduce the load that is imposed upon the software developer, and to reduce a burden of the development.

Further, in the second embodiment, there is a risk that a security level declines in the PC 1 when the virtual NIC A20 and the NIC A6 are bridge-connected; however in this embodiment, the bridge-connection is impossible because the virtual NIC A20 itself has been excluded, and a burden as well of taking a security countermeasure can be reduced.

### Fourth Embodiment

[Explanation of a Configuration]

Next, a fourth embodiment for carrying out the second invention of the present invention will be explained in details by making a reference to the accompanied drawings. A network configuration of the fourth embodiment is identical to that of the first embodiment of FIG. 1, so its explanation is omitted.

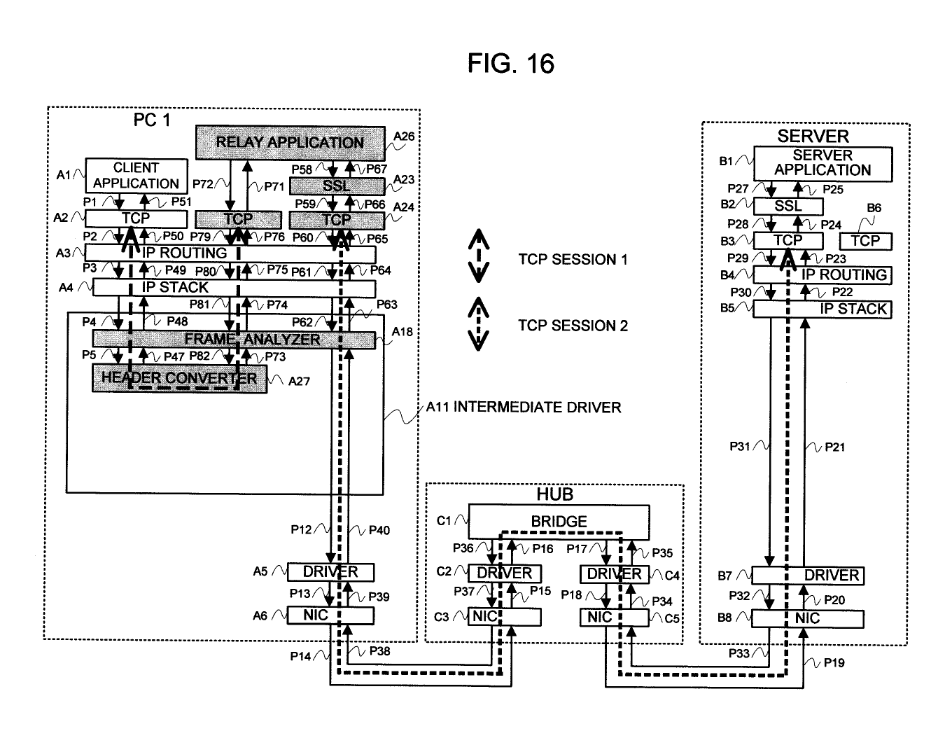

FIG. 16 is a view illustrating a communication process of the CPU and the NIC that are mounted onto each apparatus of this embodiment. Upon making a reference to FIG. 16, the fourth embodiment differs in a point that, out of the components of the PC 1 in third embodiment shown in FIG. 15, the TCP A14 incorporated into the intermediate driver A11 is separated from the intermediate driver A11, and this module is replaced with the function of the OS. Accompanied thereby, the function of each module changes as described below.

An outline of a function of a TCP A29 is almost similar to that of the TCP A25 of the third embodiment shown in FIG. 15; however the TCP A29 differs from the TCP A25 of the third embodiment in a point that the module, being a deliveree of its data, is not the header converter A13 but the IP routing A3. Further, the TCP A29 differs from the TCP A25 of the third embodiment in a point of being incorporated into not the intermediate driver A11 but the OS.

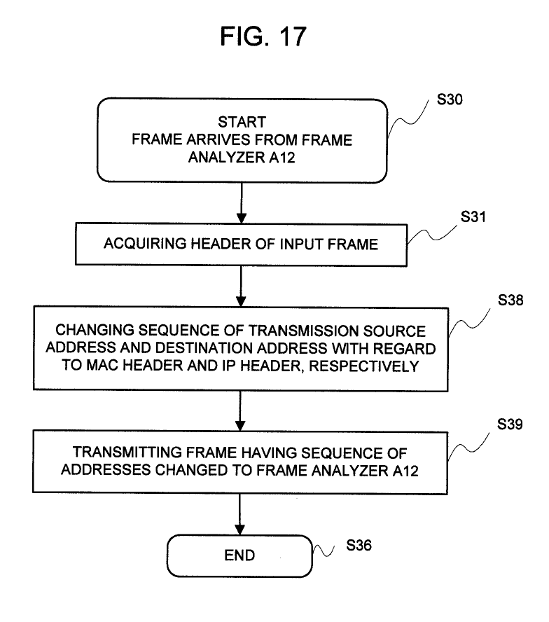

Next, a function of a header converter A27 will be explained. The header converter A27 is connected to the frame analyzer A18. FIG. 17 is a flowchart for explaining the process of the header converter A27 in details. After firstly acquiring the header of the frame that has arrived (step S31), the header converter A27 reverses a relation between the transmission source and the destination with regard to the MAC address and the IP address described in its header, respectively, (step S38). Finally, the header converter A27 transmits to the frame analyzer A18 the frame having a relation between the transmission source and the destination reversed with regard to each address (step S39).

Functions of the blocks other than the foregoing components, out of the components shown in FIG. 16, are entirely identical that of the third embodiment shown in FIG. 15, so its explanation is omitted.

[Explanation of an Operation]

An operation of this embodiment will be explained below by making a reference to FIG. 16. A point in which this embodiment differs from the third embodiment shown in FIG. 15 lies only in an operation of the header converter A27 and the TCP A14 of the PC 1 side, so only its point will be explained.

At first, an operation in the case that data is transmitted from the client application A1 of the PC 1 to the server application B1 of the server 2 will be explained. However, the operation until a connection P4 is identical to that of the third embodiment, so the explanation of the operation is started at time point of a connection P5.

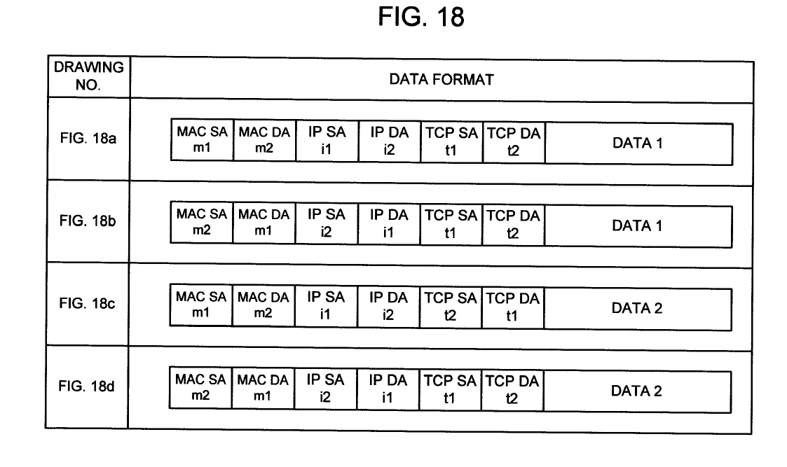

Upon receipt of the packet from the frame analyzer A18 through the connection P5 as shown in FIG. 17, the header converter A27 acquires the header of the received frame, and thereafter, reverses a relation between the transmission source and the destination with regard to its MAC address and IP address. In FIG. 18, its example is shown. For example, assume that the frame described in FIG. 18a is a frame input into the header converter A27, it follows that the frame output from the header converter A27 has a relation between its transmission source address and destination address reversed like the frame described in FIG. 18b. After making such a conversion for the header of the frame, the header converter A27 transmits the frame to the frame analyzer A18 through a connection P73.

Upon receipt of the frame from the header converter A27 through the connection P73 as shown in FIG. 7, the frame analyzer A18 makes a reference to its header. As a header that is referenced herein, the MAC header, the IP header, etc. are listed. The frame analyzer A18 identifies the terminal, being the destination of the frame, from this header. The frame analyzer A18 delivers the frame to the IP stack A4 through a connection P74 according to the step S25 of FIG. 7 because the destination IP of the frame delivered in the connection P73 is the IP address i1 of the PC 1.

Upon receipt of the packet from the frame analyzer A18 through the connection P74, the IP stack A4 removes the MAC header and the IP header from the packet, thereby to convert it into a packet, and thereafter, delivers the packet to the IP routing A3 through a connection P75.

Upon receipt of the packet from the IP stack A4 through the connection P75, the IP routing A3 makes a reference to the TCP header of the packet. When the IP routing A3 recognizes that the destination of the packet is the TCP A29 from the destination TCP port number, it delivers the received packet to the TCP A29 through a connection P76.

The TCP A29 receives the packet from the IP routing A3 through the connection P76, and makes a reference to the TCP header, thereby to investigate a reversal of the sequence and a missing of the packet. In a case where not only a reversal of the sequence but also a missing have not occurred, it removes the TCP header from the packet, and delivers the data to the relay application A26 through a connection P71. At this moment, it gives the TCP A2 an ACK packet for notifying arrival of the packet as a reply, thereby to terminate the TCP session from the TCP A2. Upon viewing from the TCP A2, the TCP session looks as if it had been established between the TCP A2 and the TCP B6 because the TCP port number of the TCP A29 has been caused to correspond to the TCP port number t2 of the TCP B6; however the actual TCP session is established between the TCP A2 and the TCP A29. In FIG. 16, this TCP session is shown with a broken line (TCP session 1).

The operation after it is entirely identical to that of the third embodiment of FIG. 15, so its explanation is omitted.

As mentioned above, it was confirmed that the data transmitted from the client application A1 was encrypted and surely arrived at the server application B1.

Next, after completing the above-mentioned process, this time, an operation will be explained of the case that the data is transmitted from the server application B1 to the client application A1. However, a point in which this embodiment differs from the third embodiment shown in FIG. 15 lies only in an operation of the TCP A29 and the header converter A27 of the PC 1 side, so only its point will be explained. Thus, the explanation of the operation is started at a time point of a connection P67 that the data transmitted from the server application B1 of the server 2 has arrived at the relay application A26 of the PC 1.

Upon receipt of the data from the SSL A23 through the connection P67, the relay application A26 delivers the data to the TCP A29 through the connection P72 for a purpose of sending it to the client application A1.

Upon receipt of the data from the relay application A26 through the connection P72, the TCP A29 adds the TCP header and the destination IP address to the data, thereby to packetize it. A port number t1 of the TCP A2 is employed for the destination TCP port number of the TCP header, and a port number t2 of the TCP B6 for the transmission source TCP port number. Further, an IP address i2 of the server 2 is set to the destination IP address. After adding the TCP header, the TCP A29 delivers the packet to the IP routing A3 through a connection P79 (TCP session 1).

Upon receipt of the packet from the TCP A29 through the connection P79, the IP routing A3 makes a reference to the destination IP address to transmit the packet to the IP stack A4 through a connection P80.

Upon receipt of the packet from the IP routing A3 through the connection P80, the IP stack A4 adds the IP header and the MAC header to the packet, thereby to generate a frame. An IP address i2 of the server 2 is employed for the destination IP address of the IP header, and an IP address i1 of the PC 1 for the transmission source IP address. Further, an MAC address m2 of the server 2 is employed for the destination MAC address of the MAC header, and an MAC address m1 of the PC 1 for the transmission source MAC address. After inserting such an IP header and MAC header into the packet, the IP stack A4 delivers the frame to the frame analyzer A18 through a connection P81. FIG. 18c shows a format of data that is delivered to the frame analyzer A18.

Upon receipt of the frame from the IP stack A4 through the connection P81 as shown in FIG. 13, the frame analyzer A18 makes a reference to its header. The frame analyzer A18 determines whether the received data has been encrypted from this header. The frame analyzer A18 determines that the frame delivered in the connection P81 has been encrypted, and delivers the frame to the header converter A27 through a connection P82.

Upon receipt of the frame from the frame analyzer A18 through the connection P82 as shown in FIG. 17, the header converter A27 acquires the header of the received frame, and reverses a relation between the transmission source and the destination with regard to the MAC address and the IP address described therein. For example, assume that the frame described in FIG. 18c is an input frame, it follows that the frame output from the header converter A27 has a relation between the transmission source address and the destination address reversed with regard to its MAC address and IP address like the frame described in FIG. 18d. After making such a conversion for the header of the frame, the header converter A27 transmits the frame to the frame analyzer A18 through a connection P47.

The operation after it is entirely identical to that of the third embodiment of FIG. 15, so its explanation is omitted.

As mentioned above, it was confirmed that the data transmitted from the server application B1 was encrypted and surely arrived at the client application A1.

[Effects]

Next, effects of this embodiment will be explained.

This embodiment has the following effect in addition to the effects of the third embodiment.

In this embodiment, changing the transmission source address and the destination address over to each other with regard to the frame, which needs to be encrypted, in the intermediate driver so that the function of the TCP A14 incorporated inside the intermediate driver A11 in the third embodiment can be replaced with the function of the TCP A29 already incorporated into the OS eliminates a burden that the software developer bears for packaging the TCP A14 into the intermediate driver. This makes it possible to reduce the load that is imposed upon the software developer, and to reduce a burden of the development.

### Fifth Embodiment

[Explanation of a Configuration]

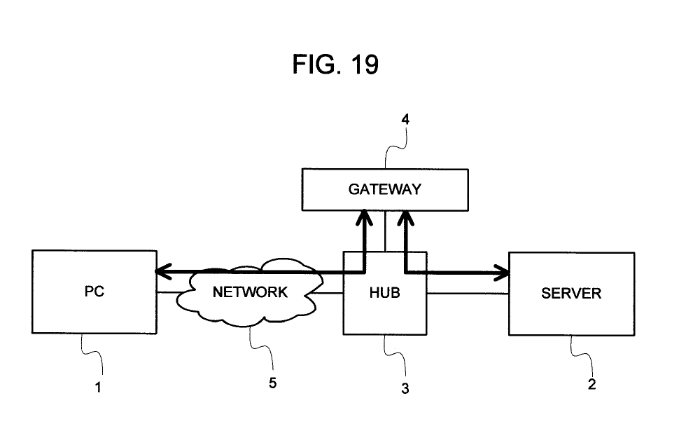

Next, a fifth embodiment for carrying out the third invention of the present invention will be explained in details by making a reference to the accompanied drawings. FIG. 19 is a view illustrating a network configuration of the fifth embodiment, which is a configuration including a PC 1, a server 2, a hub 3, and a gateway 4.

The PC 1 is connected to the hub 3 via a network 5. Herein, it is assumed that the so-called network 5 is what those skilled in the relevant field can imagine from the network, for example, LAN (Local Area Network), WAN (Wide Area Network), and Internet. The PC 1 receives the frame from the network 5, and performs a desired process for the received frame. Further, the PC 1 transmits the frame generated in the internal process of the PC 1 to the network 5.

Each of the server 2 and the gateway 4, which is connected to the hub 3, receives the frame from the hub 3, and performs a desired process for the received frame. Further, each of the server 2 and the gateway 4 transmits the frame generated in the internal process of the server 2 to the hub 3.

The hub 3 is connected to the network 5, the gateway 4 and the server 2. Upon receipt of the frame from the network 5, the gateway 4 and the server 2, the hub 3 analyzes the received frame, and transfers the frame to an appropriate port based upon its analysis result.

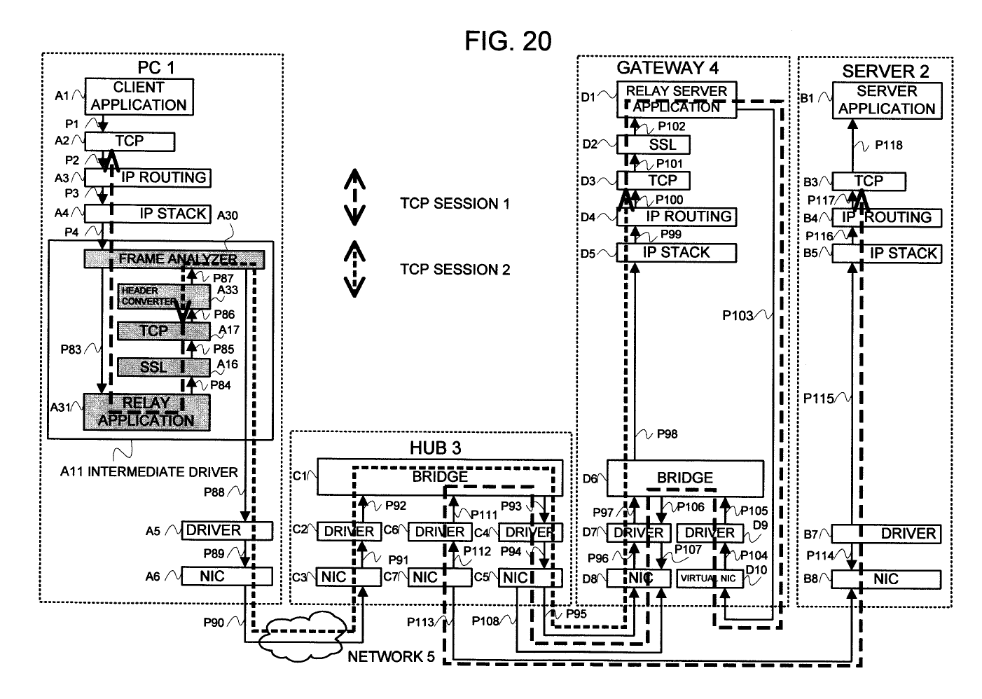

FIG. 20 is a view illustrating the communication process of the CPU and the NIC that are mounted onto each apparatus of this embodiment. Upon making a reference to FIG. 20, a configuration of the PC 1 of the fifth embodiment differs in a block configuration of the intermediate driver A11 as compared with that of the PC 1 in the first embodiment shown in FIG. 3, in which the header converter 13 and the TCP A17 are removed from the intermediate driver A11 of FIG. 3. Accompanied thereby, the function of each module changes as described below.

An outline of a function of a relay application A31 is almost similar to that of the relay application A15 of the first embodiment shown in FIG. 3; however the relay application A31 differs from the relay application A15 of the first embodiment in a point that the module, being a deliveree of its data, is not the TCP A17 but a frame analyzer A30.

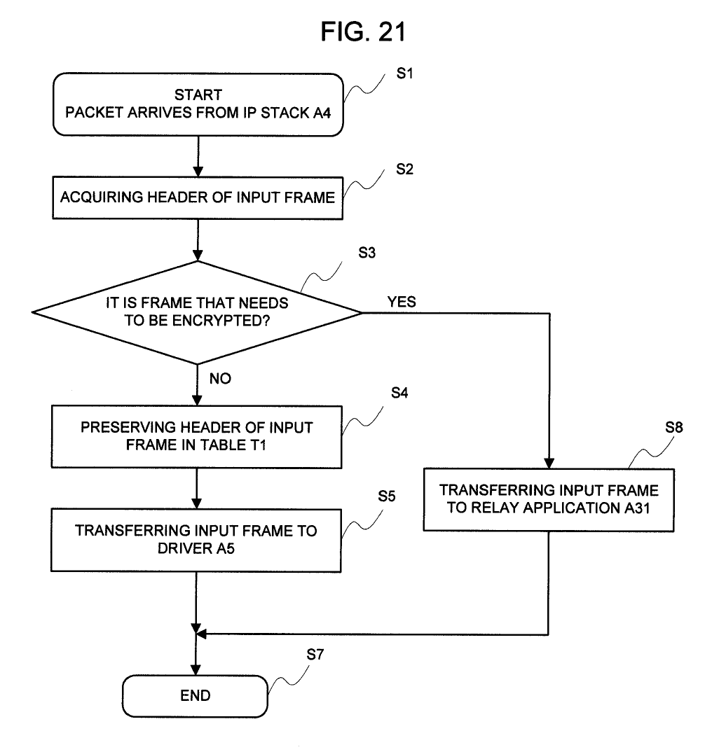

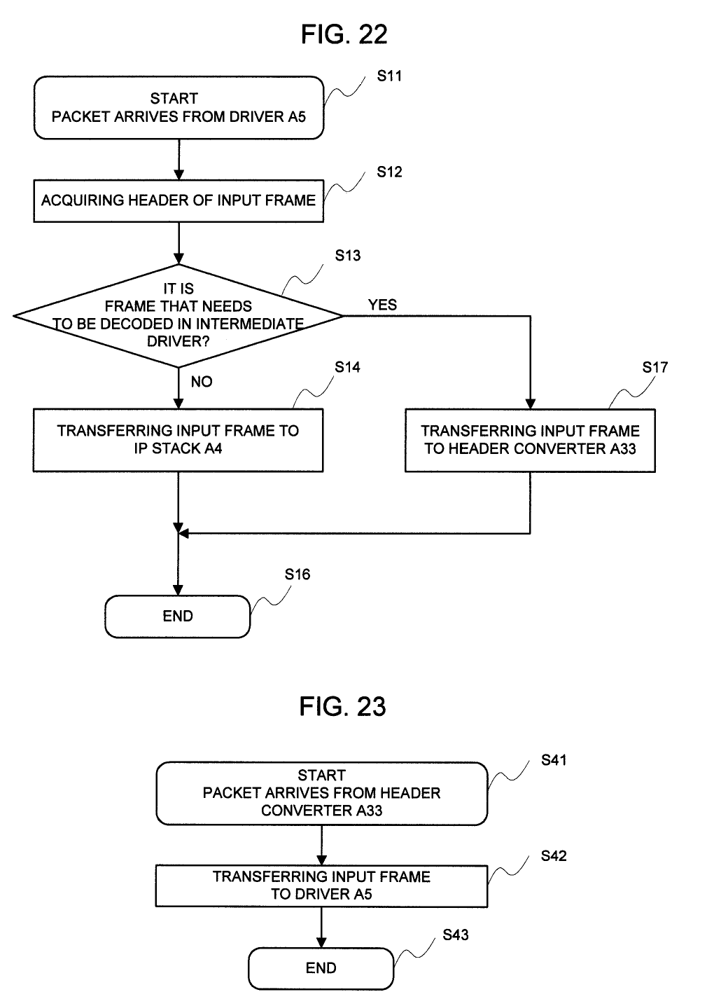

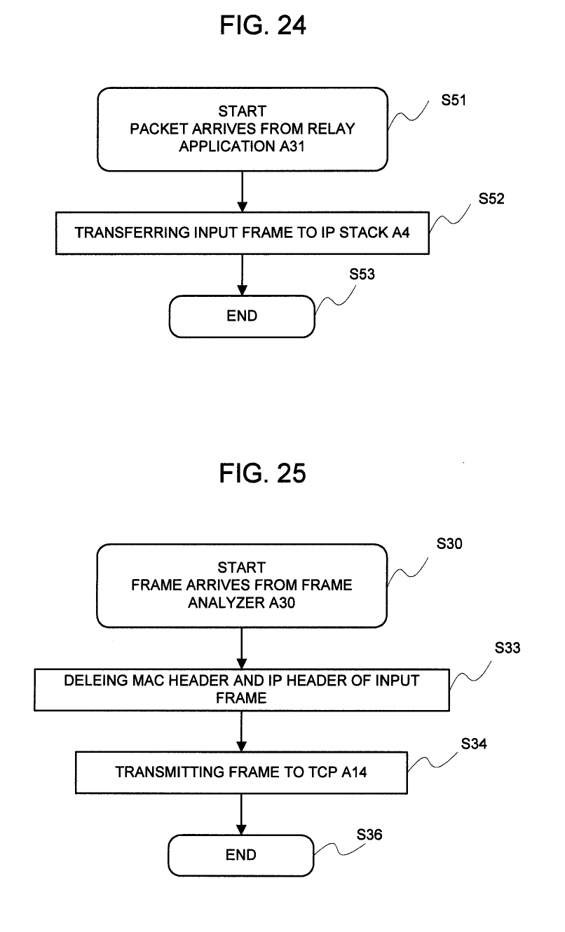

Next, a function of the frame analyzer A30 will be explained. The frame analyzer A30 is connected to the IP stack A4, a header converter A33, and the relay application A31. Each of FIG. 21, FIG. 22, FIG. 23 and FIG. 24 is an operational flowchart for explaining the process of the frame analyzer A30 in details.

FIG. 21 shows an operational flowchart of the frame analyzer A30 in the case that the frame has arrived from the IP stack A4. FIG. 21 differs from FIG. 5 in a point that the step S6 of FIG. 5 has been replaced with a step S8. Other process is identical to that of FIG. 5, so its explanation is omitted.

On the other hand, FIG. 22 shows an operational flowchart of the frame analyzer A30 in the case that the frame has arrived from the driver A5. FIG. 22 differs from FIG. 6 in a point that the step S15 of FIG. 6 has been replaced with a step S17. Other process is identical to that of FIG. 6, so its explanation is omitted.

On the other hand, FIG. 23 shows an operational flowchart of the frame analyzer A30 in the case that the frame has arrived from the header converter A33. The frame analyzer A30, as shown in FIG. 23, transmits the frame received from the header converter A33 to the driver A5 (step S42).

On the other hand, FIG. 24 shows an operational flowchart of the frame analyzer A30 in the case that the frame has arrived from the relay application A31. The frame analyzer A30 transmits the frame received from the relay application A31 to the IP stack A4 (step S52).

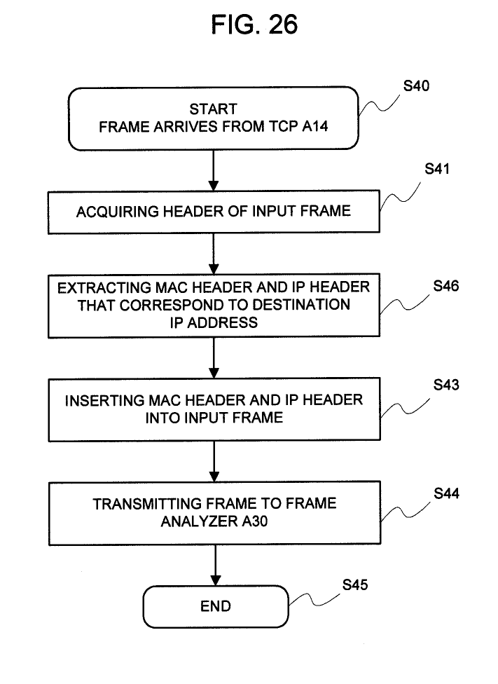

Next, a function of the header converter A33 will be explained. The header converter A33 is connected to the frame analyzer A30 and the TCP A14. Each of FIG. 25 and FIG. 26 is an operational flowchart for explaining the process of the header converter A33 in details. FIG. 25 shows an operational flowchart of the header converter A33 in the case that the frame has arrived from the frame analyzer A30. After firstly deleting the MAC header and the IP header of the frame received from the frame analyzer A30 (step S33), the header converter A33 transmits the frame to the TCP A14 (step S34).

On the other hand, FIG. 26 shows an operational flowchart of the header converter A33 in the case that the frame has arrived from the TCP A14. FIG. 26 differs from FIG. 9 in a point that the step S42 of FIG. 9 has been replaced with a step S46. In the step S46, the header converter A33 performs the process of acquiring the MAC header and the IP header that corresponds to the frame received from the TCP A14. Other process of FIG. 26 is identical to that of FIG. 9, so its explanation is omitted.

Next, a function of each component of the gateway 4 shown in FIG. 20 will be explained. At first, out of the software operating within the CPU of the gateway 4, the software that is positioned in the higher layer that is not included in the OS will be explained. The gateway 4 includes a relay server application D1 as software that corresponds hereto.

The relay server application D1 has a function of transferring the data that arrives from an SSL D2 to a virtual NIC D10 as a frame. Further, the relay server application D1 has a function of transferring the data that arrives from the virtual NIC D10 to the SSL D2 for a purpose of allowing it to get into the communication by the TCP session between the TCP A14 and a TCP D3.

Next, a function of the software that is included in the OS of the gateway 4 will be explained. As software that is included in the OS, the gateway 4 includes the SSL D2, the TCP D3, an IP routing D4, an IP stack D5, and a bridge D6. The functions of these items of the software are entirely identical to that of the modules of the server 2 of FIG. 3, respectively, so its explanation is omitted.

Next, a function of software that is positioned in the lower layer that is not included in the OS of the gateway 4 will be explained. As software that corresponds hereto, the gateway 4 includes a driver D7 and a driver D9; however a function of these items of the software is entirely identical to the driver B7 of the server 2 of FIG. 3, so its explanation is omitted.

Next, a function of hardware of the gateway 4 will be explained. As hardware, the gateway 4 includes an NIC D8 and a virtual NIC D10; however functions of these modules are entirely identical to the modules of the PC 1 of FIG. 12, so its explanation is omitted.

[Explanation of an Operation]

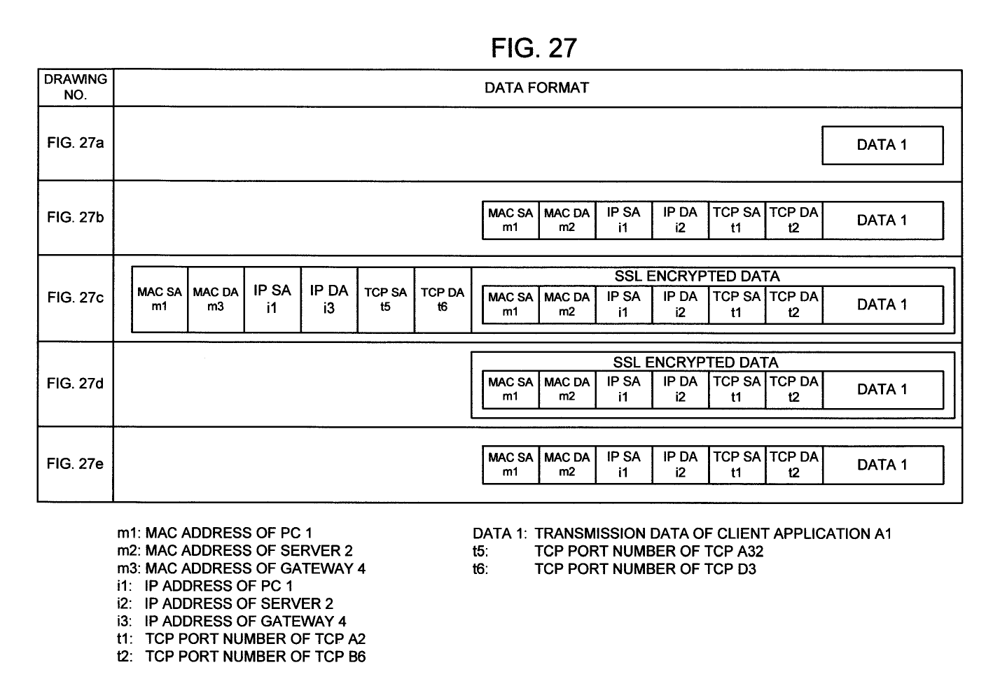

FIG. 27 shows a format of the frame that is exchanged between each of the modules of FIG. 20 and the other. An operation of this embodiment will be explained below by making a reference to FIG. 27 and FIG. 20.

At first, an operation in the case that data is transmitted from the client application A1 of the PC 1 to the server application B1 of the server 2 will be explained. However, the operation until a connection P3 is identical to that of the first embodiment, so the explanation of the operation is started at time point of a connection P4.

Upon receipt of the frame from the IP stack A4 through the connection P4 as shown in FIG. 21, the frame analyzer A30 makes a reference to its header. The frame analyzer A30 determines whether the received data has been encrypted from this header. The frame analyzer A30 determines that the frame delivered in the connection P4 has not been encrypted, and delivers the frame to the relay application A31 through a connection P83. FIG. 27b shows a format of data that is delivered to the relay application A31.

Upon receipt of the data from the frame analyzer A30 through the connection P83, the relay application A31 delivers the data to the SSL A16 through a connection P84 for purpose of encrypting it to realize prevention of the wiretapping.

Upon receipt of the data from the relay application A31 through the connection P84, the SSL A16 uses the encryption technique pre-settled with the SSL D2 of the gateway 4, thereby to encrypt the data. After completing the encryption, the SSL A16 delivers the encrypted data to the TCP A14 through a connection P85. FIG. 27c shows a format of data that is delivered to the TCP A14.

Upon receipt of the data from the SSL A16 through the connection P85, the TCP A14 adds the TCP header and the destination IP address to the data, thereby to packetize it. A port number t6 of the TCP D3 of the gateway 4 is employed for the destination TCP port number of the TCP header, and a port number t5 of the TCP A14 for the transmission source TCP port number. Further, an IP address i3 of the gateway 4 is set to the destination IP address. After adding the TCP header and the destination IP address, the TCP A14 delivers the packet to the header converter A33 through a connection P86. The TCP A14 establishes the TCP session with the TCP D3 by use of these processes, and realizes the stabilized data transfer to/from the TCP D3. In FIG. 20, this TCP session is shown with a broken line (TCP session 2).

Upon receipt of the packet from the TCP A14 through the connection P86 as shown in FIG. 26, the header converter A33 adds the MAC header and the IP header to the received packet, thereby to generate a frame. After inserting the IP header and the MAC header into the packet, the header converter A13 delivers the frame to the frame analyzer A30 through a connection P87. FIG. 27c shows a format of data that is delivered to the frame analyzer A30.

Herein, judging from a comparison of the data format of FIG. 27c with that of FIG. 11c, it can be seen that the intermediate driver of this embodiment performs not the relaying process of the TCP but the tunneling process of the TCP. That is, it establishes the “secure” TCP session 2 between the TCP A14 and the TCP D3 in such a manner of overlapping the TCP session 1 between the TCP A2 and the TCP B3. Herein, the reason why expression of “secure” is used is that the TCP session 2 between the TCP A14 and the TCP D3 is encrypted with the SSL, and hence, there is no risk of being wiretapped by a third party. In such a manner, combining the tunneling process of the TCP and the encrypting process of the SSL makes it possible to encrypt data transmitted from the client application A1.

Upon receipt of the frame from the header converter A33 through the connection P87 as shown in FIG. 23, the frame analyzer A30 delivers the frame to the driver A5 through a connection P88.

Upon receipt of the frame from the frame analyzer A12 through the connection P12, the driver A5 delivers the frame to the NIC A6 through a connection P89.

Upon receipt of the frame from the driver A5 through the connection P89, the NIC A6 delivers the frame to the NIC C3 through a connection P90 while allowing it to go through the network 5.

Upon receipt of the frame from the NIC A6 through the connection P90 while allowing it to go through the network 5, the NIC C3 delivers the frame to the driver C2 through a connection P91.

Upon receipt of the frame from the NIC C3 through the connection P91, the driver C2 delivers the frame to the bridge C1 through a connection P92.

Upon receipt of the frame from the driver C2 through the connection P92, the bridge C1 makes a reference to the destination MAC address of the received frame. When the bridge C1 recognizes that the terminal having the destination MAC address has been connected to the NIC C5, it delivers the frame to the driver C4 through a connection P93.

Upon receipt of the frame from the bridge C1 through the connection P93, the driver C4 delivers the frame to the NIC C5 through a connection P94.

Upon receipt of the frame from the driver C4 through the connection P94, the NIC C5 delivers the frame to the NIC D8 through a connection P95.

Upon receipt of the frame from the NIC C5 through the connection P95, the NIC D8 delivers the frame to the driver D7 through a connection P96.

Upon receipt of the frame from the NIC D8 through the connection P96, the driver D7 delivers the frame to the bridge D6 through a connection P97.

Upon receipt of the frame from the driver D7 through the connection P97, the bridge D6 makes a reference to the destination MAC address of the received frame. When the bridge D6 recognizes that the terminal having the destination MAC address is the gateway 4, it delivers the frame to the IP stack D5 through a connection P98.

Upon receipt of the frame from the bridge D6 through the connection P98, the IP stack D5 removes the MAC header and the IP header from the frame, thereby to convert it into a packet, and thereafter, delivers the packet to the IP routing D4 through a connection P99.

Upon receipt of the packet from the IP stack D5 through the connection P99, the IP routing D4 makes a reference to the TCP header of the packet. When the IP routing D4 recognizes that the destination of the packet is the TCP D3 from the destination TCP port number, it delivers the received packet to the TCP D3 through a connection P100.

The TCP D3 receives the packet from the IP routing D4 through the connection P100, and makes a reference to the TCP header, thereby to investigate a reversal of the sequence and a missing of the packet. In a case where not only a reversal of the sequence but also a missing have not occurred, it removes the TCP header from the packet, and delivers the data to the SSL D2 through a connection P101. At this moment, it gives the TCP A14 an ACK packet for notifying arrival of the packet as a reply (TCP session 2).

Upon receipt of the data from the TCP D3 through the connection P101, the SSL D2 uses the decoding technique settled with the SSL A16 of the PC 1, thereby to decode the data. The SSL D2 delivers the decoded data to the relay application D1 through a connection P102. FIG. 27e shows the data that is delivered to the relay application D1, and it is understood that the encryption and the encapsulation are undone herein at length, and the original frame is taken out.

Upon receipt of the frame from the SSL D2 through the connection P102, the relay server application D1 delivers the frame to the virtual NIC D10 through a connection P103.

Upon receipt of the frame from the relay server application D1 through the connection P103, the virtual NIC D10 delivers the frame to the driver D9 through a connection P104.

Upon receipt of the frame from the virtual NIC D10 through the connection P104, the driver D9 delivers the frame to the bridge D6 through a connection P105.

Upon receipt of the frame from the driver D9 through the connection P105, the bridge D6 makes a reference to the destination MAC address of the received frame. When the bridge D6 recognizes that the terminal having the destination MAC address has been linked to the upstream side of NIC D8, it delivers the frame to the driver D7 through a connection P106.

Upon receipt of the frame from bridge D6 through the connection P106, the driver D7 delivers the frame to the NIC D8 through a connection P107.

Upon receipt of the frame from the driver D7 through the connection P107, the NIC D8 delivers the frame to the NIC C5 through a connection P108.

Upon receipt of the frame from the NIC D8 through the connection P108, the NIC C5 delivers the frame to the driver C4 through a connection P109.

Upon receipt of the frame from the NIC C5 through the connection P109, the driver C4 delivers the frame to the bridge C1 through a connection P110.

Upon receipt of the frame from the driver C4 through the connection P110, the bridge C1 makes a reference to the destination MAC address of the received frame. When the bridge C1 recognizes that the terminal having the destination MAC address has been linked to the upstream side of the NIC C7, it delivers the frame to the driver C6 through a connection P111.

Upon receipt of the frame from the bridge C1 through the connection P111, the driver C6 delivers the frame to the NIC C7 through a connection P112.

Upon receipt of the frame from the driver D6 through the connection P112, the NIC C7 delivers the frame to the NIC B8 through a connection P113.

Upon receipt of the frame from the NIC C7 through the connection P113, the NIC B8 delivers the frame to the driver B7 through a connection P114.

Upon receipt of the frame from the NIC B8 through the connection P114, the driver B7 delivers the frame to the IP stack B5 through a connection P115.

Upon receipt of the frame from the driver B7 through the connection P115, the IP stack B5 removes the MAC header and the IP header from the frame, thereby to convert it into a packet, and thereafter, delivers the packet to the IP routing B4 through a connection P116.

Upon receipt of the packet from the IP stack B5 through the connection P116, the IP routing B4 makes a reference to the TCP header of the packet. When the IP routing B4 recognizes that the destination of the packet is the TCP B3 from the destination TCP port number, it delivers the received packet to the TCP B3 through a connection P117.

The TCP B3 receives the packet from the IP routing B4 through the connection P116, and makes a reference to the TCP header, thereby to investigate a reversal of the sequence and a missing of the packet. In a case where not only a reversal of the sequence but also a missing have not occurred, it removes the TCP header from the packet, and delivers the data to the server application B1 through a connection P118. At this moment, it gives the TCP A2 an ACK packet for notifying arrival of the packet as a reply (TCP session 1).

As mentioned above, it was confirmed that the data transmitted from the client application A1 was encrypted and surely arrived at the server application B1.

Herein, it is only in the section ranging from the PC 1 up to the gateway 4 that the data transmitted from the client application A1 is encrypted, and in a case where only this section is a section in which a risk that the data is wiretapped exists, this technique enjoys a sufficient merit in the terms of the security. That is, this technique enjoys a sufficient merit in the terms of the security in a case where the network 5 bridging this section is a network such as Internet having a risk that the data is wiretapped because the data is encrypted.

Further, with an operation in the case that the data is transmitted from the server application B1 to the client application A1 after completing the above-mentioned process, its explanation is omitted because the data only migrates in a direction opposite to that of the foregoing path.

In the above explanation, the operation in the case of allowing the TCP session 1 between the TCP A2 of the PC 1 and the TCP B3 of the server 2 to tunnel through the secure TCP session 2 between the PC 1 and the gateway 4 was explained. For this, the data format becomes a TCP over TCP format.

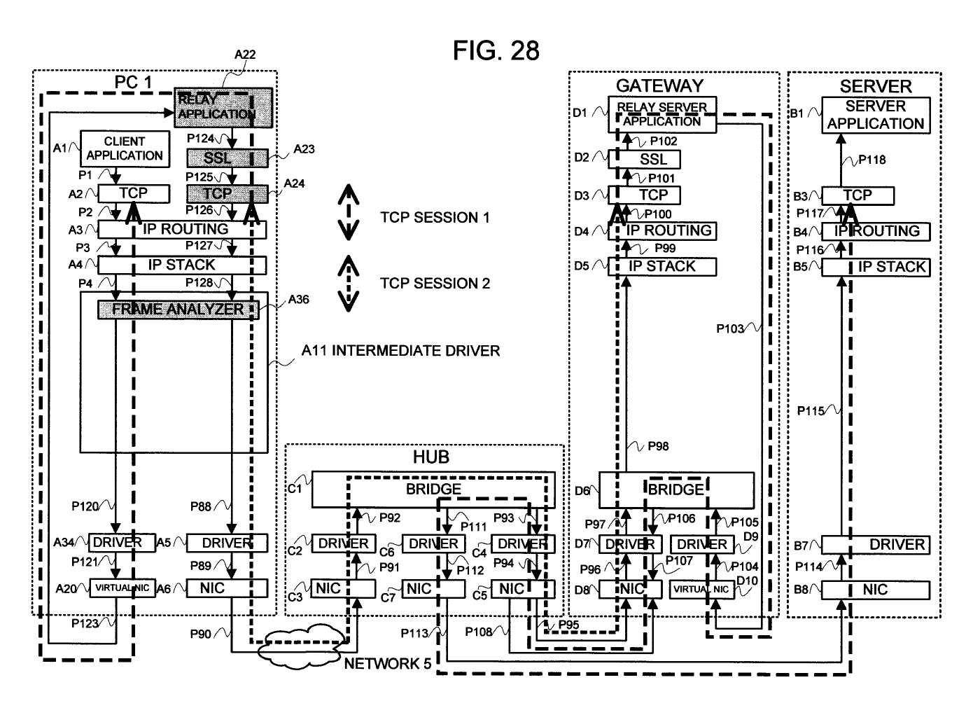

On the other hand, it is also possible to allow the UDP frame that is exchanged between the PC 1 and the server 2 to tunnel through the secure TCP session 2 between the PC 1 and the gateway 4. The system configuration in this case is a configuration in which the TCP A2 of the PC 1 side and the TCP B3 of the server 2 side shown in FIG. 28 are replaced only with UDP modules, so detailed explanation is omitted. Further, the data format becomes a UDP over TCP format. Employing such a system configuration enables voice data communication etc. using the UDP to be safely encrypted by the intermediate driver.

[Effects]

Next, effects of this embodiment will be explained.

This embodiment has the following effect in addition to the effects of the first embodiment.

In this embodiment, allowing the TCP session 1 of the PC 1 and the server 2 to tunnel through the secure TCP session 2 between the PC 1 and the gateway 4 makes it possible to encrypt the data that is sent out from the PC 1 without fail, and then to transmit it even in a case where the server application B1 of the server 2 is not in a correspondence with the SSL. For this, a burden that the user bears for searching for the server application B1 that corresponds to the SSL, and a burden of installing its server application B1 onto the server 2 can be eliminated.

### Sixth Embodiment

[Explanation of a Configuration]

Next, a sixth embodiment for carrying out the third invention of the present invention will be explained in details by making a reference to the accompanied drawings. A network configuration of the sixth embodiment is identical to that of the fifth embodiment of FIG. 19, so its explanation is omitted.

FIG. 28 is a view illustrating the communication process of the CPU and the NIC that are mounted onto each apparatus of this embodiment. Upon making a reference to FIG. 28, the sixth embodiment differs from the fifth embodiment in a point of including a driver A34 and a virtual NIC A20 in addition to the configuration of the PC 1 in the fifth embodiment shown in FIG. 20.

A function of the driver A34 is identical to that of the driver A19 shown in FIG. 12, so its explanation is omitted.

A function of the virtual NIC A20 is identical to that of the virtual NIC A20 shown in FIG. 12, so its explanation is omitted.

Further, upon making a reference to FIG. 28, the sixth embodiment differs from the fifth embodiment in a point that, out of the modules packaged inside the intermediate driver A11 in fifth embodiment, the module replaceable with the function of the OS is separated from the intermediate driver A11. Specifically, in the sixth embodiment, the SSL A16 and the TCP A14 incorporated into the intermediate driver A11 of the fifth embodiment are separated from the intermediate driver A11, and these modules are replaced with the function of the OS. Further, in the sixth embodiment, the relay application is also separated from the intermediate driver, and the intermediate driver and the relay application are loopback-connected via the virtual NIC. Accompanied thereby, the function of each module changes as mention below.

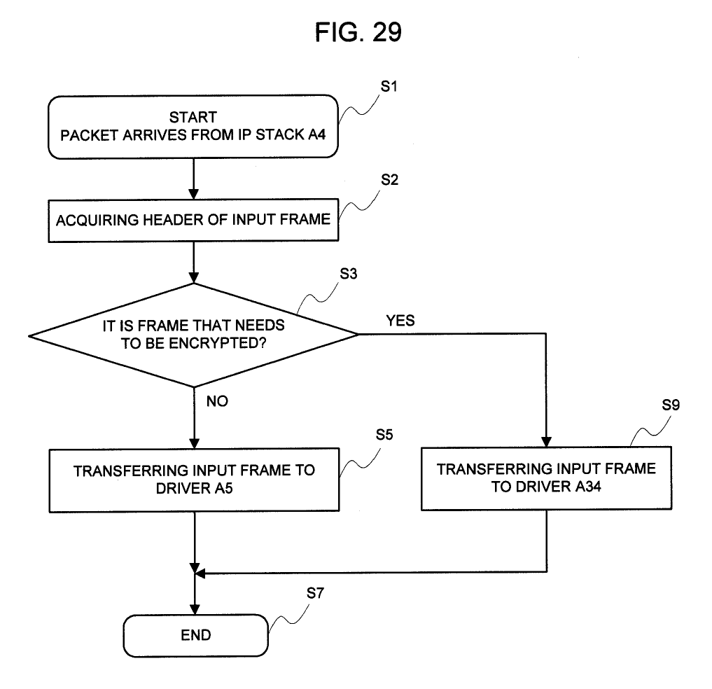

A frame analyzer A36 is connected to the IP stack A4, the driver A5, and the driver A34. FIG. 29, which is an operational flowchart for explaining the process of the frame analyzer A18 in details, shows the process in the case that the frame has arrived from the IP stack A4. The frame analyzer A36 differs from the frame analyzer A30 of the fifth embodiment in a point that the step S15 of FIG. 6 has been replaced with a step S9.

On the other hand, an operational flowchart of the frame analyzer A36 in the case that the frame has arrived from the driver A5 is entirely identical to that of FIG. 14, so its explanation is omitted.

Further, an operational flowchart of the frame analyzer A36 in the case that the frame has arrived from the driver A34 is entirely identical to that of FIG. 7, so its explanation is omitted.

Functions of a relay application A22, a TCP A24, and an SSL A23 that are shown in FIG. 28 are entirely identical to that of the relay application A22, the TCP A24, and the SSL A23 that are shown in FIG. 12, respectively, so its explanation is omitted.

Functions of the blocks other than the foregoing components out of the components shown in FIG. 28 are entirely identical that of the fifth embodiment shown in FIG. 20, so its explanation is omitted.

[Explanation of an Operation]

An operation of this embodiment will be explained below by making a reference to FIG. 28. A point in which this embodiment differs from the fifth embodiment shown in FIG. 20 lies only in an operation of the PC 1, so only the operation of the PC 1 will be explained.

At first, an operation in the case that data is transmitted from the client application A1 of the PC 1 to the server application B1 of the server 2 will be explained. However, the operation until a connection P3 is identical to that of the fifth embodiment, so the explanation of the operation is started at time point of a connection P4.

Upon receipt of the frame from the IP stack A4 through the connection P4 as shown in FIG. 29, the frame analyzer A36 makes a reference to its header, thereby to determine whether the received data has been encrypted. The frame analyzer A18 determines that the frame delivered in the connection P4 has not been encrypted, and delivers the frame to the driver A34 through a connection P120.

Upon receipt of the frame from the frame analyzer A36 through the connection P120, the driver A34 transmits the frame to the virtual NIC A20 through a connection P121.

Upon receipt of the frame from the driver A34 through the connection P121, the virtual NIC A20 transmits the frame to the relay application A22 through a connection P123.

Upon receipt of the data from the virtual NIC A20 through the connection P123, the relay application A22 delivers the data to the SSL A23 through a connection P124 for purpose of encrypting it to realize prevention of the wiretapping.

Upon receipt of the data from the relay application A22 through the connection P124, the SSL A23 uses the encryption technique pre-settled with the SSL D2, thereby to encrypt the data. After completing the encryption, the SSL A23 delivers the encrypted data to the TCP A24 through a connection P125.

Upon receipt of the data from the SSL A23 through the connection P125, the TCP A24 adds the TCP header and the destination IP address to the data, thereby to packetize it. A port number t6 of the TCP D3 of the gateway 4 is employed for the destination TCP port number of the TCP header, and a port number t5 of the TCP A24 for the transmission source TCP port number. Further, an IP address i3 of the gateway 4 is set to the destination IP address. After adding the TCP header and the destination IP address, the TCP A24 delivers the packet to the IP routing A3 through a connection P126. The TCP A24 establishes the TCP session with the TCP D3 by use of these processes, and realizes the stabilized data transfer to/from the TCP D3. In FIG. 27, this TCP session is shown with a dotted line (TCP session 2).

Upon receipt of the packet from the TCP A24 through the connection P126, the IP routing A3 makes a reference to the destination IP address to transmit the packet to the IP stack A4 through a connection P127.

Upon receipt of the packet from the IP routing A3 through the connection P127, the IP stack A4 adds the IP header and the MAC header to the packet, thereby to generate a frame. An IP address i3 of the gateway 4 is employed for the destination IP address of the IP header, and an IP address i1 of the PC 1 for the transmission source IP address. Further, an MAC address m3 of the gateway 4 is employed for the destination MAC address of the MAC header, and an MAC address m1 of the PC 1 for the transmission source MAC address. After inserting such an IP header and MAC header into the packet, the IP stack A4 delivers the frame to the frame analyzer A36 through a connection P128.

Upon receipt of the frame from the IP stack A4 through the connection P128 as shown in FIG. 29, the frame analyzer A36 makes a reference to its header, thereby to determine whether the received data has been encrypted. The frame analyzer A36 recognizes that the frame delivered in the connection P128 has been encrypted, and delivers the frame to the driver A5 through a connection P88.

The operation after it is entirely identical to that of the fifth embodiment of FIG. 20, so its explanation is omitted.

As mentioned above, it was confirmed that the data transmitted from the client application A1 was encrypted and surely arrived at the server application B1.

Further, with an operation in the case that the data is transmitted from the server application B1 to the client application A1 after completing the above-mentioned process, its explanation is omitted because the data only migrates in a direction opposite to that of the foregoing path.

[Effects]

Next, effects of this embodiment will be explained. This embodiment has the following effect in addition to the effects of the fifth embodiment.

In this embodiment, loop-backing the frame, which needs to be encrypted, from the intermediate driver A11 into the OS so that the function of the SSL A16 incorporated inside the intermediate driver A11 in the fifth embodiment can be replaced with the function of the SSL A23 already incorporated into the OS eliminates a burden that the software developer bears for packaging the SSL A16 into the intermediate driver. This makes it possible to reduce the load that is imposed upon the software developer, and to reduce a burden of the development.

### Seventh Embodiment

[Explanation of a Configuration]

Next, a seventh embodiment for carrying out the third invention of the present invention will be explained in details by making a reference to the accompanied drawings. A network configuration of the seventh embodiment is identical to that of the fifth embodiment of FIG. 19, so its explanation is omitted.

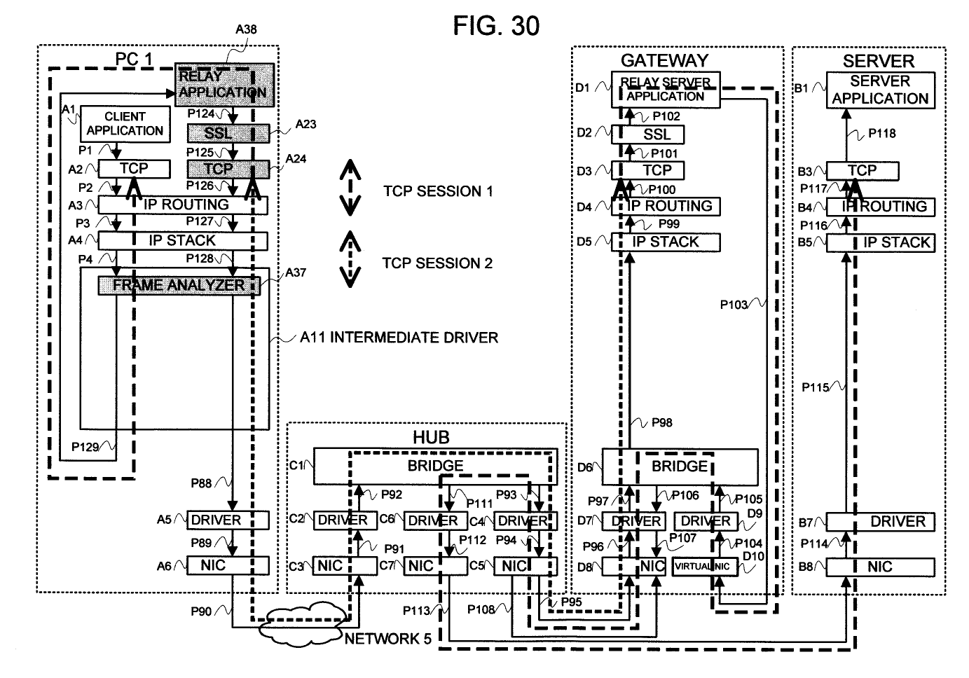

FIG. 30 is a view illustrating the communication process of the CPU and the NIC that are mounted onto each apparatus of this embodiment. Upon making a reference to FIG. 30, the seventh embodiment differs from the sixth embodiment in a point that out of the components of the PC 1 in the fifth embodiment shown in FIG. 28, the driver A34 and the virtual NIC A20 are excluded, and a frame analyzer A37 and a relay application A38 are directly loopback-connected. Accompanied thereby, the function of each module changes as described below.

An outline of a function of the frame analyzer A37 is almost similar to that of the frame analyzer A36 of the sixth embodiment shown in FIG. 28; however the frame analyzer A37 differs from the frame analyzer A36 of the sixth embodiment in a point that the module, being a deliveree of its data, is not the driver A34 but the relay application A26.

An outline of the function of the relay application A26 is almost similar to that of the relay application A22 of the sixth embodiment shown in FIG. 28; however the relay application A26 differs from the relay application A22 of the sixth embodiment in a point that the module, being a deliveree of its data, is not the virtual NIC A20 but the frame analyzer A37.

Functions of the blocks other than the foregoing components out of the components shown in FIG. 30 are entirely identical that of the sixth embodiment shown in FIG. 28, so its explanation is omitted.

[Explanation of an Operation]

An operation of this embodiment will be explained below by making a reference to FIG. 30. A point in which this embodiment differs from the sixth embodiment shown in FIG. 28 lies only in an operation of the PC 1, so only the operation of the PC 1 will be explained.

At first, an operation in the case that data is transmitted from the client application A1 of the PC 1 to the server application B1 of the server 2 will be explained. However, the operation until a connection P3 is identical to that of the sixth embodiment, so the explanation of the operation is started at time point of a connection P4.

Upon receipt of the frame from the IP stack A4 through the connection P4 as shown in FIG. 29, the frame analyzer A37 makes a reference to its header, thereby to determine whether the received data has been encrypted. The frame analyzer A37 determines that the frame delivered in the connection P4 has not been encrypted, and delivers the frame to the relay application A38 through a connection P129.

Upon receipt of the frame from the frame analyzer A37 through the connection P129, the relay application A38 delivers the data to the SSL A23 through a connection P124 for a purpose of encrypting it to realize prevention of the wiretapping.

The operation after it is entirely identical to that of the sixth embodiment of FIG. 28, so its explanation is omitted. As mentioned above, it was confirmed that the data transmitted from the client application A1 was encrypted and surely arrived at the server application B1.

Further, with an operation in the case that the data is transmitted from the server application B1 to the client application A1 after completing the above-mentioned process, its explanation is omitted because the data only migrates in a direction opposite to that of the foregoing path.

[Effects]

Next, effects of this embodiment will be explained. This embodiment has the following effect in addition to the effects of the sixth embodiment.

In this embodiment, performing the loopbacking process between the frame analyzer A37 and the relay application A38 so that the driver A34 and the virtual NIC A20 incorporated into the PC 1 in the sixth embodiment can be excluded eliminates a burden that the software developer bears for developing these modules. This makes it possible to reduce the load that is imposed upon the software developer, and to reduce a burden of the development.

Further, in the sixth embodiment, there is a risk that a security level declines in the PC 1 when the virtual NIC A20 and the NIC A6 are bridge-connected; however in this embodiment, the bridge-connection is impossible because the virtual NIC A20 itself has been excluded, and a burden of taking a security countermeasure can be reduced.

### Eighth Embodiment

[Explanation of a Configuration]

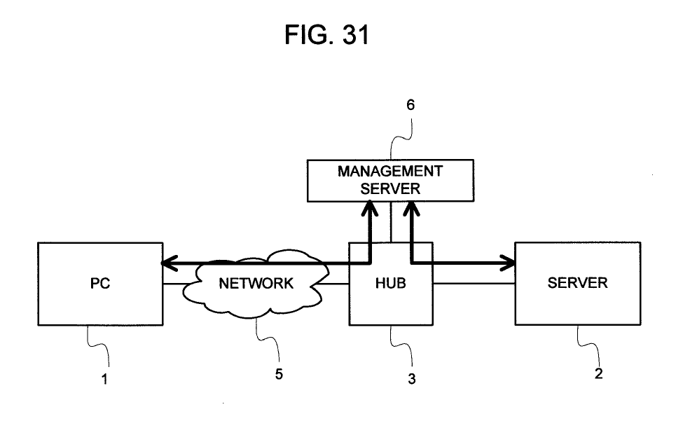

Next, an eighth embodiment for carrying out the fourth invention of the present invention will be explained in details by making a reference to the accompanied drawings. FIG. 31 is a view illustrating a network configuration of the eighth embodiment, which differs from that of FIG. 19 in a point of including a management server 6 in addition to the network configuration shown in FIG. 19. Herein, the gateway 5, which is not described in FIG. 31, may be connected to the hub 3 similarly to FIG. 19. The management server 6 has a function of receiving the frame from the PC 1, and after performing a desired process for the received frame, giving any response to the PC 1.

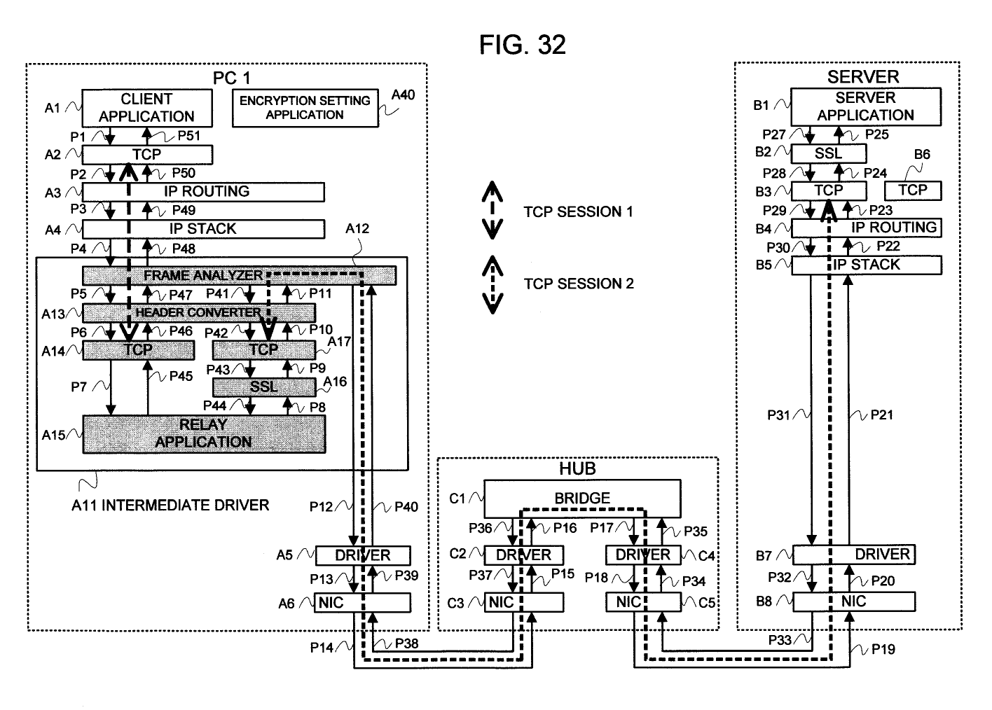

FIG. 32 is a view illustrating a communication process of the CPU and the NIC that are mounted onto each apparatus of this embodiment. Upon making a reference to FIG. 32, the eighth embodiment differs from the first embodiment in a point of including an encryption setting application A40 in addition to the configuration of the PC 1 in the first embodiment shown in FIG. 3.

The encryption setting application A40 is software that is positioned in the upper layer that is not included in the OS. The encryption setting application A40 has a function etc. of determining whether the frame is encrypted in the intermediate driver A11 responding to a network environment, and changing the setting of a frame analyzer A41 based upon its determination result. The encryption setting application A40 can perform various processes in determining whether to encrypt the frame, and can determine whether to encrypt it based upon its analysis result. This process includes the following processes. The process of sending an ICMP echo request to the management server 6, and checking whether its response is returned. The process of sending a special frame to the management server 6, and checking whether its response is returned. The process of investigating the IP address currently set to the PC 1, and checking whether the IP address is a predetermined value.

The encryption setting application A40 determines whether to encrypt the frame responding to a result of any of the above-mentioned processes or a combination thereof.

Further, various types of the timing at which the above-mentioned processes are performed in the encryption setting application A40 are thinkable, and for example, whenever the packet is transmitted/received, periodically for each certain time period, at the time of starting the PC, at the time designated by the user, or a combination thereof.

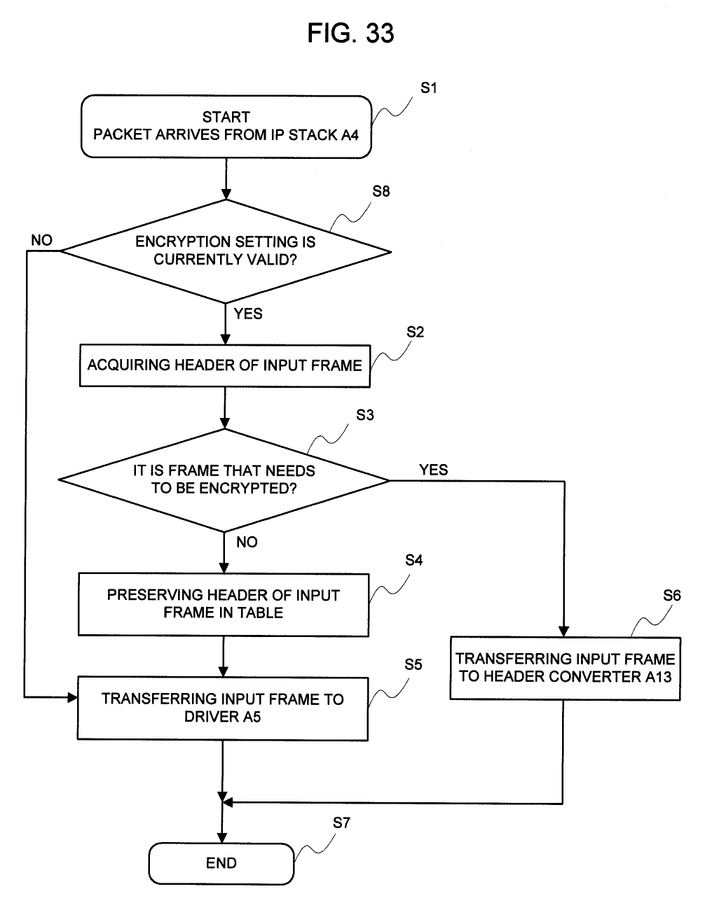

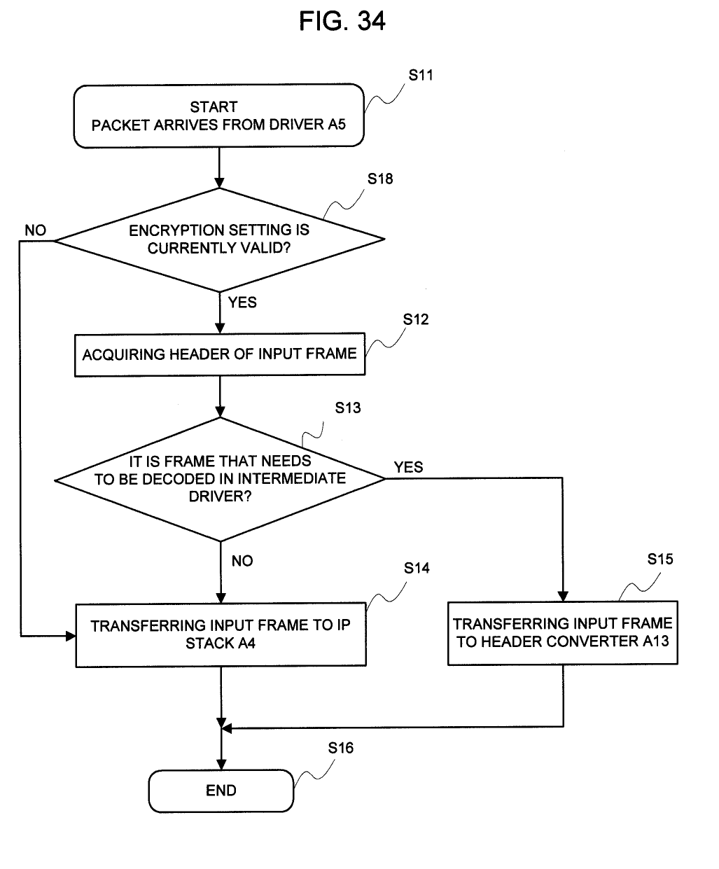

Accompanied by addition of the encryption setting application A40 to the PC 1 in such a manner, the frame analyzer is changed as described below. The frame analyzer A41 is connected to the IP stack A4, the driver A5, and a header converter A13. Each of FIG. 33 and FIG. 34 is an operational flowchart for explaining the process of the frame analyzer A41 in details. FIG. 33 shows an operational flowchart of the frame analyzer A41 in the case that the frame has arrived from the IP stack A4. FIG. 33 differs from the frame analyzer A12 of the first embodiment in a point of including a step S8 in addition to the steps of the flowchart of FIG. 5. The step S8 is a step of, based upon a result of the determination by the above-mentioned encryption setting application A40, performing a branching process of determining whether to encrypt the packet in the intermediate driver. If the encryption setting application A40 has determined that the packet is encrypted in the intermediate driver, the encryption setting is validated. On the other hand, if it has determined that the frame is not encrypted in the intermediate driver, the encryption setting is invalidated.

On the other hand, FIG. 34 shows an operational flowchart of the frame analyzer A41 in the case that the frame has arrived from the driver A5. FIG. 34 differs from the frame analyzer A12 of the first embodiment in a point of including a step S18 in addition to the steps of the flowchart of FIG. 6. The step S18 is a step of, based upon a result of the determination by the above-mentioned encryption setting application A40, performing a branching process of determining whether to decode the frame in the intermediate driver.

Further, an operational flowchart of the frame analyzer A41 in the case that the frame has arrived from the header converter A13 is entirely identical to that of FIG. 7, so its explanation is omitted.

[Explanation of an Operation]

An operation of this embodiment will be explained below by making a reference to FIG. 32. The normal process of transmitting/receiving the frame is identical to that of the first embodiment, so only the operation of the encryption setting module A40 is explained.

The encryption setting module A40 executes the process of determining whether to encrypt the frame in the intermediate driver A11 at a pre-set timing.

As a process to be performed herein, there exist one of the process of sending an ICMP echo request to the management server 6 and checking whether its response is returned, the process of sending a special frame to the management server 6 and checking whether its response is returned, and the process of investigating the IP address set to the PC 1, and checking whether the IP address is a predetermined value, or a combination thereof.

As a result of having performed the above processes, for example, in a case where one of the condition that the ICMP echo response is returned from the management server 6, the condition that the special frame is returned from the management server 6, and the condition that the IP address currently set in the PC 1 is a predetermined value, or a combination thereof holds, the encryption setting module A40 changes the setting of the frame analyzer A41, and validates the encryption setting of the step S8 and the step S18. Further, in a case where the above-mentioned condition does not hold, the encryption setting module A40 changes the setting of the frame analyzer A41, and invalidates the encryption setting of the step S8 and the step S18.

It was confirmed that performing the above operation enabled the encryption function of the intermediate driver to be automatically set responding to the network environment of the PC.

[Effects]

Next, effects of this embodiment will be explained.

In this embodiment, as mentioned above, incorporating the encryption setting module A40 into the PC 1 enables the encryption function of the intermediate driver to be automatically set responding to the network environment, whereby a burden that a user bears for manually changing the encryption function responding to a migration of the location of the PC 1 can be eliminated.

For example, by employing this encryption setting module A40, the operation is automatically executed of switching off the encryption setting in using the PC in an office LAN due to no risk of the wiretapping, and contrarily, switching on the encryption setting in using the PC in a net-café due to a high risk of the wiretapping. The user does not have to manually change the setting at all.

Further, the user has no chance to manually change the setting of the encryption, whereby no risk that the erroneous setting is induced exists, and a risk as well that information leakage occurs due to the erroneous setting can be excluded.

### Ninth Embodiment

[Explanation of a Configuration]

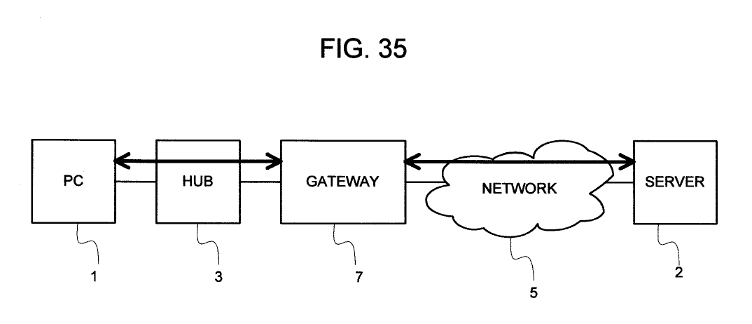

Next, a ninth embodiment for carrying out the fifth invention of the present invention will be explained in details by making a reference to the accompanied drawings. FIG. 35 is a view illustrating a network configuration of the ninth embodiment, which includes a network 5 and a gateway 7 in addition to the configuration of the first embodiment shown in FIG. 3.

Herein, the network 5 was already explained in the configuration of the fifth embodiment shown in FIG. 19, so its explanation is omitted.

The gateway 7 is connected to the hub 3 and the network 5. Upon receipt of the frame from the hub 3 and the network 5, the gateway 7 analyzes the received frame, performs a desired process for the frame, and thereafter, transfers the frame to an appropriate port.

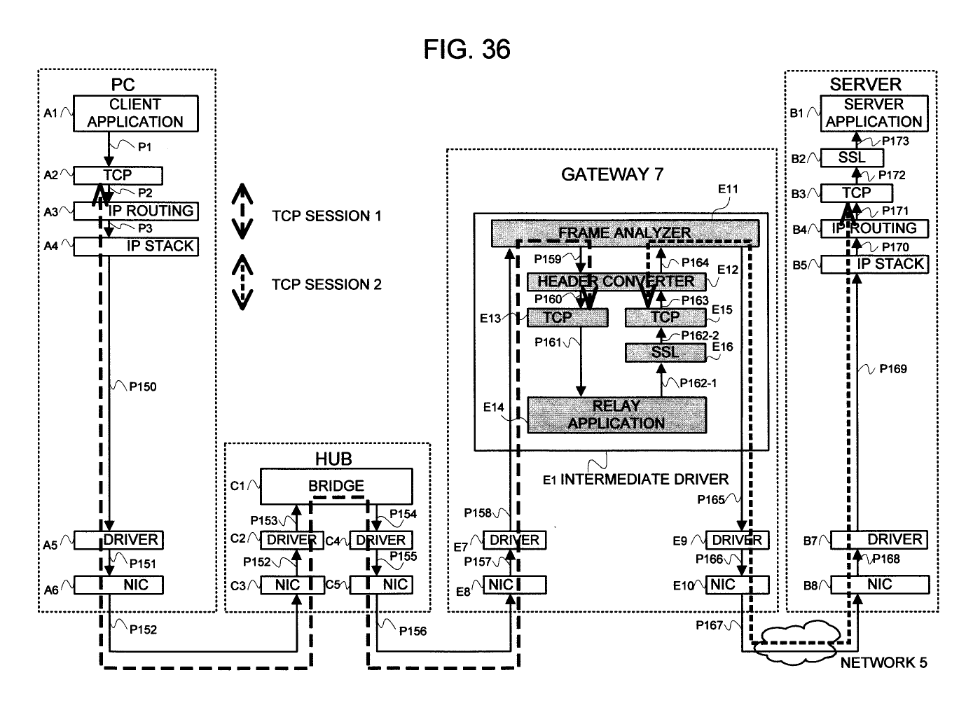

FIG. 36 is a view illustrating a communication process of the CPU and the NIC that are mounted onto each apparatus of this embodiment. Upon making a reference to FIG. 36, it can be seen that a configuration of the PC 1 of the ninth embodiment has the intermediate driver A11 removed as compared with that of the PC 1 of the first embodiment shown in FIG. 3.

Accompanied thereby, the function of the intermediate driver A11 mounted onto the PC 1 of FIG. 1 is shifted to the gateway 7.

A function of each component of the gateway 7 will be explained. The gateway 7 includes an intermediate driver E1, a driver E7, and a driver E9 as software that is positioned in the lower layer that is not included in the OS.

The intermediate driver E1, which is connected to the driver 7 and the driver E9, has a function described below. The intermediate driver E1 makes a reference to the header of the frame that arrives from the driver E7, and investigates whether the frame needs to be encrypted. If the received frame needs to be encrypted, the intermediate driver E1 terminates the TCP session with the TCP A2 of the PC 1, being a transmission source of its frame, for a time being, and thereafter, encrypts the data. Herein, as an encryption key to be used for encryption, the encryption key exchanged with the SSL B2 of the server 2, being a destination of the frame, is employed. The intermediate driver E1 has a function of, after encrypting the frame, adding to the encrypted data the header that corresponds to the TCP session with the TCP B3 of the server 2, being a destination of the frame, and thereafter, transferring the encrypted data to the driver E9. On the other hand, it has a function of, if the frame received from the driver E7 does not need to be encrypted, transferring the frame to the driver E9 as it stands. Herein, as a frame that does not need to be encrypted, the frame already encrypted in the PC 1, the DHCP packet, the ARP packet, or the like is listed.

Further, the intermediate driver E1 makes a reference to the header of the frame that arrives from the driver E9, and investigates whether the frame needs to be decoded. If the received frame needs to be decoded, the intermediate driver E1 terminates the TCP session with the TCP B3 of the server 2, being a transmission source of its frame, for a time being, and thereafter, decodes the data. Herein, as a decoding key to be used for decoding, the decoding key exchanged with the SSL B2 of the server 2, being a transmission source, is employed. The intermediate driver E1 has a function of, after decoding the frame, adding to the decoded data the header that corresponds to the TCP session with the TCP A2 of the PC 1, being a destination of the frame, and thereafter, transferring the decoded data to the driver E7. On the other hand, the intermediate driver E1 has a function of, if the received frame does not need to be decoded, transferring the frame to the driver E7 as it stands. Herein, as a frame that does not need to be decoded, the frame that should be decoded in the PC 1, the DHCP packet, the ARP packet, or the like is listed.

The intermediate driver E1 is configured of a plurality of functional blocks as shown in FIG. 36 in order to execute the above-mentioned function. Out of these functional blocks, the block different from that of the intermediate driver A11 of the first embodiment shown in FIG. 3 is only a frame analyzer E11.

Next, a function of the frame analyzer E11 will be explained. However, it will be understood that a function and a configuration of the frame analyzer to be described below is only an example.

Further, as described below, the frame analyzer E11 has a function of determining whether the received frame needs to be encrypted and decoded, and the function of determining whether to cancel the frame also can be added besides this function. With this cancellation function, it is possible to prevent the not-encrypted frame from leaking out from the PC 1, and to prevent the PC 1 from being attacked unauthorizedly from an external network.

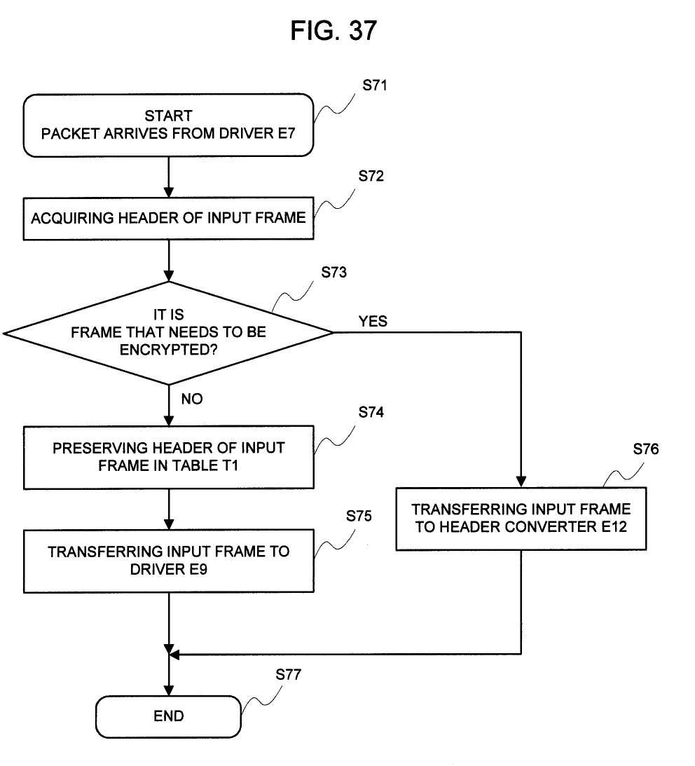

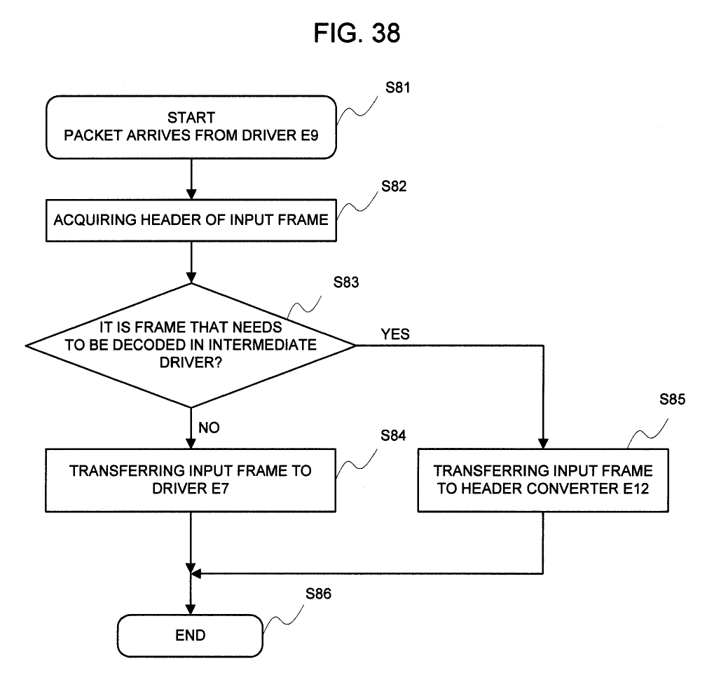

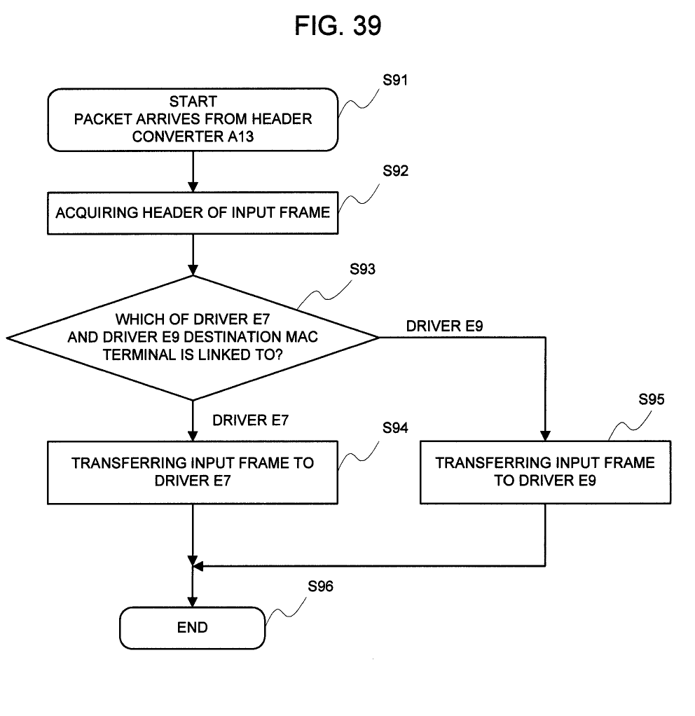

The frame analyzer E11 is connected to the driver E7, the driver E9, and a header converter E12. Each of FIG. 37, FIG. 38, and FIG. 39 is a flowchart for explaining the function of the frame analyzer E11 in details. FIG. 37 shows the process of the frame analyzer E11 in the case that the frame has arrived from the driver E7. Upon comparing FIG. 37 and FIG. 5, the frame analyzer E11 differs from the frame analyzer A12 of the first embodiment in a point of transferring the frame of which the encryption is determined to be unnecessary in a step S73 to the driver E9 (step S75). Further, the frame analyzer E11 differs from the frame analyzer A12 of the first embodiment in a point of transferring the frame of which the encryption is determined to be necessary in the step S73 to the header converter E12 (step S76). Other process is identical to that of FIG. 5, so its explanation is omitted.

On the other hand, FIG. 38 shows the process of the frame analyzer E11 in the case that the frame has arrived from the driver E9. Upon comparing FIG. 38 and FIG. 6, the frame analyzer E11 differs from the frame analyzer A12 of the first embodiment in a point of transferring the frame of which the decoding is determined to be unnecessary in a step S83 to the driver E7 (step S84). Further, the frame analyzer E11 differs from the frame analyzer A12 of the first embodiment in a point of transferring the frame of which the decoding is determined to be necessary in the step S83 to the header converter E12 (step S85). Other process is identical to that of FIG. 6, so its explanation is omitted.

Further, FIG. 39 shows the process of the frame analyzer E11 in the case that the frame has arrived from the header converter A13. In a step S93, the frame analyzer E11 identifies which of the driver E7 and the driver E9 the terminal, which has the destination MAC address of the frame header as its own MAC address, is connected to. So as to execute the identifying process in this step S93, the frame analyzer E11 has a function as well of learning the MAC address identically to the bridge C1 of FIG. 3. The frame analyzer E11 transfers the input frame to the driver E7 in some case (step S94) and transfers it to the driver E9 in some case (step S95), responding to an identification result in this step S93. The frame analysis E11 of FIG. 39 differs from the frame analysis A12 of the first embodiment in these points. Other process is identical to that of FIG. 7, so its explanation is omitted.

The reason why the frame analyzer E11 has the bridge function mounted like the case of process in the step S95 is that, even in a case where a plurality of the terminals are connected to the upstream side of the driver E7 and the driver E9, an obstacle to the transfer of the frame is prevented from occurring.

In the above-mentioned explanation of the gateway 7, making a reference to the destination MAC address of the frame header allows an identification to be made as to which of the driver E7 and the driver E9 the destination terminal is connected to; however a reference may be made to not the destination MAC address but the destination IP address.

Functions of the blocks other than the foregoing components out of the components shown in FIG. 36 are entirely identical that of the first embodiment shown in FIG. 3, so its explanation is omitted.

[Explanation of an Operation]

An operation of this embodiment will be explained below by making a reference to FIG. 36. A point in which this embodiment differs from the first embodiment shown in FIG. 3 lies only in an operation of the PC 1 and the gateway 7, so only the operation of the PC 1 and the gateway 7 will be explained.

At first, an operation in the case that data is transmitted from the client application A1 of the PC 1 to the server application B1 of the server 2 will be explained. However, the operation until a connection P3 is identical to that of the first embodiment, so the explanation of the operation is started at time point of a connection P150.

Upon receipt of the frame from the IP stack A4 through the connection P150, the driver A5 delivers the received frame to the NIC A6 through a connection P151.

Upon receipt of the frame from the driver A5 through the connection P151, the NIC A6 transfers the received frame to the NIC E8 of the gateway 7 via the hub 3.

Upon receipt of the frame from the hub 3 through a connection P156, the NIC E8 delivers the received frame to the driver E7 through a connection P157.

Upon receipt of the frame from the NIC E8 through the connection P157, the driver E7 delivers the received frame to the frame analyzer E11 through a connection P158.

Upon receipt of the frame from the driver E7 through the connection P158 as shown in FIG. 37, the frame analyzer E11 makes a reference to its header. The frame analyzer A12 determines whether the received data has been encrypted from this header. The frame analyzer E11 determines that the frame delivered in the connection P158 has not been encrypted, and delivers the frame to the header converter E12 through a connection P159 according to FIG. 37.

Upon receipt of the frame from the frame analyzer E11 through the connection P159 as shown in FIG. 8, the header converter E12 registers the MAC header and the IP header of the received frame into the table T2 of FIG. 10b responding to the destination TCP. It is determined that the destination TCP of the frame received in the connection P159 is the TCP E13 because the port number of the TCP E13 has been caused to coincide with the port number t2 of the TCP B6, and its MAC address and IP address are registered into the top stage of the table T2 of FIG. 10b. After registering the header of the received frame into the table T2, the header converter E12 removes the MAC header and the IP header from the frame, thereby to convert it into a packet, and thereafter, makes a reference to the destination port number to deliver the packet to the TCP E13. FIG. 11c shows a format of data that is delivered to the TCP A14.

Upon receipt of the packet from the header converter E12 through the connection P160, the TCP E13 makes a reference to the TCP header, thereby to investigate a reversal of the sequence and a missing of the packet, and in a case where not only a reversal of the sequence but also a missing have not occurred, removes the header from the packet, and delivers the data to the relay application E14 through a connection P161. At this moment, it gives the TCP A2 an ACK packet for notifying arrival of the packet as a reply, thereby to terminate the TCP session from the TCP A2. Upon viewing from the TCP A2, the TCP session looks as if it were established between the TCP A2 and the TCB B6 because the port number of the TCP E13 has been caused to coincide with the port number t2 of the TCP B6; however the actual TCP session is established between the TCP A2 and the TCP E13. In FIG. 3, this TCP session is shown with a broken line (TCP session 1).

Upon receipt of the data from the TCP E13 through the connection P161, the relay application E14 delivers the data to the SSL E16 through a connection P162-1 for a purpose of encrypting it to realize prevention of the wiretapping.

Upon receipt of the data from relay application E14 through the connection P162-1, the SSL E16 uses the encryption technique pre-settled with the SSL B2 of the server 2 to encrypt the data. After completing the encryption, the SSL E16 delivers the encrypted data to the TCP E15 through a connection P162-2. FIG. 11d shows a format of data that is delivered to the TCP E15.

Upon receipt of the data from the SSL A16 through the connection P162-2, the TCP E15 adds the TCP header and the destination IP address to the data, thereby to packetize it. A port number t4 of the TCP B3 of the server 2 is employed for the destination TCP port number of the TCP header, and a port number t3 of the TCP E15 for the transmission source TCP port number. Herein, the port number t4 of the TCP B3 is a port number that is explicitly used in transmitting the encrypted data. Further, an IP address i2 of the server 2 is set to the destination IP address, After adding such a TCP header and destination IP address, the TCP E15 delivers the packet to the header converter E12 through a connection P163. The TCP E15 establishes the TCP session with the TCP B3 of the server 2 by use of theses processes, and realizes the stabilized data transfer to/from the TCP B3. In FIG. 3, this TCP session is shown with a dotted line (TCP session 2).

Upon receipt of the packet from the TCP E15 through the connection P163 as shown in FIG. 9, the header converter E12 makes a reference to the table T2, and adds the MAC header and the IP header that corresponds to the received packet, thereby to generate a frame. Specifically, it adds the MAC header and the IP header that corresponds to the received packet, responding to the transmission source TCP. For example, the transmission source TCP of the packet received in the connection P163 is the TCP E15, whereby its MAC address and IP address has been registered in the top stage of the table T2 of FIG. 10b. After inserting the IP header and the MAC header into the packet, the header converter E12 delivers the frame to the frame analyzer E11 through a connection P164. FIG. 11e shows a format of data that is delivered to the frame analyzer E11. Upon receipt of the frame from the header converter E12 through the connection P164 as shown in FIG. 39, the frame analyzer E11 makes a reference to its header. As a header to be referenced herein, the MAC header, the IP header, etc. are listed. The frame analyzer E11 makes identification from this header as to which of the driver E7 and the driver E9 the destination terminal of the frame is linked to. As an example of the identification method, the method of making a reference to the destination MAC address or the destination IP address is thinkable, and it can be seen from the MAC address learning that the terminal having the destination MAC address of the frame delivered in the connection P164 is in a link with the upstream side of the driver E9, whereby the frame analyzer E11 delivers the frame to the driver E9 through a connection P165 according to a step S93 of FIG. 39.

Upon receipt of the frame from the frame analyzer E11 through the connection P165, the driver E9 delivers the frame to the NIC E10 through a connection P166.

Upon receipt of the frame from the driver E9 through the connection P166, the NIC E10 delivers the frame to the NIC B8 via the network 5.

Upon receipt of the frame from the NIC E10 via the network 5, the NIC B8 delivers the frame to the driver B7 through a connection P168.

The operation after it is entirely identical to that of the first embodiment, so its explanation is omitted.

As mentioned above, it was confirmed that the data transmitted from the client application A1 was encrypted in the gateway 7 and surely arrived at the server application B1.

Further, with an operation in the case that the data is transmitted from the server application B1 to the client application A1 after completing the above-mentioned process, its explanation is omitted because the data only migrates in a direction opposite to that of the foregoing path.

From the above explanation, it was confirmed that the bi-directional communication between the client application A1 and the server application B1 was encrypted without fail by allowing it to go through the gateway 7.

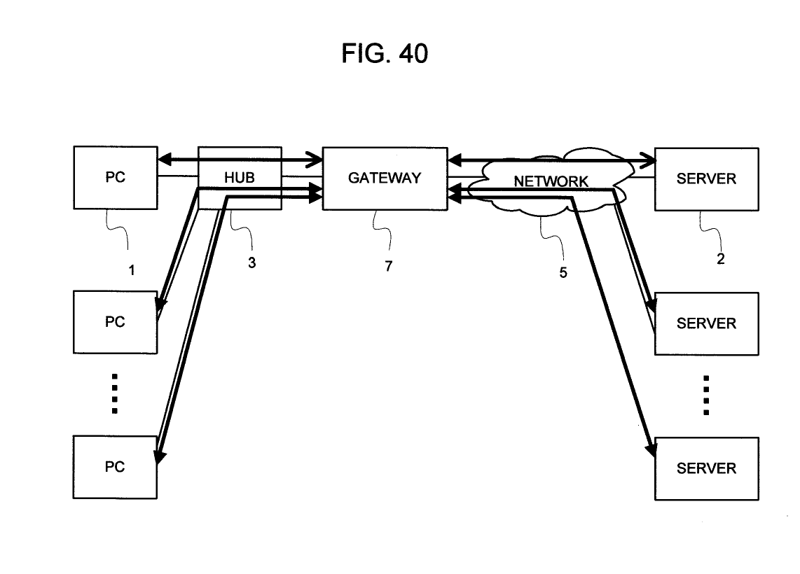

Further, in the above explanation, the operation in the case of encrypting the communication between the PC 1 and the server 2 in the gateway 7 was explained, and the gateway 7 in the case that the gateway 7 mediates communication between each of a plurality of the PCs and the server in addition to the communication between the PC 1 and the server 2 as shown in FIG. 40 assumes the following configuration.

The intermediate driver E1 of the gateway 7, which includes the TCP E13, the relay application E14, the SSL E16, and the TCP E15 for each communication session between the PC and the server, performs a relaying process of the TCP session between the PC and the server. This enables data that is transmitted/received between each PC and each server to be encrypted.

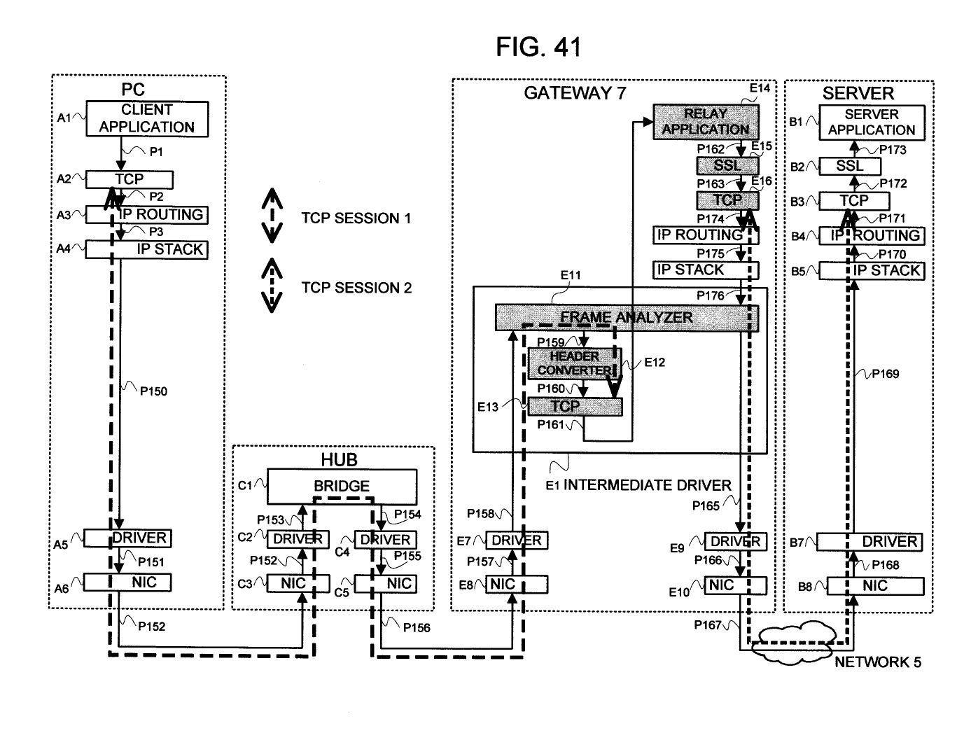

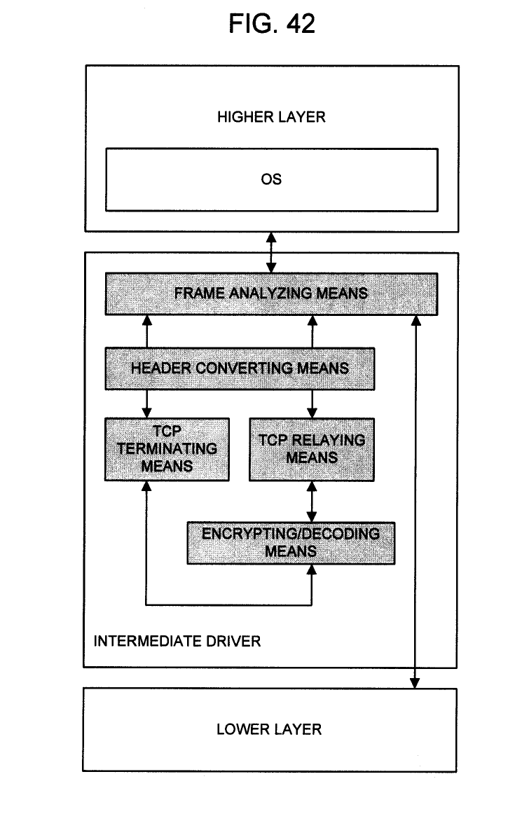

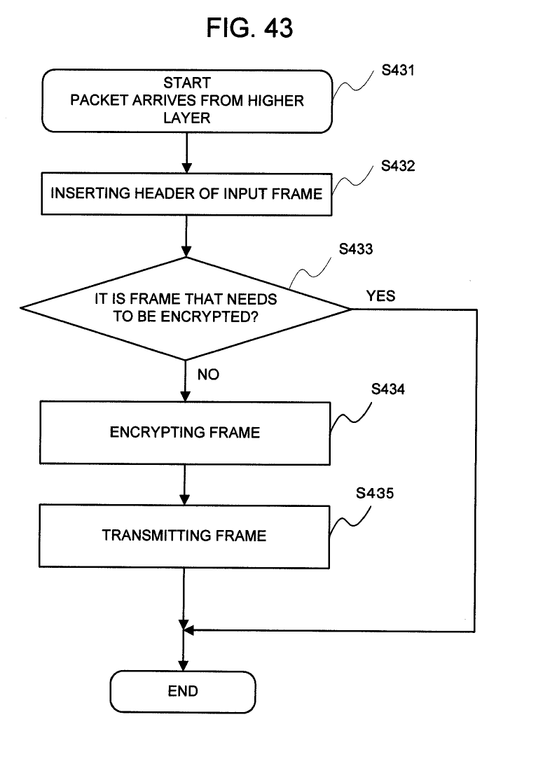

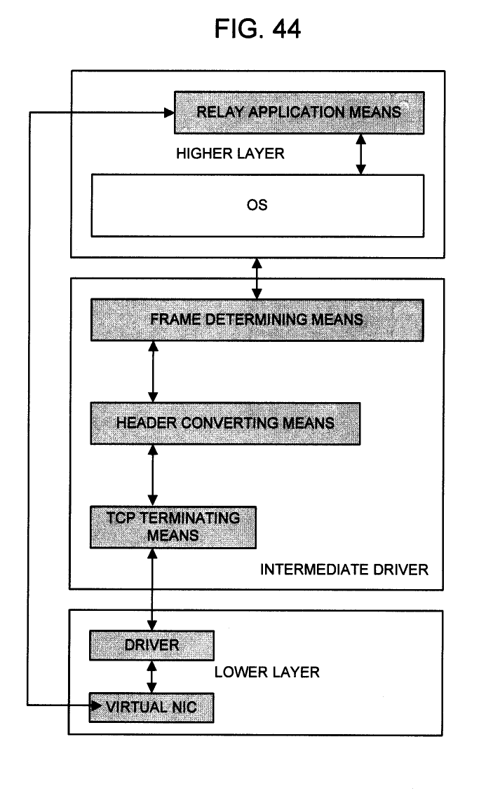

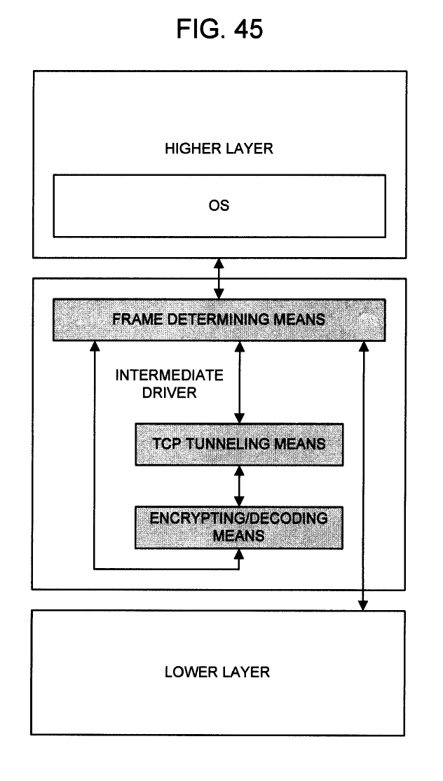

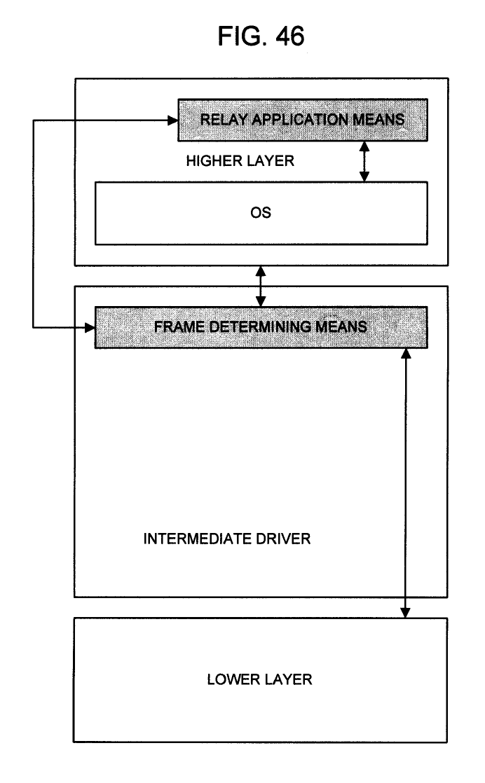

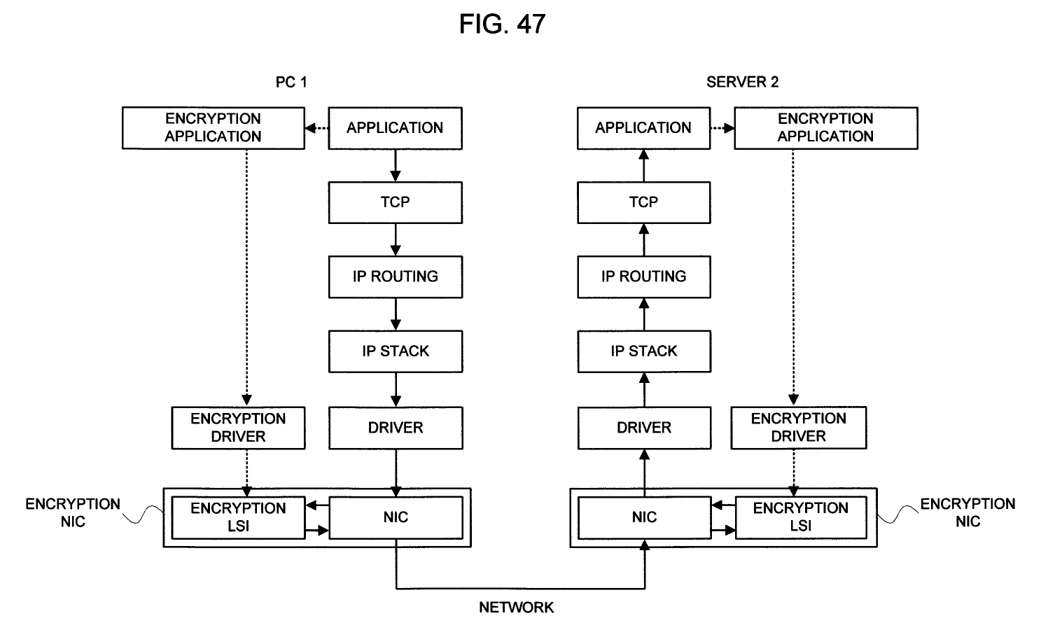

Further, loopback-connecting the intermediate driver and the OS in addition to the configuration, as already described in the second embodiment and third embodiment, makes it possible to reduce a burden that the soft developer bears. Incorporation of the loopbacking process as above-mentioned into the intermediate driver of this embodiment allows the system configuration as shown in FIG. 41 to be obtained, and its configuration and operation is apparent from the explanation of the second embodiment and third embodiment, so its explanation is omitted.

[Effects]

Next, effects of this embodiment will be explained. In this embodiment, mounting the function of the intermediate driver incorporated in the PC in the first embodiment onto the gateway apparatus makes it possible to collectively encrypt the communication data between each of a plurality of the PCs and the server in the gateway apparatus without installing the intermediate driver into each PC even in a case where a plurality of the PCs each having a risk of the information leakage exist. For this, a burden of installing the intermediate driver into all PCs each having a risk of the information leakage can be eliminated.

The present invention has been described with reference to the preferred embodiments; however, the present invention, which is not always limited to the above-mentioned embodiments, can be carried out by making an alteration hereto within the scope of the technical spirit of the present invention. For example, in a case of transmitting data to the PC 2 from a PC 1 via the server like the case of transmitting the electronic mail, a frame analyzer for determining whether the transmission data has been encrypted, and an SSL for, in a case where this frame analyzer has determined that the transmission data has not been encrypted, encrypting the transmission data may be mounted onto the server.

1-62. (canceled)

63. A communication system including a transmitter and a receiver, characterized in comprising:
a first session establishing means for establishing a first session with said transmitter responding to a session establishment request from a transport layer of said transmitter;
a second session establishing means for establishing a second session with the transport layer of said receiver for transmitting/receiving encrypted transmission data; and
an encrypting means for exchanging information necessary for encryption through said second session, encrypting the transmission data received through said first session based upon this information, and transmitting it to said receiver through said second session.

64. The communication system according to claim 63, characterized in that said first session establishing means waits for the session establishment request from the transport layer of said transmitter in a plurality of ports.

65. The communication system according to claim 63, characterized in comprising a determining means for determining the transmission data, and as a result of the determination, sending the transmission data that has not been encrypted to said first session establishing means.

66. The communication system according to claim 65, characterized in that said determining means is a means for making a reference to a header of the transmission data, thereby to determine whether or not the transmission data has been encrypted.

67. The communication system according to claim 63, characterized in that said second session establishing means employs a port different from the port that is employed in said first session to establishes said second session.

68. The communication system according to claim 63, characterized in that each of said first session establishing means, said second session establishing means, and said encrypting means is configured between a network layer and a data-link layer as an intermediate driver.

69. The communication system according to claim 68, characterized in that connecting said intermediate driver and an application layer that ranks more highly than it via a virtual network interface allows said second session establishing means and said encrypting means to be packaged onto Operating System.

70. The communication system according to claim 69, characterized in that said Operating System (OS) further comprises said first session establishing means.

71. The communication system according to claim 63, characterized in comprising a controlling means for conducting a communication test, and responding to a result of this test, deciding whether or not the transmission data is encrypted.

72. The communication system according to claim 71, characterized in that a timing at which said controlling means conducts a communication test is one of the time that said transmitter is started, the time of transmitting/receiving data, the time after a lapse of every constant time period, and the designated time, or a combination thereof.

73. The communication system according to claim 72, characterized in that said communication test is one of a test for checking whether a response of an ICMP echo request is returned, a test for checking whether a response of an echo request employing a special frame is returned, and a test for checking whether a value of an IP address allotted to said transmitter is a specified value, or a combination thereof.

74. The communication system according to claim 63, characterized in that said encrypting means comprises a decoding means for decoding the received data based upon said information.

75. The communication system according to claim 74, characterized in that said decoding means is a means for decoding the received data that has been determined by said determining means to be data sent through the second session established by said second session establishing means.

76. The communication system according to claim 74, characterized in that said determining means is a means for making a reference to a header of the received data, thereby to determine that the received data has been sent through the second session established by said second session establishing means.

77. A communication system including a transmitter and a receiver, characterized in comprising:
a first session establishing means for establishing a first session with said transmitter responding to a session establishment request from a transport layer of the transmitter; and
a second session establishing means for establishing a second session with the transport layer of said receiver for transmitting/receiving encrypted transmission data to/from said receiver.

78. A communication apparatus, characterized in comprising:
a first session establishing means for establishing a first session responding to a session establishment request from a transport layer;
a second session establishing means for establishing a second session with the transport layer of a transmission destination for transmitting/receiving encrypted transmission data; and
an encrypting means for exchanging information necessary for encryption through said second session, encrypting the transmission data received through said first session based upon this information, and transmitting it through said second session.

79. The communication apparatus according to claim 78, characterized in that said first session establishing means waits for the session establishment request from said transport layer in a plurality of ports.

80. The communication apparatus according to claim 78, characterized in comprising a determining means for determining the transmission data, and as a result of the determination, sending the transmission data that has not been encrypted to said first session establishing means.

81. The communication apparatus according to claim 80, characterized in that said determining means is a means for making a reference to a header of the transmission data, thereby to determine whether or not the transmission data has been encrypted.

82. The communication apparatus according to claim 78, characterized in that said second session establishing means employs a port different from the port that is employed in said first session to establish said second session.

83. The communication apparatus according to claim 78, characterized in that each of said first session establishing means, said second session establishing means, and said encrypting means is configured between a network layer and a data-link layer as an intermediate driver.

84. The communication apparatus according to claim 78, characterized in that connecting said intermediate driver and an application layer that ranks more highly than it via a virtual network interface allows said second session establishing means and said encrypting means to be packaged onto Operating System.

85. The communication apparatus according to claim 84, characterized in that said Operating System (OS) further comprises said first session establishing means.

86. The communication apparatus according to claim 78, characterized in comprising a controlling means for conducting a communication test, and responding to a result of this test, deciding whether or not the transmission data is encrypted.

87. The communication apparatus according to claim 86, characterized in that a timing at which said controlling means conducts a communication test is one of the time that the apparatus itself is started, the time of transmitting/receiving data, the time after a lapse of every constant time period, and the designated time, or a combination thereof.

88. The communication apparatus according to claim 86, characterized in that said communication test is one of a test for checking whether a response of an ICMP echo request is returned, a test for checking whether a response of an echo request employing a special frame is returned, and a test for checking whether a value of an IP address allotted to the apparatus itself is a specified value, or a combination thereof.

89. The communication apparatus according to claim 78, characterized in that said encrypting means comprises a decoding means for decoding the received data based upon said information.

90. The communication apparatus according to claim 89, characterized in that said decoding means is a means for decoding the received data that has been determined by said determining means to be data sent through the second session established by said second session establishing means.

91. The communication apparatus according to claim 90, characterized in that said determining means is a means for making a reference to a header of the received data, thereby to determine that the received data has been sent through the second session established by said second session establishing means.

92. A communication apparatus, characterized in comprising:
a first session establishing means for establishing a first session responding to a session establishment request from a transport layer; and
a second session establishing means for establishing a second session with the transport layer of a transmission destination for transmitting/receiving encrypted transmission data.

93. A communication method, characterized in comprising:
a first session establishment step of establishing a first session responding to a session establishment request from a transport layer of a transmission source;
a second session establishment step of establishing a second session with the transport layer of a transmission destination;
an encryption step of exchanging information necessary for encryption through said second session, and encrypting transmission data received through said first session based upon this information; and
a transmission step of transmitting said encrypted transmission data to said transmission destination through said second session.

94. The communication method according to claim 93, characterized in that said first session establishment step is a step of waiting for the session establishment request from the transport layer of said transmission source in a plurality of ports, and establishing a session responding to the establishment request received by any port.

95. The communication method according to claim 93, characterized in that said encryption step is a step of determining the transmission data, and as a result of the determination, encrypting the transmission data that has not been encrypted.

96. The communication method according to claim 95, characterized in that said encryption step is a step of making a reference to a header of the transmission data, thereby to determine whether or not the transmission data has been encrypted.

97. The communication method according to claim 93, characterized in that said second session establishment step is a step of employing a port different from the port that is employed in said first session to establish said second session.

98. The communication method according to claim 93, characterized in comprising a control step of conducting a communication test, and responding to a result of this test, deciding whether or not said transmission data is encrypted.

99. The communication method according to claim 98, characterized in that a timing at which said communication test is conducted is one of the time that an apparatus of said transmission source is started, the time of transmitting/receiving data, the time after a lapse of every constant time period, and the designated time, or a combination thereof.

100. The communication method according to claim 98, characterized in that said communication test is one of a test for checking whether a response of an ICMP echo request is returned, a test for checking whether a response of an echo request employing a special frame is returned, and a test for checking whether a value of an IP address allotted to said transmission source is a specified value, or a combination thereof.

101. The communication method according to claim 93, characterized in comprising a decoding step of decoding the received data based upon said information.

102. The communication system according to claim 101, characterized in that said decoding step is a step of decoding the received data that has been determined to be data sent through the second session established in said second session establishment step.

103. The communication system according to claim 102, characterized in that said decoding step is a step of making a reference to a header of the received data, thereby to making a determination.

104. A communication method, characterized in comprising:
a first session establishment step of, responding to a session establishment request from a transport layer of a transmission source, establishing a first session with said transmission source; and
a second session establishment step of establishing a second session with the transport layer of a transmission destination for transmitting/receiving encrypted transmission data.

105. A program of an information processing apparatus, characterized in causing said information processing apparatus to function as:
a first session establishing means for, responding to a session establishment request from a transport layer of a transmitter, establishing a first session with said transmitter;
a second session establishing means for establishing a second session with a transport layer of a receiver for transmitting/receiving encrypted transmission data; and
an encrypting means for exchanging information necessary for encryption through said second session, encrypting the transmission data received through said first session based upon this information, and transmitting it to said receiver through said second session.

106. The program according to claim 105, characterized in causing said first session establishing means to function as a means for waiting for the session establishment request from the transport layer of said transmitter in a plurality of ports.

107. The program according to claim 105, characterized in comprising a determining means for determining the transmission data, and as a result of the determination, sending the transmission data that has not been encrypted to said first session establishing means.

108. The program according to claim 107, characterized in causing said determining means to function as a means for making a reference to a header of the transmission data, thereby to determine whether or not the transmission data has been encrypted.

109. The program according to claim 105, characterized in causing said second session establishing means to function as a means for employing a port different from the port that is employed in said first session to establish said second session.

110. The program according to claim 105, characterized in comprising a controlling means for conducting a communication test, and responding to a result of this test, deciding whether or not the transmission data is encrypted.

111. The program according to claim 110, characterized in that a timing at which said controlling means conducts a communication test is one of the time that said transmission node is started, the time of transmitting/receiving data, the time after a lapse of every constant time period, and the designated time, or a combination thereof.

112. The program according to claim 110, characterized in that said communication test is one of a test for checking whether a response of an ICMP echo request is returned, a test for checking whether a response of an echo request employing a special frame is returned, and a test for checking whether a value of an IP address allotted to said transmission node is a specified value, or a combination thereof.

113. The program according to claim 105, characterized in that said encrypting means comprises a decoding means for decoding the received data based upon said information.

114. The program according to claim 113, characterized in that said decoding means is a means for decoding the received data that has been determined by said determining means to be data sent through the session established by said second session establishing means.

115. The program according to claim 114, characterized in causing said determining means to function as a means for making a reference to a header of the received data, thereby to determine that the received data has been sent through the second session established by said second session establishing means.

116. A program of an information processing apparatus, characterized in causing said information processing apparatus to function as:
a first session establishing means for, responding to a session establishment request from a transport layer of a transmitter, establishing a first session with said transmitter; and
a second session establishing means for establishing a second session with the transport layer of a receiver for transmitting/receiving encrypted transmission data to/from said receiver.
